(19) United States
(12) Patent Application Publication
(10) Pub. No.: US 2005/0130009 A1
(43) Pub. Date: Jun. 16, 2005

(54) Filling-collecting device for fuel cell, fuel cell system and reusing device for filling-collecting device for fuel cell

(76) Inventors: Kenji Hasegawa, Hirakata-shi (JP); Toshiyuki Aoyama, Settsu-shi (JP); Masaru Higashionji, Katano-shi (JP); Masafumi Shimotashiro, Katano-shi (JP); Masayuki Ono, Osaka-shi (JP); Kenya Hori, Tsuyama-shi (JP); Masaru Odagiri, Kawanishi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/868,871

(22) Filed: Jun. 17, 2004

(30) Foreign Application Priority Data
Jun. 18, 2003 (JP) 2003-173150
Jun. 18, 2003 (JP) 2003-173405
Jun. 18, 2003 (JP) 2003-173446
Feb. 25, 2004 (JP) 2004-049953

(51) Int. Cl. H01M 8/04; H01M 4/94

(52) U.S. Cl. 429/34; 429/26; 429/25; 429/10; 429/23; 429/44

(57) ABSTRACT

There is included a partition plate (1350, 1450, 1550, 1650, 1750, 1850, 1950) which divides interior of one container (1151, 1241, 1340, 1440, 1540, 1640, 1648, 1649, 1740, 1840, 1940) into two spaces of a fuel accommodating space for filling (1342, 1442, 1542, 1642, 1742, 1842, 1942) for accommodating therein liquid fuel and an effluent collecting space (1341, 1441, 1541, 1641, 1741, 1841, 1941) for accommodating therein effluents derived from a fuel cell body, and which is movable along an axial direction of the container. The partition plate is moved so as to narrow the fuel accommodating space for filling due to a pressure difference between pressures of the fuel accommodating space for filling and the effluent collecting space, whereby the liquid fuel (100) is fed from the fuel accommodating space for filling to the anode side of the fuel cell body and whereby the effluent derived from the cathode side is collected into the effluent collecting space.

### BACKGROUND OF THE INVENTION

The present invention relates to a filling-collecting device for fuel cells which is connected to a fuel cell system which generates power by supplying organic fuels such as methanol directly to an anode electrode, a fuel cell system to which the filling-collecting device for fuel cells is connected, and a reusing device for a filling-collecting device for fuel cells which regenerates the filling-collecting device for fuel cells.

Fuel cell systems have been observed as an energy source which is clean and highly efficient for the next generation. Solid-state polymer electrolyte fuel cells (PEFC), in which an anode and a cathode are arranged to sandwich a solid-state polymer electrolyte has been observed for its uses in power sources for electric vehicles and in a distributed power supply for domestic use. Among the solid-state polymer electrolyte fuel cells, a direct methanol fuel cells (DMFC), which supplies organic fuels such as methanol and dimethyl ether directly to an anode to generate power, does not require a reformer for reforming organic fuels such as methanol into gas which contains hydrogen in abundance, and consequently, its structure is simplified. As a result, the direct methanol fuel cell has been observed for its uses for example, in a portable device, and its development has been advanced.

The direct methanol fuel cell generates power based on the following reactions:
Anode: CH₃OH+H₂O→6H+6e⁻+CO₂
Cathode: 6H+6e⁻+3/2O₂→3H₂O

As is clear from the reactions, in a cathode, water is produced whose amount is three times as much as the amount of the water consumed in an anode. As a result, the water produced in a cathode requires disposal.

This type of fuel cell, however, is problematic in the following regards since disposal of the water produced in the cathode is required.

The first problem is that, for example, when this water is discharged from the portable device, water droplets caused by the emission of water and water vapor stick to the portable device. Also, when the portable device is put in a bag, pocket and the like in a state in which a fuel cell is activated, problems occur such that the bag and pocket can become wet.

In order to solve the first problem, a fuel tank is suggested which is structured so that an elastic film is provided in the fuel tank so as to accommodate fuel in a section on which the pressure of the elastic film is applied, and to accommodate produced water in a section on which negative pressure is applied in the fuel tank (for example, Japanese unexamined patent publication No. H04-223058).

A fuel tank is also suggested which is structured so that a pouched partition wall is formed in the fuel tank to accommodate produced water (for example, Japanese unexamined patent publication No. 2003-092128).

According to the respective suggestions, however, it is undeniable that the structures of the fuel cartridges become more complex and that the production cost of the fuel cartridges rise. Furthermore, the respective suggestions do not consider the recycling of the fuel tank. That is, according to the suggestion made in Japanese unexamined patent publication No. H04-223058, when fuel tanks are exchanged, produced water is discarded together with the fuel tank, and according to the suggestion made in Japanese unexamined patent publication No. 2003-092128, a highly water-absorbing material is employed for collecting produced water, and consequently, it is difficult to recycle fuel tanks in both cases. Therefore, even though these fuel tanks can collect produced water, the fuel tanks are disposable, and consequently the costs of employing the fuel tanks are increased.

Also, in the direct methanol fuel cell, the supply method of methanol as a fuel has not been established. For example, in a method in which a fuel tank attached to a fuel cell is to be exchanged every time the fuel is consumed, the abovementioned cost problem occurs. Therefore, a user has to supply methanol to either the fuel tank or the fuel cell. However, it is well known that methanol has toxic consequences, and when methanol is manually injected into a fuel tank, for example, it is possible that methanol could leak and cause danger to the human body by clinging to the user's skin and by being inhaled as methanol vapor, and the like.

The second problem is that an auxiliary device which disposes of carbon dioxide and water produced in the cathode is required to be mounted for continuous power generation.

An example of the structure of the fuel cell system of such a conventional DMFC system is disclosed in the specification of U.S. Pat. No. 5,599,638. This fuel cell system employs a fuel circulating system in which methanol solution as a fuel, which is accommodated in a circulation tank, is supplied to an anode using a pump for stable supply, and the residual methanol solution which has not been consumed in the anode is brought back to the circulation tank again to be collected for use as a fuel.

The water produced by power generation on the cathode side is collected by a water collector and sent to the circulation tank containing methanol solution.

However, in a DMFC system, such as the one shown in the abovementioned chemical formulas, 1 mol methanol and 1 mol water of the methanol solution supplied to the anode side is consumed to generate power, whereas 3 mol water is produced at the cathode side. Therefore, if all the produced water is collected to be supplied to the circulation tank, this accelerates the drop of the methanol solution concentration in the circulation tank severely, with the result that the available time to generate power is reduced and electric energy to be generated is also reduced.

On the other hand, another conceivable solution is that only part of the water produced in the cathode side is supplied to the circulation tank to prevent the severe drop of the methanol solution concentration. However, this solution, which can be employed as a fuel cell system for vehicles and large-sized devices, cannot be employed as a fuel cell system for portable electronics devices since it requires drainage of other water which is not collected in the circulation tank, and consequently, it is very likely that moisture clings to and dew condensation is formed on electronic devices and circuits incorporated in portable electronic devices, together with the drainage.

According to the fuel cell system employed for portable electronic devices in particular, its structure is required to be small-sized and its electric energy to be generated is small. Also, since the electric power for driving auxiliary devices such as a pump in the fuel cell system is self-consumed, it is required that the auxiliary devices are reduced to as small a number as possible so as to reduce electric power consumption under a situation in which electric energy is limited. For example, when the output for generating power in the fuel cell system is 12W, the electric power consumption of the auxiliary device is preferably equal to or less than 2W.

In the abovementioned conventional method, however, a number of auxiliary devices such as fuel supply devices for supplying fuel (for example, a fuel supply pump and the like) and water collecting facilities for collecting water (for example, a water collecting pump and the like) are required, so that the self-consumed electric power can not be reduced as well as the system itself becomes more complex and is difficult to be small-sized.

Accordingly, a technical problem to be solved by the present invention is to provide a filling-collecting device for fuel cells, a fuel cell system and a reusing device for a filling-collecting device for fuel cells, for example, in the fuel cell which generates power by supplying a liquid fuel such as methanol directly to an anode, which can miniaturize and simplify the structure of an auxiliary device in the fuel supply system and the like, and which can be employed for portable electronic devices such as personal computers and mobile phones.

### SUMMARY OF THE INVENTION

In order to achieve the above objective, this invention is structured as follows.

A first aspect of the present invention provides a filling-collecting device for fuel cells for use in a fuel cell system equipped with a fuel cell body having an anode, a cathode, and an electrolyte membrane disposed between the anode and the cathode, the filling-collecting device comprising:
a single container capable of defining a fuel accommodating space for filling for accommodating therein a liquid fuel undiluted solution to be fed to the anode side, and an effluent collecting space for accommodating therein effluents produced in the cathode;
a partition plate which is movably set inside the container along its axial direction and which divides interior of the container into two spaces of the fuel accommodating space for filling and the effluent collecting space; and
an effluent inlet opening and a fuel feed opening each of which is provided in the container, where the effluent inlet opening communicates with the effluent collecting space and serves for taking in effluents containing water and air from the cathode side of the fuel cell body, and the fuel feed opening communicates with the fuel accommodating space for filling and serves for feeding the liquid fuel undiluted solution stored inside thereof to the anode side of the fuel cell body, wherein
the partition plate is moved so as to narrow the fuel accommodating space for filling due to a pressure difference between pressures generated in the fuel accommodating space for filling and in the effluent collecting space so that the pressure of the fuel accommodating space for filling becomes lower, whereby the liquid fuel undiluted solution is fed from the fuel accommodating space for filling through the fuel feed opening and whereby the effluents produced on the cathode side is collected into the effluent collecting space through the effluent inlet opening.

According to the above structure, since the partition plate is provided which is movable in the axial direction in a filling and collecting container to form the fuel accommodating space and the effluent collecting space so as to move the partition plate by using the difference between the fuel accommodating space and the effluent collecting space in pressure, the fuel filling operation in the fuel tank in the fuel cell system and the effluent collecting operation from the effluent tank in the fuel cell system can be conducted in parallel in the same process. As a result, each operation time of fuel filling and effluent collection can be reduced to allow each operation to be quick.

A second aspect of the present invention provides a filling-collecting device for fuel cells for use in a fuel cell system equipped with a fuel cell body having an anode, a cathode and an electrolyte membrane disposed between the anode and the cathode, the filling-collecting device comprising:
a single container capable of defining a fuel accommodating space for filling for accommodating therein a liquid fuel undiluted solution to be fed to the anode side, and an effluent collecting space for accommodating therein effluents produced in the cathode;
a partition plate which is movably set inside the container along its axial direction and which divides interior of the container into two spaces of the fuel accommodating space for filling and the effluent collecting space; and
an effluent inlet opening, a water feed opening and a fuel feed opening each of which is provided in the container, where the effluent inlet opening communicates with the effluent collecting space and serves for taking in effluents containing water and air from the cathode side of the fuel cell body, the water feed opening serves for feeding the water stored in the effluent collecting space to the anode side of the fuel cell body, and the fuel feed opening communicates with the fuel accommodating space for filling and serves for feeding the liquid fuel undiluted solution stored inside thereof to the anode side of the fuel cell body, wherein
when the effluents stored in the effluent collecting space via the effluent inlet opening has caused an internal pressure of the effluent collecting space to become higher than a pressure of the fuel accommodating space for filling, thereby making the partition plate to be moved toward the fuel accommodating space for filling to pressurize the fuel accommodating space for filling, whereby the liquid fuel undiluted solution can be discharged through the fuel feed opening and whereby the water can be discharged through the water feed opening.

According to the second aspect of the present invention, since the filling-collecting device for fuel cells has the fuel supply opening to the fuel cell body, and is structured to separate the effluent collecting space and the fuel accommodating space for filling by the partition plate completely so that liquid fuel undiluted solution and effluent may not be mixed together, the change of liquid fuel in concentration never occurs. Also since the effluent accumulated in the effluent collecting space applies pressure on the partition plate from the effluent collecting space toward the side of the fuel accommodating space for filling, liquid fuel can be stably supplied to the fuel cell body without mounting a pump on the fuel cell body for supplying fuel.

Furthermore, since the effluent which contains water and air from the cathode applies pressure on the partition plate, another pressure applying mechanism becomes unnecessary in the filling-collecting device for fuel cells, so that the structure in the filling-collecting device for fuel cells can be simplified. Consequently, the complexity of the inner structure of the filling-collecting device for fuel cells can be prevented. Furthermore, since effluent is first lead to the effluent collecting space to feed the water of an amount which is consumed by the reaction in the anode from the effluent collecting space, a completely closed system is established without lowering the fuel concentration on the anode side and without releasing redundant moisture to the outside of the system.

In the filling-collecting device for fuel cells, there may be provided a gas-liquid separating mechanism in the effluent collecting space which separates water and air from the effluent so as to accumulate the water in the effluent collecting space as well as to discharge the air to the outside of the effluent collecting space.

The gas-liquid separating mechanism may be made up of a heat exchange device which is communicated with the effluent inlet opening and which is provided with a tube set arranged in the effluent collecting space so as to condense the moisture contained in the effluent into liquid water using the water collected in the effluent collecting space as a cooling medium.

The filling-collecting device for fuel cells may be further provided with a pressure regulating mechanism in the effluent collecting space for regulating the pressure in the effluent collecting space by the effluent from the fuel cell body, and the pressure regulating mechanism may be made up of components such as a pressure regulating valve located at the exterior wall of the effluent collecting space.

A third aspect of the present invention provides the filling-collecting device for fuel cells of the first aspect or second aspect, further comprising a fuel resupply connector and a water collecting connector each of which is provided in the container, where the fuel resupply connector is so provided as to communicate with the fuel accommodating space for filling and the water collecting connector is so provided as to communicate with the effluent collecting space and serves for collection of effluents stored in the effluent collecting space, wherein
in resupply of fuel, the water collecting connector and the fuel resupply connector are each connected to a reusing device which serves for resupplying fuel to the fuel accommodating space for filling, and the fuel is resupplied to the fuel accommodating space for filling, whereby the partition plate is moved toward the effluent collecting space so that effluents in the effluent collecting space can be discharged.

Also, as a fourth aspect of the present invention provides a fuel cell system comprising:
the filling-collecting device for fuel cells of the first aspect;
a fuel cell body having an anode for oxidizing fuel, a cathode for reducing oxygen, an electrolyte membrane disposed between the anode and the cathode, and a diffusion layer disposed on each surface of the electrolyte membrane;
a fuel feed line which makes the fuel feed opening and the anode communicated with each other so that the liquid fuel undiluted solution accommodated in the fuel accommodating space for filling can be fed to the anode;
an effluent collecting line which makes the cathode and the effluent inlet opening communicated with each other so that the effluents can be collected from the cathode into the effluent collecting space; and
a pressure difference generating mechanism for generating a pressure difference between the fuel accommodating space for filling and the effluent collecting space so that a pressure of the fuel accommodating space for filling becomes lower.

A fifth aspect of the present invention provides A fuel cell system comprising:
the filling-collecting device of second aspect;
a fuel cell body having an anode for oxidizing fuel, a cathode for reducing oxygen, an electrolyte membrane disposed between the anode and the cathode, and diffusion layers disposed on respective surfaces of the electrolyte membrane;
a water feed line which makes the water feed opening and the anode communicated with each other so that water contained in the effluents can be fed to the anode;
a first feed-quantity regulating unit for regulating quantity of water fed through the water feed opening so that concentration of fuel supplied to the anode becomes a specified value; and
a control unit for controlling the first feed quantity regulating unit by means of the effluents stored in the effluent collecting space so that the partition plate pressurizes the fuel accommodating space for filling with a specified pressure.

A sixth aspect of the present invention provides the fuel cell system of fourth aspect or fifth aspect, wherein
the pressure difference generating mechanism is equipped with an air pump for supplying air to the cathode; and
the air pump is an air supply pump which supplies air to the cathode so that the effluents produced in the cathode are collected to the effluent collecting space through the effluent collecting line and that the effluent collecting space is pressurized so as to make the partition plate moved toward the fuel accommodating space for filling, whereby the liquid fuel undiluted solution is supplied to the anode from the fuel accommodating space for filling through the fuel feed line.

According to the above aspects, an air supply device is the air supply pump which moves the partition plate from the effluent collecting space toward the side of the fuel accommodating space for filling so as to supply air in the cathode by the pressure which allows liquid fuel undiluted solution to be supplied from the fuel accommodating space for filling to the anode. That is, since the air supply device is the air supply pump which supplies air using this pressure as its discharge pressure, the collection in the discharge section and the resupply of liquid fuel can be conducted simultaneously.

A seventh aspect of the present invention provides the fuel cell system of fifth aspect, further comprising:
a second feed-quantity regulating unit for regulating a quantity of liquid fuel supplied to the fuel cell body, wherein
the control unit controls a second feed-quantity regulating unit so that the liquid fuel consumed by power generation in the fuel cell body is fed from the filling-collecting device for fuel cells to the anode side of the fuel cell body.

According to the above structure, since the second feeding amount adjustment means controls so that fuel of an amount which has been consumed is fed, power can be generate stably.

A eighth aspect of the present invent-ion provides the fuel cell system of fifth aspect, further comprising: a position detecting unit for detecting a position of the partition plate; and a fuel remaining quantity calculating unit for detecting remaining quantity of the liquid fuel accommodated in the filling-collecting device for fuel cells based on information concerning the position of the partition plate detected by the position detecting unit.

According to the above structure, since the filling-collecting device for fuel cells is energized toward the side of the fuel accommodating space by moving the partition plate so as to discharge liquid fuel undiluted solution, the residual amount of the liquid fuel undiluted solution in the filling-collecting device for fuel cells can be detected by detecting the position of the partition plate. Also, the partition plate may be located at a position which another member for detecting the position of the partition plate can detect.

The position detecting unit may be made up of the device which can detect the position of the partition plate contactlessly with the filling-collecting device for fuel cells.

The position detecting unit which can detect contactlessly may be made up of the magnet which is arranged at the partition plate and the detector which is located outside the filling-collecting device for fuel cells to detect the position of the magnet by detecting the magnetic field which is emitted from the magnet to transmit the exterior wall of the filling-collecting device for fuel cells.

There may be also provided a remaining electric energy calculating unit for calculating the electric energy which can be generated by the liquid fuel accommodated in the filling-collecting device for fuel cells based on the information on the remaining amount of the liquid fuel undiluted solution calculated by a fuel remaining quantity calculating unit, an electric energy consumption calculator for detecting the electric energy output from the fuel cell body and for calculating electric energy output per unit time based on the detected electric energy, and a remaining time calculator for calculating the available time left to generate power by the liquid fuel undiluted solution accommodated in the filling-collecting device for fuel cells based on the information on the electric energy which can generate power calculated by the remaining electric energy calculating unit and on the electric energy consumption per unit time calculated by the electric energy consumption calculator. The above structure allows the available time left to generate power by the liquid fuel undiluted solution accommodated in the filling-collecting device for fuel cells to be learnt.

A eighth aspect of the present invention provides the fuel cell system of any one of fourth aspect to seventh aspect, further comprising a fuel mixing tank for storing the liquid fuel fed from the filling-collecting device for fuel cells and water fed through the water feed opening.

According to the above structure, since there is provided the tank in which fuel and the water fed from the water feeding opening are mixed together to be accumulated, water and liquid fuel undiluted solution can be mixed together in the tank so that the concentration of the liquid fuel supplied to the anode can be easily controlled.

It is to be noted that the above structure is preferably further provided with a concentration detector for detecting the concentration of the liquid fuel in the fuel mixing tank so as to control the first feeding amount adjustment device and the second feeding amount adjustment device based on the detection signal from the concentration detection device so that the concentration of the fuel in the fuel mixing tank may be fixed.

Since at least the anode side of the fuel cell body is arranged in the fuel mixing tank, the liquid fuel in the fuel mixing tank can be used directly for the anode side, so that the structure can become simpler by omitting the pump for supplying liquid fuel from the tank to the anode.

A ninth aspect of the present invention provides the fuel cell system of any one of fourth aspect to eighth aspect, wherein the diffusion layer placed on the anode side has hydrophilicity, and the diffusion layer placed on the cathode side has hydrophobicity.

According to the above structure, the liquid fuel supplied to the anode is diffused through the diffusion layer having hydrophilic property on the anode side so as to be supplied to an electrolyte membrane quickly. For example, even when the liquid fuel to be supplied is supplied to only part of the diffusion layer, the capillary phenomenon by the hydrophilic property of the diffusion layer or the action of gravity can diffuse the liquid fuel to supply the liquid fuel over the entire surface of the electrolyte membrane evenly and efficiently. In the cathode, a product produced by power generation, for example, water, can be discharged by the diffusion layer having hydrophobic property on the cathode side. Also, since the diffusion layer has hydrophobic property, the water can be efficiently discharged to the outside of the cathode. Since the diffusion layer has hydrophobic property and the air supply device applies pressure on the inside of the cathode, there is also an effect that the crossover of transmitted liquid fuel from the anode side through the electrolyte membrane can be decreased.

Accordingly, the fuel cell system which can supply liquid fuel efficiently, which can discharge a product efficiently, and which generate power efficiently is provided in the fuel cell body. While such efficient power generation is made possible, the fuel cell system can also achieve miniaturization without the structure of the fuel cell system becoming complex.

A tenth aspect of the present invention provides a reusing device for filling-collecting device for fuel cells for use in connection with the filling-collecting device for fuel cells of third aspect, wherein
interior space thereof is partitioned into a filling fuel supply part where fuel is stored and an effluent accommodation part by a piston, where a fuel filling connector which is connectable with the fuel resupply connector of the filling-collecting device for fuel cells is provided in the filling fuel supply part, and an effluent collecting connector which is connectable with a water collecting connector of the filling-collecting device for fuel cells is provided in the effluent accommodation part, and
the piston is moved toward the filling fuel supply part, whereby fuel in the filling fuel supply part is supplied to the fuel accommodating space for filling of the filling-collecting device for fuel cells through the fuel resupply connector, while effluents in the effluent collecting space of the filling-collecting device for fuel cells are collected into the effluent accommodation part through the effluent collecting connector.

A eleventh aspect of the present invention provides a fuel cell system comprising:
a fuel cell body having an anode for oxidizing fuel, a cathode for reducing oxygen, an electrolyte membrane disposed between the anode and the cathode, an anode-side diffusion layer disposed on an anode-side surface of the electrolyte membrane and having hydrophilicity, and a cathode-side diffusion layer disposed on a cathode-side surface of the electrolyte membrane and having hydrophobicity;
a fuel feed line which makes the fuel feed opening and the anode communicated with each other so that the liquid fuel undiluted solution accommodated in the fuel accommodating space for filling can be fed to the anode;
one container capable of defining a fuel accommodating space for filling for accommodating therein a liquid fuel undiluted solution to be fed to the anode side, and an effluent collecting space for accommodating therein effluents produced in the cathode;
a partition plate which is movably set inside the container along its axial direction and which divides interior of the container into two spaces of the fuel accommodating space for filling and the effluent collecting space; and
a fuel feed opening and an air supply unit each of which is provided in the container, where the fuel feed opening communicates with the effluent collecting space and with the fuel accommodating space for filling of the fuel cell body and serves for feeding the liquid fuel undiluted solution stored inside thereof to the anode side of the fuel cell body, and the air supply unit supplies air to the cathode.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a schematic perspective view of a case in which a fuel cell system of each embodiment of the present invention is used as a fuel cell package for use in a battery for a personal notebook computer;

FIG. 2A is a perspective view showing one example of the connection method between a fuel cell body part and a fuel discharge opening and an effluent supply opening of a fuel tank in the fuel cell system shown in FIG. 1;

FIG. 2B is a perspective view showing an alternative example of the connection method between the fuel cell body part and the fuel discharge opening and the effluent supply opening in the fuel tank;

FIG. 3 is a sectional view showing the structure of the fuel tank when the connection method shown in FIGS. 2A and 2B is employed;

FIG. 4 is a perspective view showing the arrangement direction of a pressure release valve of the fuel tank for fuel cells;

FIG. 5A is an outlined structural diagram showing the structure of a fuel cell system of a first embodiment of the present invention;

FIG. 5B is a view of a modified example of a filling-collecting device for fuel cells shown in FIG. 5A;

FIG. 6 is a view showing an alternative modified example of the filling-collecting device for fuel cells shown in FIG. 5A;

FIG. 7 is an outlined structural diagram of a fuel cell system of a second embodiment of the present invention;

FIG. 8 is a schematic view showing a state in which a filling-collecting device for fuel cells and a reusing device for a filling-collecting device for fuel cells employed for the filling-collecting device for fuel cells shown in FIG. 7 are connected to each other;

FIG. 9 is a view showing a leakage prevention mechanism equipped for a filling-collecting device for fuel cells shown in FIG. 5A;

FIG. 10A is a sectional view of the leakage prevention mechanism shown in FIG. 7;

FIG. 10B is a sectional view of a plug part which is engaged with a socket part shown in FIG. 10A;

FIG. 11 is a view showing a state in which the socket part shown in FIG. 10A and the plug part shown in FIG. 10B are engaged with each other;

FIG. 12 is a view showing an alternative modified example of the filling-collecting device for fuel cells shown in FIG. 7;

FIG. 13 is a view of a modified example of the fuel cell system which is employed for the filling-collecting device for fuel cells shown in FIG. 12;

FIG. 14 is an outlined structural diagram showing the structure of a fuel cell system of a third embodiment of the present invention;

FIG. 15 is a schematic view showing the structure of a gas-liquid separating device which is employed for the fuel cell system of FIG. 14;

FIG. 16A is a schematic view showing the structure of a partition plate provided for a filling-collecting device for fuel cells which is employed in the fuel cell system of FIG. 14;

FIG. 16B is an enlarged sectional view of a part shown in FIG. 16A;

FIG. 17A is a schematic view showing the structure of the partition plate provided for the filling-collecting device for fuel cells employed in the fuel cell system of FIG. 14;

FIG. 17B is a sectional view taken on line A-A′ of FIG. 17A;

FIG. 18 is a schematic view showing the structure of a modified example of the filling-collecting device for fuel cells employed in the fuel cell system of FIG. 14;

FIG. 19 is a schematic view showing the structure in appearance of the filling-collecting device for fuel cells of FIG. 18;

FIG. 20 is a schematic view showing an alternative modified example of the filling-collecting device for fuel cells employed in the fuel cell system of FIG. 14;

FIG. 21 is a schematic view showing a further alternative modified example of the filling-collecting device for fuel cells employed in the fuel cell system of FIG. 14;

FIG. 22 is a schematic view showing a state in which the filling-collecting device for fuel cells and a reusing device for a filling-collecting device for fuel cells employed for the filling-collecting device for fuel cells shown in FIG. 21 are connected to each other;

FIG. 23A is a schematic view showing an upper limit position of a partition plate of the filling-collecting device for fuel cells shown in FIG. 21;

FIG. 23B is a schematic view showing a lower limit position of the partition plate of the filling-collecting device for fuel cells shown in FIG. 21;

FIG. 24 is an outlined structural diagram showing the structure of a fuel cell system of a fourth embodiment of the present invention;

FIG. 25 is a schematic view showing the structure of a fuel cell body employed for the fuel cell system of FIG. 24;

FIG. 26A is a front view of a separator on a cathode side of the fuel cell body of FIG. 25;

FIG. 26B is a sectional view taken on line B-B′ of FIG. 26A;

FIG. 27 is a schematic view showing the structure of a separator on an anode side of the fuel cell body of FIG. 25;

FIG. 28 is an outlined structural diagram showing the structure of a fuel cell system of a fifth embodiment of the present invention;

FIG. 29 is a schematic view showing the structure of a filling-collecting device for fuel cells employed in the fuel cell system of FIG. 28;

FIG. 30 is an enlarged sectional view of a part showing the structure of a partition plate of the filling-collecting device for fuel cells of FIG. 29;

FIG. 31 is a view showing an upper limit position and a lower limit position of the partition plate of the filling-collecting device for fuel cells of FIG. 29;

FIG. 32 is a block diagram showing the structure of a control unit employed in the fuel cell system of FIG. 28;

FIG. 33 is an outlined structural diagram of a fuel cell system of a sixth embodiment of the present invention;

FIG. 34 is a schematic structural view showing a fuel cell body for use in the fuel cell system of FIG. 33;

FIG. 35 is a schematic view showing the structure of a filling-collecting device for fuel cells employed in the fuel cell system of FIG. 33;

FIG. 36A is a schematic view showing the structure of the filling-collecting device for fuel cells of FIG. 35;

FIG. 36B is a sectional view taken on line B-B′ of FIG. 36A;

FIG. 37 is a schematic view showing a state in which the filling-collecting device for fuel cells and a reusing device for a filling-collecting device for fuel cells employed for the filling-collecting device for fuel cells shown in FIG. 35;

FIG. 38 is an explanatory diagram showing a specific example of the material balance of the fuel cell system of FIG. 33; and

FIG. 39 is a graph showing the relation among the amount of liquid fuel undiluted solution in a fuel tank, the volume of water accumulated in the fuel tank and the volume of water and fuel in total which are accumulated in the fuel tank in the fuel cell system of FIG. 33.

### DETAILED DESCRIPTION OF THE PREFERRED EMBODIMENTS

Before the description of the present invention proceeds, it is to be noted that like parts are designated by like reference numerals throughout the accompanying drawings.

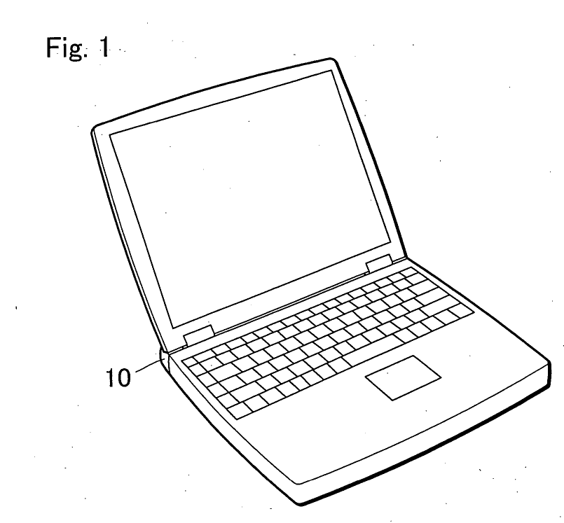

The fuel cell system of each embodiment, which can be structured to be small in size, is suitable for being attached to mobile devices such as mobile phones and small-sized and portable devices such as personal computers as shown in FIG. 1. It is to be noted that the component shown as 10 in FIG. 1 denotes the fuel cell system.

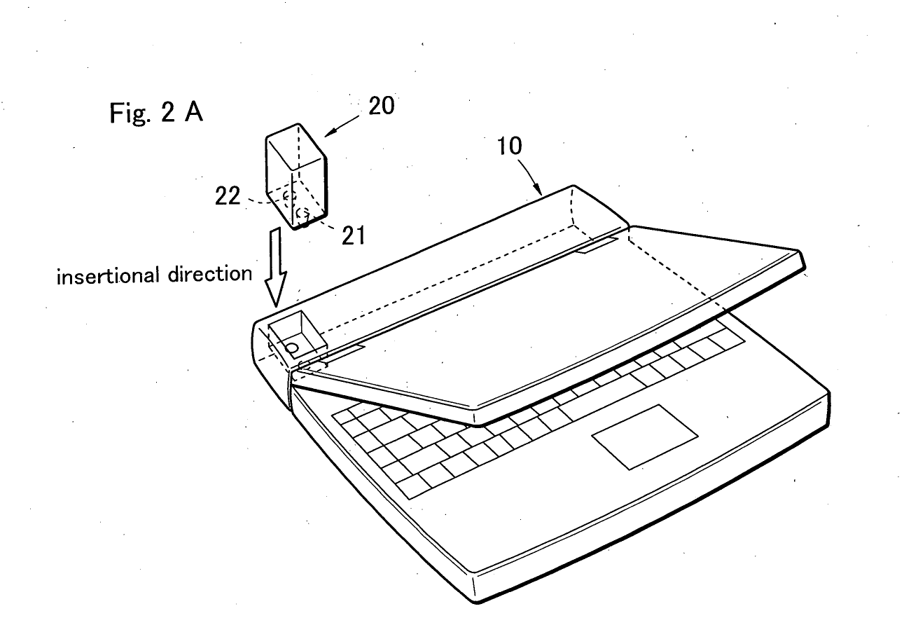

As will hereinafter be described, the fuel cell system of each embodiment is provided with a fuel cell tank 20 which is employed for supplying fuel to a fuel cell body. In the fuel cell system of each embodiment, as shown in FIG. 2A and FIG. 2B, a fuel discharge opening 21 and an effluent collection opening 22, both of which are connected to the fuel tank 20 are preferably arranged on one side face of the fuel tank 20 for fuel cells so that the fuel tank 20 for fuel cells can be attached and removed easily. That is, since the fuel discharge opening 21 and the effluent collection opening 22 are arranged on one side face, the connection thereof can be completed by simply inserting the fuel tank 20 for fuel cells into the part of the fuel cell body 10.

At this time, as will hereinafter be described, a pressure release valve 23 provided in the fuel tank is preferably arranged on a side face other than the bottom side face which is located in parallel with the direction orthogonal to the gravity direction, further preferably arranged on a different side face from the side face on which the fuel discharge opening 21 and the effluent collection opening 22 are arranged.

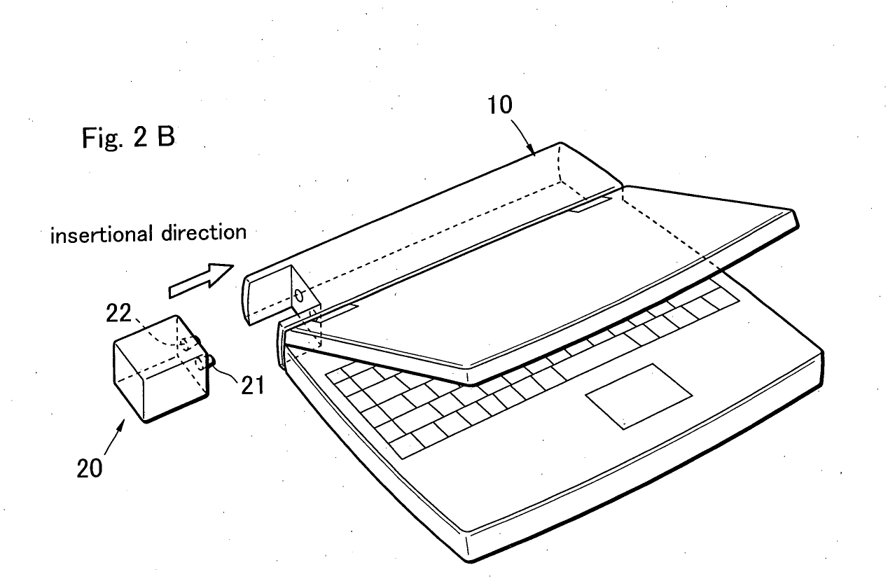

It is to be noted that in the fuel tank 20 for fuel cells shown in FIGS. 2A and 2B where the fuel discharge opening 21 and the effluent supply opening 22 on the same side face as described above, an effluent path 22a is arranged which connects the effluent collection opening 22 to an effluent collecting space which is a space for collecting effluent from the effluent supply opening 22. The effluent path 22a may have a structure which those skilled in the art easily conceive, for example, the structure in which the fuel tank 20 for fuel cells is partitioned by a partition wall, in which pipe is installed in the fuel tank 20 for fuel cells or in which the fuel tank 20 for fuel cells is formed by a guide rod whose interior is hollowed as shown in FIG. 3.

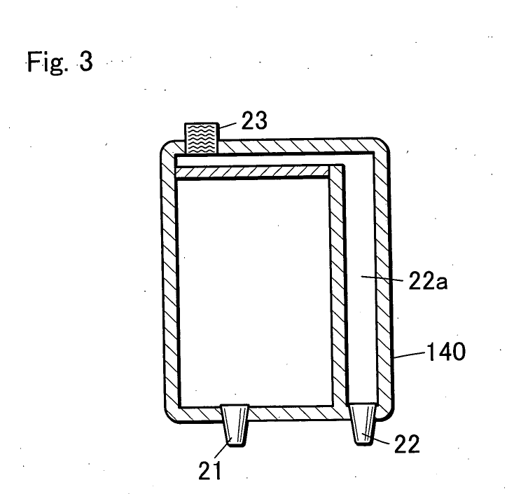

When the fuel cell system 10 is used as power source to devices, the pressure release valve 23 of the fuel tank is preferably arranged in a direction other than the directions of the device side and the human body side. The temperature of the fuel cell body of the fuel cell system reaches about 60° C. at the time of power generation, so that the temperature of the gas discharged from a cathode also reaches about 60° C., and the temperature of the gas discharged from the pressure release valve 23 is still several tens ° C. even though the gas is cooled to some extent. The discharged gas also contains water vapor. As a result, when the pressure release valve 23 is located on the device side and on the human body side, the device and the human body are negatively influenced by heat and moisture and the like. For example, as shown in FIG. 4, when the fuel cell system 10 is attached to a notebook personal computer, since a user sometimes uses the computer on the user's knees, it is impossible to employ a structure such that the pressure release valve 23 is orientated in the gravity direction 310d. It is also to be avoided that the pressure release valve 23 is orientated toward the computer side for the reasons described above. Consequently, in this case, the pressure release valve 23 is preferably orientated in the upward direction 310a, in the side face direction 310b and in the back face direction 310c.

Next, each embodiment of the fuel cell system of the present invention will be described.

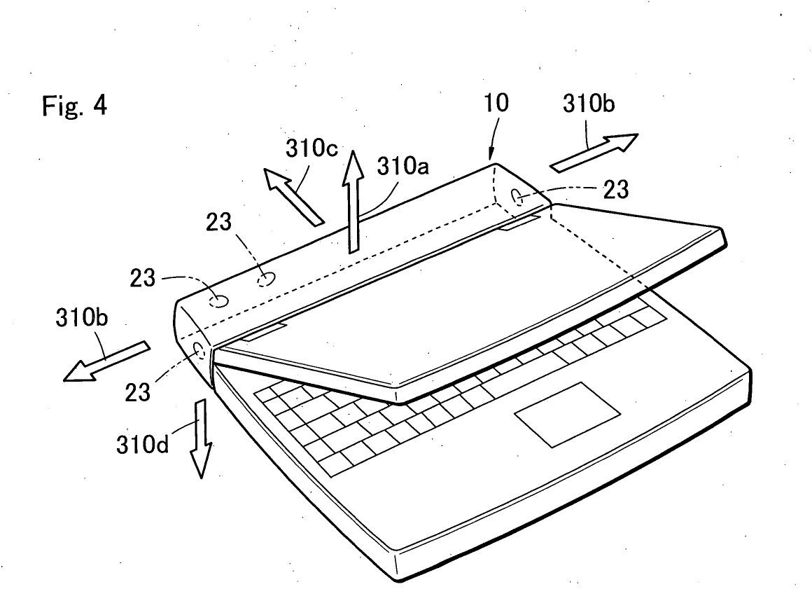

There is shown a first embodiment of the present invention. A fuel cell system 1010 of the first embodiment has the structure shown in FIG. 5A, and is provided with the filling-collecting device 1020 for fuel cells and a fuel cell system body 1001 which can be connected with the filling-collecting device 1020 for fuel cells.

The filling-collecting device 1020 for fuel cells is provided with a fuel filling mechanism 1060 for supplying fuel 100 for filling to the fuel cell system 1001 and an effluent collecting mechanism 1000 for collecting effluents produced in the fuel cell system 1010 from the fuel cell system 1010.

The fuel filling mechanism 1060 is provided with a fuel accommodation container 1040 for filling for accommodating the fuel 100 for filling, which is connected to a fuel buffer tank 1030 provided for the fuel cell system 1010 through the pipe 1015, a leakage prevention mechanism 1025 which is arranged adjacent to the outlet of the fuel accommodation container 1040 for filling, and for example, a solenoid type fuel supply pump 1014 for filling for supplying the fuel 100 for filling from the fuel accommodation container 1040 for filling to the fuel buffer tank 1030. It is to be noted that since the leakage prevention mechanism 1025 is provided, the fuel accommodation container 1040 for filling can be attached to and removed from the pipe 1015 which is connected to the fuel cell system 1010 or the fuel supply pump 1014 for filling.

The fuel accommodation container 1040 for filling is filled with fuel undiluted solution 100. As liquid fuel undiluted solution 100 for filling, organic solutions such as methanol and dimethyl ether are suitable examples, and methanol is particularly suitable. The constituent material of the fuel accommodation container 1040 for filling requires strength above a certain level so that the fuel accommodation container 1040 for filling can be distributed without modification, and for example, polymeric resins such as polyethylene terephthalate and polypropylene, and glass or metals such as aluminum and stainless may be employed. It is preferable that the volume of the fuel accommodation container 1040 for filling is sufficiently larger than, for example, several times to dozens of times as large as, the volume of the fuel buffer tank 1030 provided for the fuel cell system 1010, based on the standpoint that the exchange frequency of the fuel accommodation container 1040 for filling is lessen in the filling-collecting device 1020 for fuel cells. By way of example, when the volume of the fuel buffer tank 1030 is 50 ml, the volume of the fuel accommodation container 1040 for filling is about 500 ml.

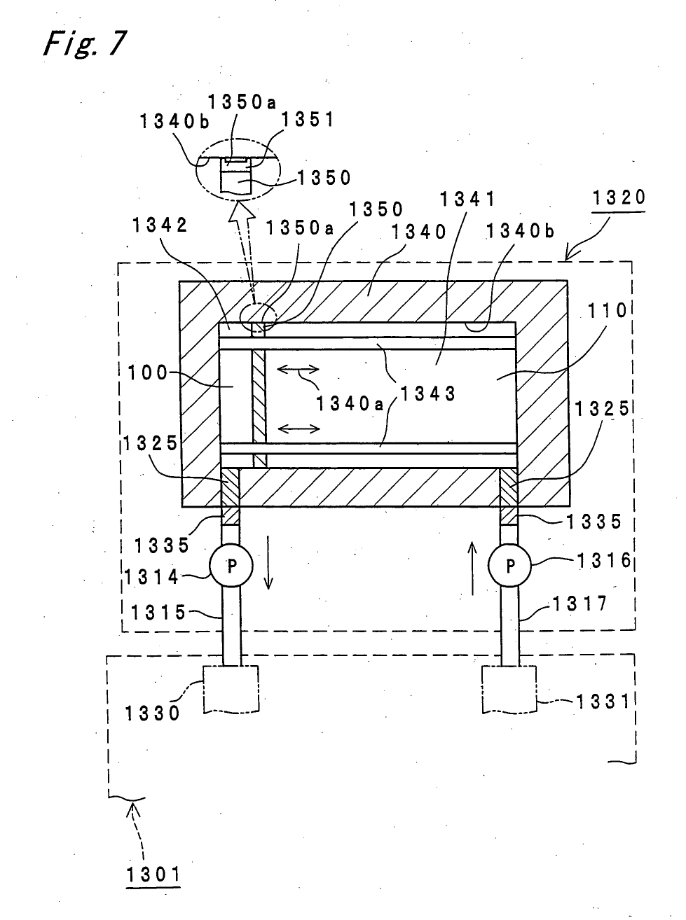

The leakage prevention mechanism 1025 is a mechanism for preventing the fuel 100 for filling from leaking from the fuel accommodation container 1040 for filling when the fuel accommodation container 1040 for filling is not connected to the fuel cell system body 1001, and the structure shown in FIG. 9 is an example for the mechanism.

The leakage prevention mechanism 1025 shown in FIG. 9 has a leakage prevention valve 1026 and a spring 1027 provided in the fuel accommodation container 1040 for filling. On the other hand, an extrusion pin 1029 is provided facing the leakage prevention mechanism 1025 in the pipe 1015 on the side of the fuel supply pump 1014 for filling. For the leakage prevention valve 1026 and the extrusion pin 1029, polymeric resins such as polyethylene and polypropylene, and metals such as aluminum and stainless can be employed.

In the leakage prevention mechanism 1025 thus structured, when the fuel accommodation container 1040 for filling is off the pipe 1015, the leakage prevention valve 1026 is attached firmly to an end connection 1028 by the shrinkage force of the spring 1027. The leakage of the fuel 100 for filling is thus prevented. On the other hand, when the fuel accommodation container 1040 for filling is connected to the pipe 1015, the extrusion pin 1029 is applied to the leakage prevention valve 1026 so as to press the leakage prevention valve 1026 against the shrinkage force of the spring 1027. As a result, the leakage prevention valve 1026 is off the end connection 1028 so that the fuel 100 for filling in the fuel accommodation container 1040 for filling can be supplied to the pipe 1015.

It is to be noted that the leakage prevention mechanism 1025 is not limited to the structure shown in FIG. 9, and may have a structure which is heretofore known or which those skilled in the art easily conceive.

An effluent collecting mechanism 1070 is provided with an effluent collection container 1050 which is connected to an effluent buffer tank 1031 of the fuel cell system 1010 through a pipe 1017, the leakage prevention mechanism 1025 which is arranged adjacent to the outlet of the effluent collection container 1050, and for example, a solenoid type pump for collecting effluent 1016 for supplying effluent 110 from the effluent buffer tank 1031 to the effluent collection container 1050. It is to be noted that since the leakage prevention mechanism 1025 is provided, the effluent collection container 1050 can be attached to and removed from the pipe 1017 which is connected to the fuel cell system body 1001 or the pump 1016 for collecting effluent.

The effluent collection container 1050, which is a container for collecting the effluent, may be made of the same material as the material of the fuel accommodation container 1040 for filling in the fuel filling mechanism 1060. The volume of the effluent collection container 1050 is preferably equal to the volume of the fuel accommodation container 1040 for filling, based on the standpoint that the exchange frequency of the fuel accommodation container 1040 for filling is made nearly equal to the effluent collection container 1050 in the filling-collecting device 1020 for fuel cells. The structure of the leakage prevention mechanism 1025 is the same as the structure of the fuel filling mechanism 1060.

The operations of the fuel supply pump 1014 for filling and the pump 1016 for collecting effluent are controlled in the filling-collecting device 1020 for fuel cells, in the fuel cell system body 1001 or in a control unit 400 which is arranged separately from the filling-collecting device 1020 for fuel cells and the fuel cell system body 1001.

Next, a description is given for the fuel cell system body 1001.

As shown in FIG. 5A, the fuel cell system body 1001 is provided with a fuel cell body 1000 as well as is further provided with the fuel buffer tank 1030, the effluent buffer tank 1031, a fuel mixing tank 1032, gas-liquid separating device 1033, a connection part 1034 for fuel which is arranged in the part of a supply opening 1030a of the fuel buffer tank 1030, and a connection part 1035 for effluent which is arranged in the part of the collection opening 1031a of the effluent buffer tank 1031. It is to be noted that although in the fuel cell system body 1001 pumps are respectively provided for a fuel supply system path to the fuel cell body 1000 and for a effluent discharge system path from the fuel cell body 1000, these pumps are not shown in the figure and the description for the operations thereof are omitted the fuel buffer tank 1030 and the effluent buffer tank 1031 may have such a structure as to be removed from the fuel cell system body 1001 respectively or together.

The fuel cell body 1000 is provided with a membrane electrode assembly 1002, an anode 1004 and a cathode electrode 1006. The anode 1004 is connected to a fuel circulation path 1036, and the cathode 1006 is connected to an air supply path 1037 and an effluent discharge path 1038.

The membrane electrode assembly 1002, which has a solid-state polymer electrolyte membrane, is arranged being sandwiched by the anode 1004 and the cathode 1006. The anode 1004 has a structure such that a catalyst for breaking down fuel to pick electrons, a diffusion layer of fuel and a separator as-a collector are laminated, and the cathode 1006 has a structure such that a reaction catalyst of proton and oxygen, a diffusion layer of air and a separator as a collector are laminated. As the catalyst of the anode 1004 and the cathode 1006, platinum and ruthenium are employed.

The cathode 1006 is connected to a motor-type air supply pump 1039, for example, which supplies 1 liter of air or oxygen per minute as gas oxidizer through the air supply path 1037 to the cathode 1006. The operation of the air supply pump 1039 is also controlled in the control unit 400.

The fuel buffer tank 1030 accommodates a fuel 101 which is the same liquid as the fuel 100 for filling, that is organic solutions such as methanol and dimethyl ether, methanol in particular, in which a discharge opening 1030c is connected to the fuel mixing tank 1032. As described above, a connection part 1034 for fuel is arranged in the part of the supply opening 1030a of the fuel buffer tank 1030, and the pipe 1015 which is connected to the fuel accommodation container 1040 for filling of the filling-collecting device 1020 for fuel cells is connected to the connection part 1034 for fuel so that the pipe 1015 can be attached to and removed from the connection part 1034 for fuel. Also, the connection part 1034 for fuel has the same structure as the structure of the leakage prevention mechanism 1025 described by reference to FIG. 9, and the supply opening 1030a of the fuel buffer tank 1030 is closed in a state in which the pipe 1015 is not connected to the connection part 1034 for fuel.

The supply opening 1031b of the effluent buffer tank 1031 is connected to the effluent discharge path 1038 which is connected to the cathode 1006, having the gas-liquid separating device 1033 on the midway of the effluent discharge path 1038. As the fuel cell body 1000 generates power, air and water are discharged from the cathode 1006, and since air is separated in the gas-liquid separating device 1033 to be discharged to outside, the effluents 110 such as water are supplied to the effluent buffer tank 1031 so that these effluents 110 are accumulated. Also, a discharge opening 1031c of the effluent buffer tank 1031 is connected to the fuel mixing tank 1032. As described above, the connection part 1035 for effluent is arranged in the part of the collection opening 1031a of the effluent buffer tank 1031, and the pipe 1017 which is connected to the effluent collection container 1050 of the filling-collecting device 1020 for fuel cells is connected to the connection part 1035 for effluent so that the pipe 1017 can be attached to and removed from the connection part 1035 for effluent. The connection part 1035 for effluent has the same structure as the structure of the leakage prevention mechanism 1025 described by reference to FIG. 9 and, the collection opening 1031a of the effluent buffer tank 1031 is closed in a state in which the connection part 1035 for effluent is not connected to the pipe 1017.

As described above, since the fuel 101 is supplied from the fuel buffer tank 1030 and the effluents 110 such as water are supplied from the effluent buffer tank 1031 to the fuel mixing tank 1032 respectively, a diluted fuel 120, that is the fuel 101 which is diluted, is accommodated in the fuel mixing tank 1032. Also, the fuel mixing tank 1032 is connected through a fuel circulation path 1036 to the anode 1004, and the gas-liquid separating device 1033 is arranged on the midway of the collection path to the fuel mixing tank 1032 from the anode 1004. As the fuel cell body 1000 generates power, the diluted fuel 120 which is unreacted and carbon dioxide gas are discharged from the anode 1004, and since carbon dioxide gas is separated in the gas-liquid separating device 1033 to be discharged to outside, the diluted fuel 120 is supplied to the fuel mixing tank 1031.

In the filling-collecting device 1020 for fuel cells which is structured as described above, the description is given hereinafter for the filling and collecting operations of the filling-collecting device 1020 for fuel cells when the filling-collecting device 1020 for fuel cells is connected to the fuel cell system body 1001. First, the operation of the fuel cell system 1010 structured as described above is described before the description of the filling and collecting operations.

The fuel 101 is supplied from the fuel buffer tank 1030 and the effluents 110 such as water are supplied from the effluent buffer tank 1031 to the fuel mixing tank 1032 respectively, so that the fuel 101 is diluted to a prescribed concentration, 2 mol for example, to become the diluted fuel 120. The diluted fuel 120 is supplied to the anode 1004. On the other hand, air or oxygen as an oxidizer, is supplied to the cathode 1006 by the air supply pump 1039 through the air supply path 1037. Consequently, the reaction is produced in the anode 1004 and the cathode 1006 by the carbon supported precious metal catalysts such as Pt and Pt-Ru in the anode 1004 and the cathode 1006, so that power is generated in the fuel cell body 1000.

Regarding the diluted fuel 120 which has passed the anode 1004 and the carbon dioxide gas which has been generated in the anode 1004, the carbon dioxide gas is separated in the gas-liquid separating device 1033 of the fuel circulation path 1036 to be discharged to outside, and the left diluted fuel 120 is returned to the fuel mixing tank 1032 to be circulated.

Also, regarding the gas which has passed the cathode 1006 and the effluents 110 such as water which have been generated in the cathode 1006, the gas is separated in the gas-liquid separating device 1033 of the effluent discharge path 1038 to be discharged to outside, and the left effluents 110 such as water are supplied to the effluent buffer tank 1031.

As power generation proceeds, the fuel 101 in the fuel buffer tank 1030 is consumed and the effluents 110 such as water increase in the effluent buffer tank 1031. When the fuel 101 in the fuel buffer tank 1030 reaches a prescribed amount, for example, when there is almost no amount left, the filling and collecting operations are conducted by the filling-collecting device 1020 for fuel cells. It is to be noted that although the water is produced in the cathode 1006 whose amount is three times as much as the water consumed in the anode 1004 as described above in theory, the sum of the amount of the consumed fuel and the amount of the consumed water can be made roughly equal to the amount of the produced water by setting the concentration of the diluted fuel 120 to be supplied to the anode 1004 appropriately, for example setting at 6.5% by weight.

The filling and collecting operations are described hereinafter.

The pipe 1015 which is connected to the fuel accommodation container 1040 for filling of the filling-collecting device 1020 for fuel cells and the pipe 1017 which is connected to the effluent collection container 1050 are connected to the connection part 1034 for fuel of the fuel buffer tank 1030 and the connection part 1035 for effluent of the effluent buffer tank 1031 in the fuel cell system body 1001, respectively.

It is to be noted that the pipe 1015 and the pipe 1017 may be arranged in the filling-collecting device 1020 for fuel cells together with the pump 1014 and the pump 1016 as in this embodiment, may be arranged as separated independent members, and may be arranged in the fuel cell system body 1001.

The pipe 1015 and the pipe 1017 are preferably structured so as to be connected to the connection part 1034 for fuel and the connection part 1035 for effluent simultaneously when the filling-collecting device 1020 for fuel cells is connected to the fuel cell system body 1001, from the standpoint of convenience and operationality and the like although the pipe 1015 and the pipe 1017 may be connected separately. Specifically, as shown in FIG. 3 described above, the pipe 1015 which is communicated with the fuel discharge opening 21 and the pipe 1017 which is communicated with the effluent supply opening 22 are preferably arranged on the same side face.

After the connection, the fuel supply pump 1014 for filling is activated so that the fuel 100 for filling accommodated in the fuel accommodation container 1040 for filling is supplied through the pipe 1015 and the connection part 1034 for fuel to the inside of the fuel buffer tank 1030. Also in, order to reduce operation time, in parallel with the supply operation of the fuel 100 for filling, the pump 1016 for collecting effluent is activated so that the effluents 110 such as water accommodated in the effluent buffer tank 1031 are collected through the connection part 1035 for effluent and the pipe 1017 in the effluent collection container 1050. At this time, small amounts of the effluents 110 such as water for diluting fuel are preferably left in the effluent buffer tank 1031.

When the supply of the fuel 100 for filling and the collection of the effluent 110 are completed, the fuel supply pump 1014 for filling and the pump 1016 for collecting effluent are stopped, and the pipe 1015 and the pipe 1017 are then taken out of the connection part 1034 for fuel and the connection part 1035 for effluent respectively to finish the filling and collecting operations.

As described above, since the filling-collecting device 1020 for fuel cells which can be attached to and removed from the fuel cell system body 1001 so that fuel is automatically supplied from the fuel accommodation container 1040 for filling to the inside of the fuel buffer tank 1030 through the pipe 1015, fuel can be safely supplied without being spilled out, and furthermore the effluent 110 accommodated in the effluent buffer tank 1031 can be automatically collected from the effluent buffer tank 1031 to the inside of the effluent collection container 1050 through the pipe 1017. As a result, the discharge of water vapor and the like from the fuel cell system 1010 to the outside can be prevented.

Since the filling-collecting device 1020 for fuel cells is provided with the leakage prevention mechanism 1025 and the volume of the filling-collecting device 1020 for fuel cells is made larger than the volume of the fuel buffer tank 1030, fuel leakage can be prevented at the time of connection to the fuel buffer tank 1030, and the exchange frequency of the fuel accommodation container 1040 for filling can be reduced.

It is to be noted that in the first embodiment although the filling-collecting device 1020 for fuel cells is provided with two independent containers of the fuel accommodation container 1040 for filling and the effluent collection container 1050, a single container may have the both functions of the fuel accommodation container 1040 for filling and the effluent collection container 1050 as shown in FIG. 5B. That is, as described above, since a container 1051 which accommodates the fuel 100 for filling becomes empty by supplying the fuel 100 for filling to the fuel buffer tank 1030, the empty container 1051 can be used for collecting the effluent 110 after fuel is supplied. It is to be noted that when a single container is thus used, there is preferably arranged a discriminator 1052 for discriminating an accommodated matter in the container 1051 as shown in FIG. 5B. For example, since the effluent 110 from the cathode 1006 contains formic acid as a by-product, the discriminator 1052 can employ a testing device which changes its color by the liquid property of the content and for example, litmus paper and the like for measuring the acidity in liquid can be employed as the testing device.

Also as a modified example, a single container in appearance in which a fuel accommodating space for filling and an effluent collecting space are formed can be employed.

Since an accommodation container for filling and an effluent collection container are formed into the same single container 1241, the recycling efficiency of the fuel accommodation container for filling can be improved and the cost thereof can be lowered.

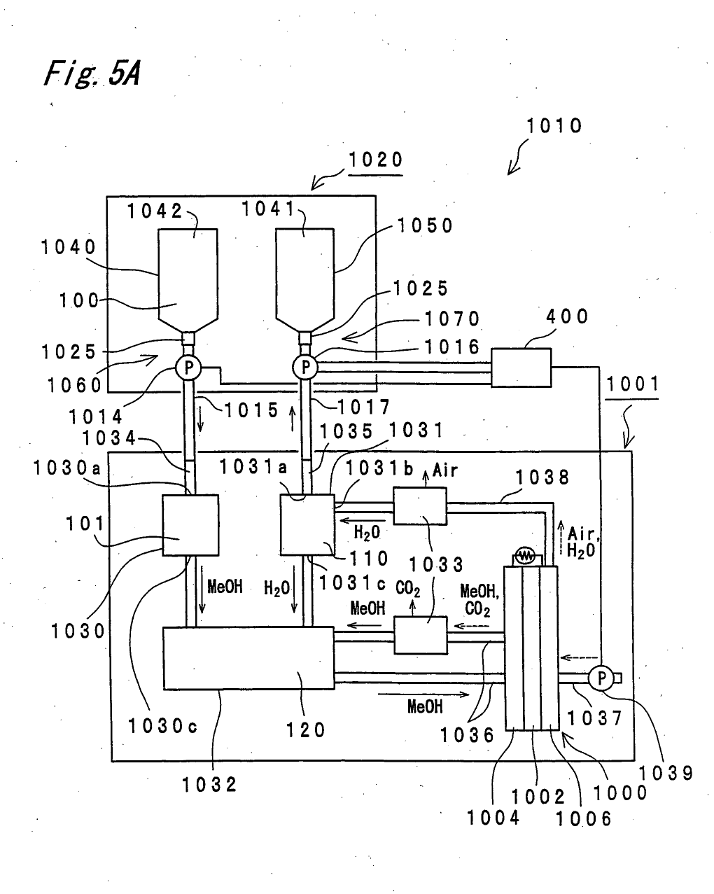

Furthermore, although two pumps of a fuel supply pump for filling 1114 and a pump for collecting effluent 1116 are arranged in the modified example of FIG. 5B, a single pump 1213 can be substituted for the two pumps by arranging a switching valve 1209 for switching flow path between a pipe 1215 and a pipe 1217 as shown in the alternative modified example of FIG. 6, so that the single container 1241 can be used. It is to be noted that a control unit 402 of FIG. 6, which corresponds to the control unit 401, controls the operations of the pump 1213, the switching valve 1209 and the air supply pump 1239.

Also in FIG. 6, although the structure in which the filling-collecting device 1220 for fuel cells has the pipe 1215 or the pipe 1217 is taken for example similarly to the case of FIG. 5A, the structure may be such that a fuel cell system body 1201 is provided with both of the pump 1213 and the switching valve 1209 or only the switching valve 1209. According to the structure, connection points between the filling-collecting device 1220 for fuel cells and the fuel cell system body 1201 can be combined into one.

Next, there is shown a second embodiment of the present invention.

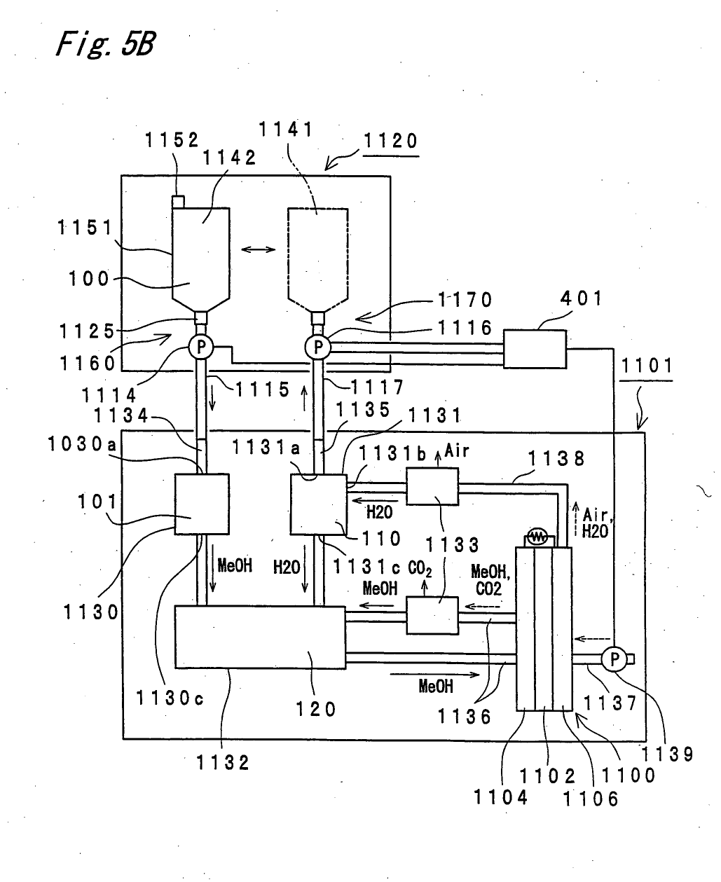

FIG. 7 shows a filling-collecting device 1320 for fuel cells of the second embodiment. The filling-collecting device 1320 for fuel cells is provided with a single filling and collecting container 1340 whose interior is hollowed, a partition plate 1350 which is arranged in the filling and collecting container 1340 so as to be movable along the axial direction 1340a of the filling and collecting container 1340 as well as so that the filling and collecting container 1340 is partitioned into an effluent collecting space 1341 and a fuel accommodating space 1342 for filling, and a leakage prevention mechanism 1325 as a connection part which can be attached to and removed from a pipe 1315 and a pipe 1317.

As the partition plate 1350, polymeric resins such as polyethylene terephthalate, polycarbonate, Teflon (trademark) and the like, glass and metals such as aluminum and stainless may be employed. Although the partition plate 1350 whose the thickness is thinner is preferable for improving initial fuel occupancy for filling in the filling and collecting container 1340, the partition plate 1350 which is too thin leads to lack of strength when pressure is applied. Therefore, the preferable thickness of the partition plate 1350 varies depending on the material employed for the partition plate 1350 and the size thereof.

In a contact part 1350a which is in contact with an inner face 1340b of the filling and collecting container 1340 in the partition plate 1350, an O-ring and the like made of an elastic member or a seal member 1351 in a shape shown in FIG. 7 are arranged, for example so that effluent accommodated in an effluent collecting space 1341 and fuel for filling in the fuel accommodating space 1342 may not be mixed with each other.

Furthermore, a guide member may also be arranged in the filling and collecting container 1340 for guiding the movement of the partition plate 1350 along the axial direction 1340a. As the guide member, bars 1343 which are arranged through the partition plate 1350 along the axial direction 1340a, and a recessed part or a projecting part and the like which are formed on the inner face 1340b of the filling and collecting container 1340 along the axial direction 1340a so as to engage with the partition plate 1350, are conceivable. It is to be noted that when the bars 1343 are employed, for example, seal members such as O-rings are arranged in through parts of the partition plate 1350 so as to prevent the leakage of effluent and fuel for filling in the through parts.

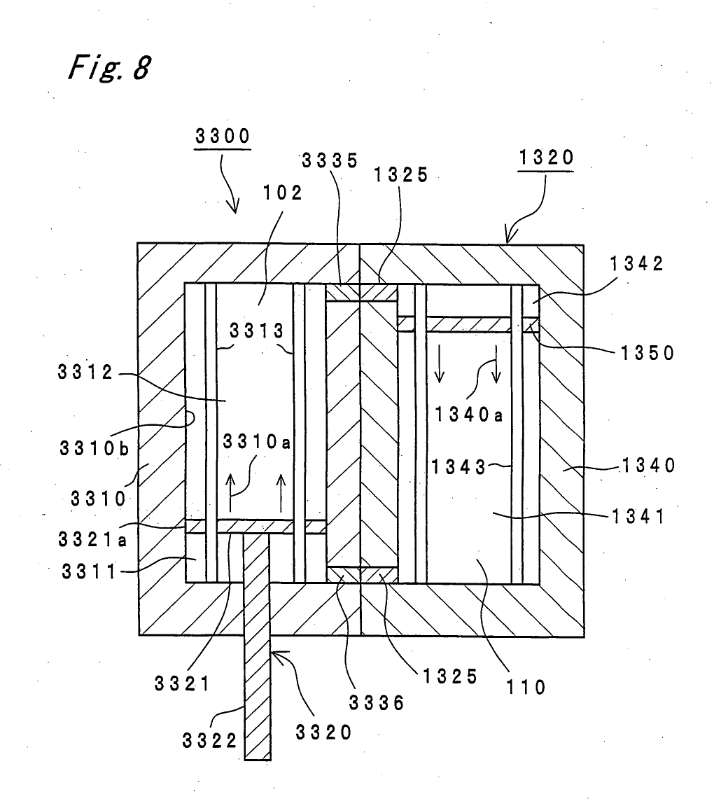

For the leakage prevention mechanism 1325, a socket part, shown in FIG. 10A by way of example, which is commercially available may be employed. The socket part 1325 is provided with a recessed part for inserting a plug 1326, a valve part 1327 and a spring 1329 for pressing the valve part 1327 against a valve seat part 1328. In the valve section 1327, seal members such as packing are arranged in the contact part with the valve seat, part 1328, and ordinarily, the valve part 1327 is pressed against the valve seat part 1328 by the spring 1329 so that the leakage of the fuel for filling and effluent is prevented from the filling and collecting container 1340 to the outside.

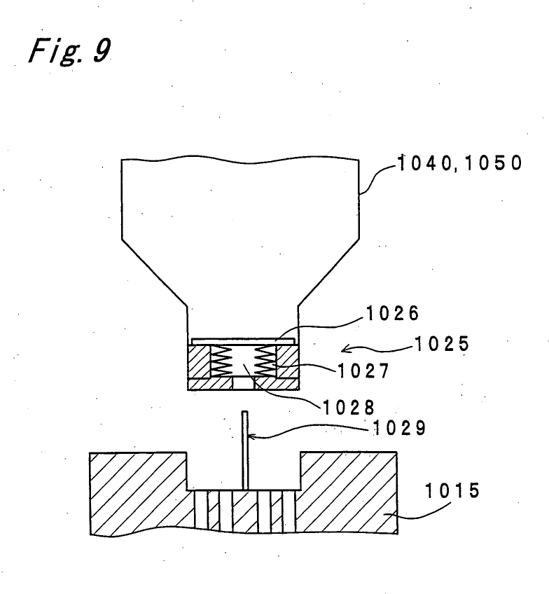

On the other hand, a commercially available plug part 1335 is arranged in each of the pipe 1315 and the pipe 1317, facing the socket part 1325. The plug part 1335, which can be connected to the socket part 1325 for example as shown in, FIG. 10B, is provided with a projecting part 1336 which is engaged with a recessed part for inserting a plug 1326 of the socket part 1325, a valve part 1337 and a spring 1339 for pressing the valve part 1337 against the valve seat part 1338. Since such a plug part 1335 is engaged with the recessed part for inserting a plug 1326 of the socket part 1325 so that the valve part 1327 and the valve part 1337 of both sides are in contact with each other as shown in FIG. 11, the contact of the valve part 1327 with the valve part 1337 and the contact of the valve seat part 1328 with the valve seat part 1338 are released so that a path for connecting the effluent collecting space 1341 to the pipe 1317 and a path for connecting the fuel accommodating space 1342 for filling to the pipe 1315 are respectively opened. Also, an O-ring 1332 for leakage prevention is arranged in the recessed part for inserting a plug 1326 so that liquid leakage from the connection part is prevented at the time of the connection of the socket part 1325 and the plug part 1335.

In the filling-collecting device 1320 for fuel cells of the second embodiment which is structured as described above, the description will be given for the filling and collecting operations of the filling-collecting device 1320 for fuel cells when connected to the fuel cell system body 1301. It is to be noted that the filling-collecting device 1320 for fuel cells is in an initial state in which the filling-collecting device 1320 for fuel cells is filled with the fuel 100 for filling, so that the partition plate 1350 is located on the side of the pipe 1317 in the filling and collecting container 1340, that is on the right side in the figure.

As described above, since the filling-collecting device 1320 for fuel cells is connected to the fuel cell system body 1301 by connecting the pipe 1315 and the pipe 1317 to the fuel buffer tank 1330 and the effluent buffer tank 1331 of the fuel cell system body 1301. And as described in the first embodiment, the effluents 110 such as water are accumulated in the effluent buffer tank 1331 as well as the fuel 101 is consumed in the fuel buffer tank 1330. Then, the pump for collecting effluent 1314 is activated as required so that the effluent 110 in the effluent buffer tank 1331 is supplied through the pipe 1317 to the effluent collecting space 1341 of the filling-collecting device 1320 for fuel cells. The pressure of the effluent collecting space 1341 is increased by the supplying operation to press the partition plate 1350, so that the partition plate 1350 moves along the axial direction 1340a to the left in the figure, that is toward the side of the fuel accommodating space 1342 for filling. The fuel 100 for filling which is accommodated in the fuel accommodating space 1342 for filling is applied pressure by this movement of the partition plate 1350, and is supplied to the inside of the fuel buffer tank 1330 of the fuel cell system body 1301 through the pipe 1315. That is, the pump for collecting effluent 1314 functions as a pressure difference generating mechanism.

Filling and collecting operations are conducted by repeating the abovementioned operations until the fuel 100 for filling accommodated in the fuel accommodating space 1342 for filling has been almost completely or completely consumed. It is to be noted that the inside of the filling-collecting device 1320 for fuel cells is filled with the effluent 110 in a state in which the fuel 100 for filling has been completely consumed.

As described above, the filling-collecting device 1320 for fuel cells achieves the same effects as the effects of the filling-collecting device 1020 for fuel cells of the abovementioned first embodiment that fuel can be safely supplied without being spilled out, that effluent 231 can be automatically collected, and further that the filling and collecting container 1340 as a single container can collect the effluent 110 from the effluent buffer tank 1331 of the fuel cell system body 1301 and supply the fuel 100 for filling to the fuel buffer tank 1330 simultaneously.

Also, since the filling-collecting device 1320 for fuel cells is made up of the filling and collecting container 1340 as a single container, the filling-collecting device 1320 for fuel cells can be connected to the fuel buffer tank 1330 and the effluent buffer tank 1331 at a time by connecting the filling-collecting device 1320 for fuel cells to the fuel cell system body 1301, so that the handling for attachment and removal is made much easier.

It is to be noted that since the collecting operation of the effluent 110 from the inside of the filling-collecting device 1320 for fuel cells presses the partition plate 1350 so that pressure is applied on the fuel 100 for filling in the filling-collecting device 1320 for fuel cells, the fuel supply pump for filling 1314 is not required to be arranged. As a result, the device structure can also be simplified together with the abovementioned simplification of the container.

Also, although the above description relates to the case in which the pump 1316 for collecting effluent is firstly activated, the fuel supply pump 1314 for filling may be activated firstly. The activation of the fuel supply pump 1314 for filling decreases the fuel 100 for filling in the fuel accommodating space 1342 for filling, and thereby the partition plate 1350 moves along the axial direction 1340a to the left in the figure. As a result, negative pressure is applied on the effluent collecting space 1341 to suck the effluent 110 into the effluent collecting space 1341 by the effluent buffer tank 1331. In this case, the arrangement of the pump 1316 for collecting effluent is not required. That is, the fuel supply pump 1314 for filling becomes a pressure difference generating mechanism in this case.

Also, although the first embodiment and the second embodiment relate to the case in which the fuel supply pump 1314 for filling and the pump 1316 for collecting effluent are provided for the filling-collecting devices 1020 to 1320 for fuel cells, this invention is not limited to the structure and the fuel supply pump 1314 for filling and the pump 1316 for collecting effluent may be provided for the fuel cell system bodies 1001 to 1301.

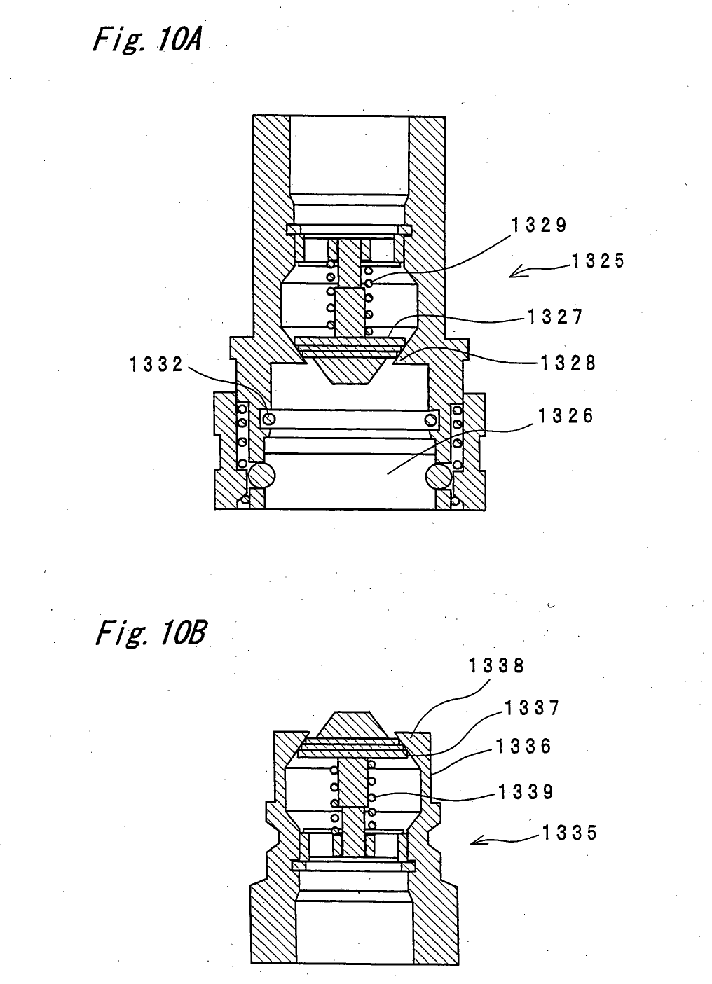

Also, as the modified example of the filling-collecting device 1320 for fuel cells of the second embodiment, a filling-collecting device 1420 shown in FIG. 12 may be structured. In the second embodiment, the partition plate 1350 moves by the operations of the fuel supply pump 1314 for filling and the pump 1316 for collecting effluent, whereas the filling-collecting device 1420 for fuel cells of the modified example moves by the piston 1455 so that the fuel supply pump for filling and the pump for collecting effluent are omitted. The structure for the rest of the filling-collecting device 1420 for fuel cells is similar to the structure of the filling-collecting device 1320 for fuel cells and the description thereof is omitted here.

The piston 1455 is provided with a partition plate 1456 and a rod 1457 which is protrusively provided on the partition plate 1456, extending along the axial direction 1440a through the filling and collecting container 1420 to reach outside. Also in the contact part of the partition plate 1456 with the inner face 1440b of the filling and collecting container 1420, a seal member 1451 is arranged, and also in the through portion of the rod 1457 of the filling and collecting container 1420 a seal member (not shown) is arranged for leakage prevention.

In the filling-collecting device 1420 for fuel cells, in an initial state, the fuel accommodating space 1442 for filling is filled with the fuel 100 for filling and the piston 1455 is located on the side of the pipe 1417, that is on the right side in the figure. When fuel is filled in, the pipe 1415 and the pipe 1417 are connected to the fuel buffer tank 1430 and the effluent buffer tank 1431 of the fuel cell system body 1401 so that the filling-collecting device 1420 for fuel cells is connected to the fuel cell system body 1401. After the connection, the piston 1455 is pressed toward the side of the pipe 1415 along the axial direction 1440a. Pressure is applied on the fuel 100 for filling which is accommodated in the fuel accommodating space 1442 for filling by pressing the piston 1455 so that the fuel 100 for filling is supplied to the inside of the fuel buffer tank 1430 through the pipe 1415. On the other hand, negative pressure occurs in the effluent collecting space 1441 by the movement of the piston 1455. Since negative pressure occurs in the effluent collecting space 1441, the effluent 110 in the effluent collection tank 1431 is sucked into the effluent collecting space 1441 through the pipe 1417. That is, in this embodiment the piston 1455 functions as a pressure difference generating mechanism.

As described above, the filling-collecting device 1420 for fuel cells achieves the same effects by the single operation of the piston 1455 as the abovementioned effects of the filling-collecting device 1320 for fuel cells of the second embodiment. Furthermore, the filling-collecting device 1420 for fuel cells eliminates the need for a fuel supply pump for filling and a pump for collecting effluent by using the piston 1455. Consequently, the filling-collecting device 1420 for fuel cells can further simplify the device structure as compared with the filling-collecting device 1320 for fuel cells.

It is to be noted that the operation of the piston 1455 may be conducted mechanically by using driving sources such as a motor, and may be conducted manually. When the piston 1455 is manually operated in particular, the device structure can be simplified.

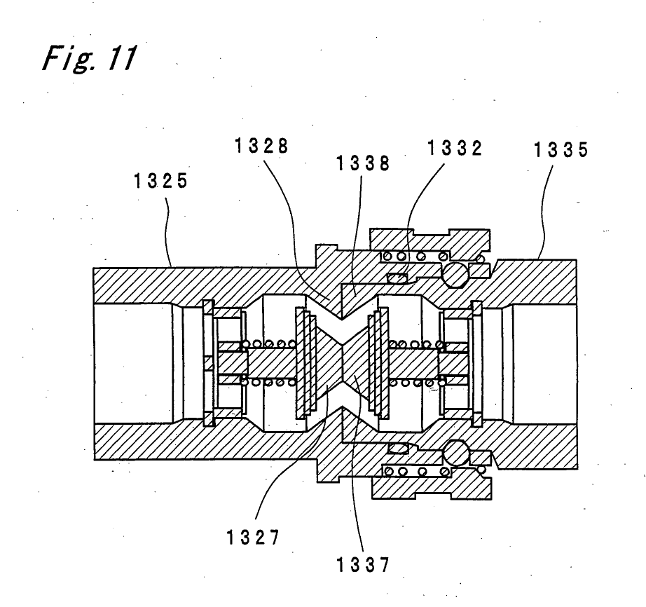

Furthermore, when the filling-collecting device 1420 for fuel cells is employed, it is also possible to connect to the fuel cell system 1403 as shown in FIG. 13. While the fuel cell system 1401 of FIG. 12 has a structure such that the fuel buffer tank 1330 and the effluent buffer tank 1431 are separately arranged, the fuel cell system 1403 of FIG. 13 is provided with a fuel effluent tank 1480 which is integrally composed as shown in the figure. It is to be noted that the structure for the rest of the fuel cell system 1403 is similar to the structure of the fuel cell system 1401 and the description thereof is omitted here. Also, the fuel effluent tank 1480 may have a structure such that the fuel effluent tank 1480 is removable from the fuel cell system 1403.

The fuel effluent tank 1480 internally has a partition plate 1483 which moves along the axial direction 1480a of the fuel effluent tank 1480, and the inside of the fuel effluent tank 1480 is partitioned into a fuel part 1481 and an effluent part 1482 by the partition plate 1483. It is to be noted that in the contact part of the partition plate 1483 with the inner face of the fuel effluent tank 1480, a seal member is arranged similar to the seal member which is arranged on the partition plate 1451 of the filling-collecting device 1420 for fuel cells. The fuel part 1481, which is a part for accommodating the fuel 101, is connected to a fuel mixing tank 1432 of the fuel cell system body 1403 as well as is removably connected to the fuel accommodating space 1442 for filling of the filling-collecting device 1420 for fuel cells through the pipe 1415. The effluent part 1482, which is a part for accommodating the effluent 110, is connected to the fuel mixing tank 1432 of the fuel cell system body 1403 as well as is removably connected to the effluent collecting space 1441 of the filling-collecting device 1420 for fuel cells through the pipe 1417.

In the fuel cell system 1403 thus structured, the fuel 101 in the fuel part 1481 is supplied to an anode 1404 by power generation in the fuel cell body 1400, and the effluent 110 is collected in the discharge part 1482 from a cathode 1406. The partition plate 1483 moves toward the side of the fuel part 1481 along the axial direction 1480a by the consumption of the fuel 101 and the collection of the effluent 110.

When the fuel 100 is filled in and the effluent 110 is collected, the filling-collecting device 1420 for fuel cells is connected to the fuel effluent tank 1480 of the fuel cell system body 1403 to press the piston 1455 of the filling-collecting device 1420 for fuel cells toward the left side in the figure, that is toward the side of the pipe 1415 so that pressure is applied on the fuel 100 for filling accommodated in the fuel accommodating space 1442 to be supplied to the fuel part 1481 of the fuel effluent tank 1480 through the pipe 1415. The fuel 101 in the fuel part 1481 presses the partition plate 1483 of the fuel effluent tank 1480 along the axial direction 1480b by the fuel supply operation. Consequently, the partition plate 1483 applies pressure on the effluent 110 in the discharge part 1482 of the fuel effluent tank 1480 so that the effluent 110 is delivered through the pipe 1417 to the effluent collecting space 1441 of the filling-collecting device 1420 for fuel cells.

Since the filling-collecting device 1420 for fuel cells and the fuel cell system 1403 are thus combined, when fuel is filled in and effluent is collected, fuel can be filled in and effluent can be collected simultaneously and efficiently by a single operation of pressing the piston 1455 with the connection of the fuel effluent tank 1480 and the filling-collecting device 1420 for fuel cells. Also, the device structure can be simplified without the need for a pump for filling fuel and for collecting effluent. When the piston 1455 is manually operated in particular, the fuel filling-collecting device 1420 for fuel cells does not require electric power, and consequently, the device structure can be further simplified.

Next, a description is given below for the reusing device which is connected to the filling-collecting device 1320 for fuel cells so as to refill the fuel 100 for filling in the filling-collecting device 1320 for fuel cells after the fuel 100 for filling is supplied to the fuel cell system body 1301 and so as to collect the effluent 110 which has been collected in the effluent collecting space 1341 in the second embodiment as described above.

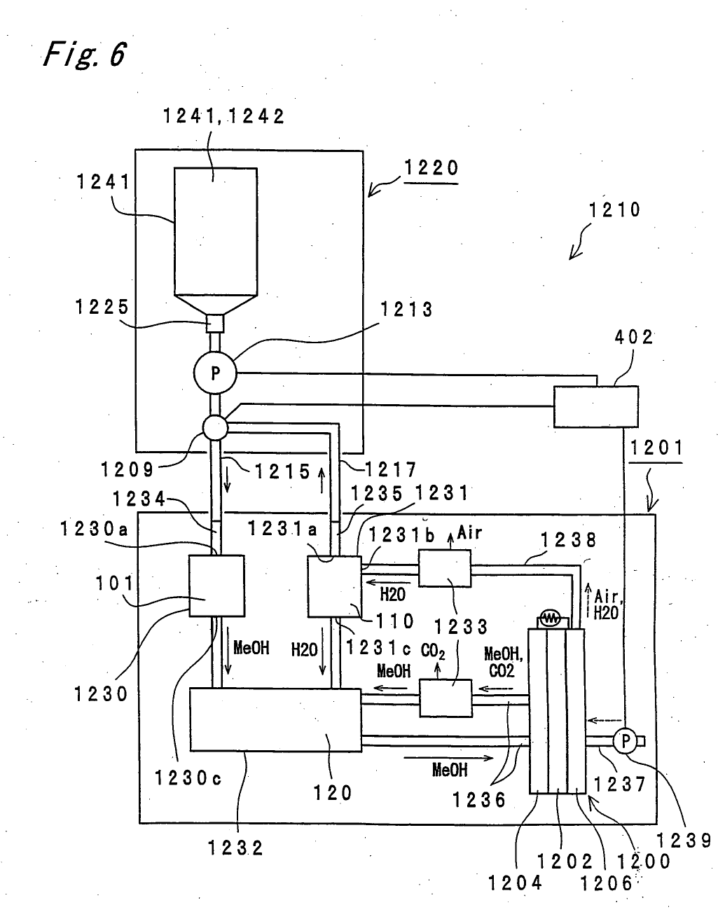

The reusing device 3300 shown in FIG. 8 is provided with a single reusing device casing 3310 whose interior is hollowed and which is the same size as the size of the filling-collecting device 1320 for fuel cells, a piston 3320 which is arranged in the reusing device casing 3310 and which is movable along the axial direction 3310a of the reusing device casing 3310, and a plug part 3336 and a plug part 3335 which are respectively engaged with the socket parts 1325 arranged at two positions in the filling-collecting device 1320 for fuel cells.

The piston 3320 has a partition plate 3321 for partitioning the interior of the reusing device casing 3310 into an effluent accommodation part 3311 and a filling fuel supply part 3312, and a rod 3322 which is protrusively provided on the partition plate 3321, extending along the axial direction 3310a through the reusing device casing 3310 to reach outside. Also in the contact part 3321a of the partition plate 3321 with the inner face 3310b of the reusing device casing 3310, for example, seal members such as an O-ring (not shown) are arranged as described above so that the effluent 110 accommodated in the effluent accommodation part 3311 and the fuel 102 for filling accommodated in the filling fuel supply part 3312 may not be mixed with together. Also, in the portion of the rod 3322 for passing through the reusing device casing 3310, a seal member is arranged for leakage prevention.

As a material for such a piston 3320, polymeric resins such as polyethylene, polypropylene and Teflon (trademark) are preferable.

Also, a guide member may be arranged in the reusing device casing 3310 for guiding the movement of the piston 3320 along the axial direction 3310a. As the guide member, bars 3313 which are arranged through the partition plate 3321 along the axial direction 3310a, a recessed part or a projecting part which are formed in the inner face 3310b of the reusing device casing 3310 along the axial direction 3310a so as to engage with the partition plate 3321 and the like, are conceivable.

The description is given hereinafter for the regenerating operation of the filling-collecting device 1320 for fuel cells using the reusing device 3300 which is thus structured. It is to be noted that the reusing device 3300 is set to a state in which the reusing device 3300 is filled with the fuel 102 for filling and that the filling-collecting device 1320 for fuel cells is set to a state in which the filling-collecting device 1320 for fuel cells is filled with the effluent 110 to some extent or completely.

As shown in FIG. 8, the socket part 1325 in the effluent collecting space 1341 of the filling-collecting device 1320 for fuel cells and the plug part 3336 in the effluent accommodation part 3311 of the reusing device 3300 are connected, as well as the socket part 1325 in the fuel accommodating space 1342 for filling of the filling-collecting device 1320 for fuel cells and the plug part 3335 in the filling fuel supply part 3312 of the reusing device 3300 are connected. As a result, the effluent collecting space 1341 is communicated with the effluent accommodation part 3311, as well as the fuel accommodating space 1342 for filling is communicated with the filling fuel supply part 3312. It is to be noted that FIG. 8 shows a state before regeneration operation is conducted.

Next, an operator presses the rod 3322 of the piston 3320 along the axial direction 3310a. The fuel 102 for filling which is accommodated in the filling fuel supply part 3312 of the reusing device 3300 is supplied to the fuel accommodating space 1342 for filling of the filling-collecting device 1320 for fuel cells through the socket part 1325 and the plug part 3335 by pressing the piston 3320 toward the side of the filling fuel supply part 3312. The partition plate 1350 of the filling-collecting device 1320 for fuel cells presses the effluent 110 in the effluent collecting space 1341 by the supply of the fuel 102 for filling to the fuel accommodating space 1342 for filling. As a result, the effluent 110 is supplied to the effluent accommodation part 3311 of the reusing device 3300 through the socket part 1325 and the plug part 3336. The filling-collecting device 1320 for fuel cells is thus filled with the fuel 102 for filling, whereas the reusing device 3300 is filled with the effluent 110.

It is to be noted that the above-mentioned regenerating operation is conducted without any problem even when remaining fuel is left in the fuel accommodating space 1342 for filling of the filling-collecting device 1320 for fuel cells, and that the regenerating operation is conducted without any problem even when the amount of the fuel 102 for filling accommodated in the filling fuel supply part 3312 of the reusing device 3300 is smaller than the capacity of the fuel accommodating space 1342 for filling. In the latter case, although the discharge of the effluent 110 of the effluent collecting space 1341 of the filling-collecting device 1320 for fuel cells is left half-finished, the operation of the fuel cell system body 1301 itself is not affected.

Next, description is given for the third embodiment of the present invention.

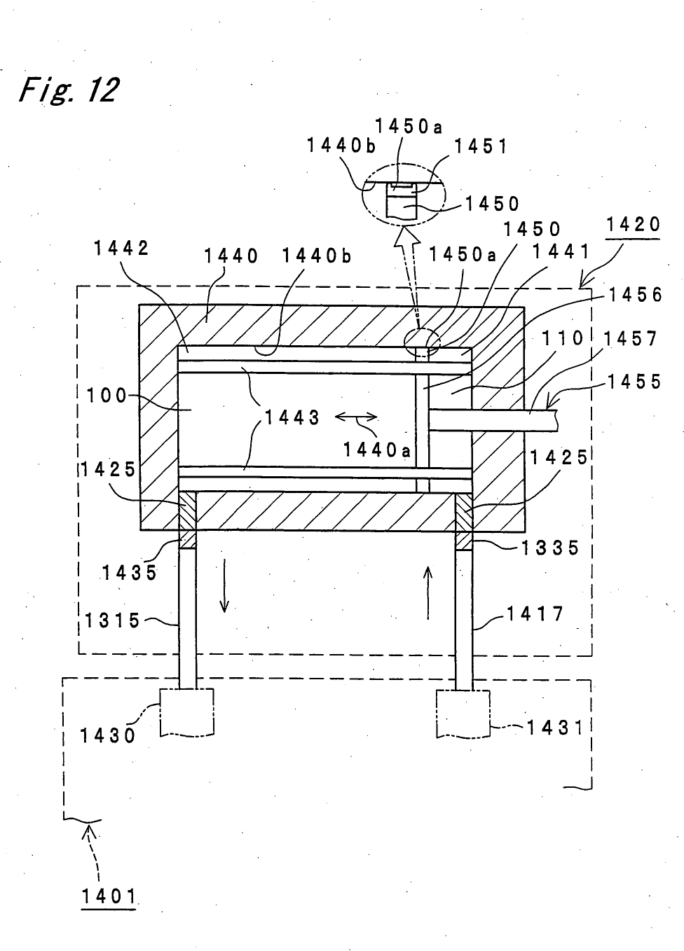

FIG. 14 is an outlined structural diagram showing the schematic structure of the fuel cell system 1510 of the third embodiment of the present invention.

As shown in FIG. 14, the fuel cell system 1510 is provided with a fuel cell body 1500 which is a power generation section for generating power by converting chemical energy of fuel into electrical energy electrochemically, and an auxiliary device system for supplying fuel and the like to the fuel cell body 1500 and the like. Also, this fuel cell system 1510 is a direct methanol fuel cell (DMFC) which generates power with methanol solution which is an example of an organic liquid fuel as a fuel by taking out protons directly from this methanol.

As shown in FIG. 14, the fuel cell body 1500 is provided with an anode (fuel electrode) 1504, a cathode (air electrode) 1506, a membrane electrode assembly 1502 which is arranged between the anode 1504 and the cathode 1506, and an anode side diffusion layer 1507 and a cathode side diffusion layer 1508 as diffusion layers which are respectively arranged on the surface of the electrolyte membrane of the membrane electrode assembly 1502. The anode 1504 has a function to react the supplied methanol oxidatively to take out protons and electrons (anode reaction). The electron moves to the cathode 1506 through an external circuit (power generation circuit), not shown, which electrically connects the anode 1504 and the cathode 1506, and the proton moves to the cathode 1506 through the membrane electrode assembly 1502. The cathode 1506 also has a function to deoxidize to produce water by using oxygen supplied from outside, the proton which moves from the anode 1504 through the membrane electrode assembly 1502 and the electron which passes through the external circuit (cathode reaction). Thus, oxidative reaction is conducted in the anode 1504 and reductive reaction is conducted in the cathode 1506 respectively so as to pass electrons through the external circuit, so that electric current is produced to generate power.

Specifically, as the membrane electrode assembly 1502 for example, the membrane electrode assembly is employed whose crossover of liquid fuel is made 1/10 of a conventional membrane electrode assembly. On one surface of the membrane electrode assembly 1502, platinum and ruthenium or alloyed metal of platinum and ruthenium are dispersedly allowed to be supported on a carbon powder carrier as an anode catalyst for the anode 1504, and on the other surface of the membrane electrode assembly 1502, platinum fine particles are dispersedly allowed to be supported on a carbon carrier as a cathode catalyst for the cathode 1506. This membrane electrode assembly 1502 where a catalyst is formed, is called as a membrane electrode assembly. The diffusion layer 1507 on the anode side is carbon paper to which hydrophilic treatment is applied for example, and the diffusion layer 1508 on the cathode side is carbon paper to which hydrophobic treatment is applied for example. It is to be noted that in such hydrophilic property treatment, hydrophilic property can be enhanced by activating carbon paper by water vapor. In hydrophobic property treatment, hydrophobicity can be imparted by impregnating carbon paper with fluororesin dispersions such as polytetrafluoroethylene. The fuel cell body 1500 can be formed by making the respective diffusion layer 1507 and diffusion layer 1508 into close contact with the surface of the electrolyte membrane of the membrane electrode assembly and then fixing the diffusion layer 1507 and diffusion layer 1508 to a housing through a separator. The respective diffusion layer 1507 and diffusion layer 1508 are also used as electrodes.

It is to be noted that for the diffusion layer 1507 and the diffusion layer 1508, carbon cloth may be substituted for the carbon paper. As the membrane electrode assembly 1502, for example, crossover can be reduced by using Dupont's Nafion (trade name) triply. Also as membrane electrode assembly 1502 for example, a fine-pore filling electrolyte membrane, that is a porous membrane having fine pores of submicron order in which electrolyte polymer is filled, and ceramic porous material in which electrolyte polymer is filled may be employed.

As shown in FIG. 14, the anode 1504 is provided with a fuel supply opening 1509 for supplying methanol solution to the inside so that the anode reaction is produced, and a discharge valve 1511 is arranged in the fuel supply opening 1509 for discharging carbon dioxide produced by the anode reaction.

Also, the cathode 1506, which uses air for example, to supply oxygen used for producing the cathode reaction, is provided with an air supply opening 1512 for supplying the air to the inside, and a discharge opening 1513 for discharge water (both cases included of either state of liquid phase or vapor phase, and a state in which liquid phase or vapor phase are contained) produced by the cathode reaction from the inside. It is to be noted that this effluent contains water in major proportions, but also sometimes contains formic acid, formic acid methyl and methanol (by crossover which will be described).

Description is now given of the structure of the auxiliary equipment system in the fuel cell system 1510. The auxiliary equipment system is composed of auxiliary equipment for feeding a methanol solution to the anode 1504 of the fuel cell body 1500, auxiliary equipment for feeding air to the cathode 1506, and auxiliary equipment for collecting water, i.e., a product produced in the cathode 1506.

As shown in FIG. 14, as the auxiliary device structure for fuel supply, there are provided a filling-collecting device 1520 for fuel cells for accommodating methanol solution as liquid fuel so that the methanol solution can be supplied to the anode 1504, and a fuel supply line 1536 for connecting the filling-collecting device 1520 for fuel cells to the fuel supply opening 1509 of the anode 1504.

The filling-collecting device 1520 for fuel cells has, in its inner space, a fuel accommodating space 1542 for filling for accommodating liquid fuel undiluted solution, and a effluent collecting space 1541 mainly for collecting water as effluents produced in the cathode 1506. The filling-collecting device 1520 for fuel cells is also provided with a partition plate 1550 which is movable along the inner wall of the filling-collecting device 1520 for fuel cells for partitioning the inner space into the fuel accommodating space 1542 for filling and the effluent collecting space 1541. That is, according to filling-collecting device 1520 for fuel cells, since the partition plate 1550 moves to move the position of the partition, the volume of the fuel accommodating space 1542 for filling and the volume of the effluent collecting space 1541 can be varied. It is to be noted that since the total amount of the volume of the fuel accommodating space 1542 for filling and the volume of the effluent collecting space 1541 is set to the volume of the filling-collecting device 1520 for fuel cells, when either volume of the fuel accommodating space 1542 for filling or the effluent collecting space 1541 is increased, the other volume is decreased by the increased volume.

Also, one end of the fuel supply line 1536 is connected to the fuel accommodating space 1542 for filling so that the liquid fuel undiluted solution which is accommodated in the fuel accommodating space 1542 for filling can be supplied to the anode 1504 through the fuel supply line 1536 from the fuel supply opening 1509. On the midway of the fuel supply line 1536, a regulating valve 1560 is arranged which can regulate the amount of the liquid fuel undiluted solution supplied through the fuel supply line 1536 (flow rate). It is to be noted this regulating valve 1560 can close the fuel supply line 1536 which is communicated with the fuel accommodating space 1542 for filling by closing the openness of the regulating valve 1560. In the fuel accommodating space 1542 for filling of the filling-collecting device 1520 for fuel cells, methanol solution is accommodated whose concentration is 63.8 wt % in weight percent in an initial state as liquid fuel undiluted solution.

Next, as the auxiliary device structure for supplying air, there are provided an air supply line 1537 whose one end is connected to the air supply opening 1512 of the cathode 1506 and an air supply pump 1539 which is arranged on the midway of the air supply line 1537 for supplying air through the air supply line 1537 to the inside of the cathode 1506. As this air supply pump 1539, a pump which is small-sized and requires little power is preferably employed, and for example, a motor-type pump (with a check valve, discharge rate: 0-2 L/min., discharge pressure: 30 kPa) is employed which supplies air at the rate of 1 L/min when used, for example. Also, when power is generated in the fuel cell body 1500, the air supply pump 1539 is driven to supply air of necessity (or oxygen) to the inside of the cathode 1506, and when the power generation is stopped, the drive of the air supply pump 1539 is also stopped.

Also, as the auxiliary device structure for collecting the water, the discharge opening 1513 of the cathode 1506 and a water collection line 1538 which is communicated with the effluent collecting space 1541 of the filling-collecting device 1520 for fuel cells so as to supply the water which is produced in the cathode 1506 to the effluent collecting space 1541 to collect the water.

While effluent which contains water in major proportions is produced by power generation in the cathode 1506, air is supplied to the inside of the cathode 1506 by the air supply pump 1539. As a result, the mixture of this effluent and air (for example, air-liquid mixture) is discharged from the cathode 1506 through the discharge opening 1513 to the water collection line 1538. This mixture often contains produced water as water vapor. Therefore, there is provided a gas-liquid separating device 1533 on the midway of the water collection line 1538 for separating such a mixture in a state in which gas and liquid are mixed together, into gas and liquid so as to discharge the liquid to the water collection line 1538. There is further provided a valve 1561 in the water collection line 1538 which is arranged between the gas-liquid separating device 1533 and the filling-collecting device 1520 for fuel cells, for closing the water collection line 1538 to the effluent collecting space 1541.

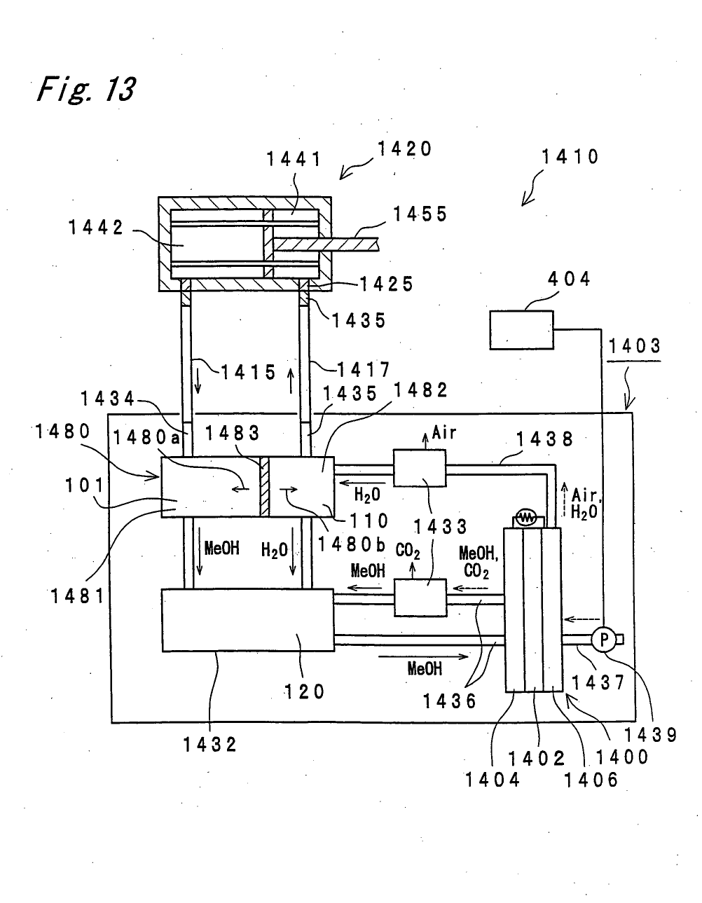

Here, FIG. 15 is a schematic view showing the schematic structure of the gas-liquid separating device 1533. As shown in FIG. 15, the gas-liquid separating device 1533 is provided with a gas-liquid separating chamber 1533a for accommodating the water 110 which is the effluent discharged from the cathode on the lower side thereof and accommodating the gas 112 on the upper side thereof respectively and separately, an inlet pipe 1521 which is the end of the water collection line 1538 toward the cathode 1506 and which is arranged on the lower side of the space in this gas-liquid separating chamber 1533a, a pressure regulating valve 1562 which is communicated with the space on the upper side of the gas-liquid separating chamber 1533a for regulating the space to a prescribed pressure by discharging extra gas accommodated in the space, and a water discharge opening 1522 which is arranged adjacent to the bottom of the gas-liquid separating chamber 1533a.

As shown in FIG. 15, the inlet pipe 1521 is arranged so as to be immersed in the water 110 accommodated in the gas-liquid separating chamber 1533a, and is further spirally bent, for example, so that the contact area of the water with the external surface of the inlet pipe 1521 is increased. Since the inlet pipe 1521 has such an arrangement and a shape, when the mixture of water and air sent through the water collection line 1538 is passed through the inlet pipe 1521, the inlet pipe 1521 exchanges heat with the surrounding water for condensing the mixture so that the mixture in a liquefied state can be introduced to the gas-liquid separating chamber 1533a. The gas left in the mixture moves to the upper side of the gas-liquid separating chamber 1533a. On the other hand, since the water discharge opening 1522 is arranged adjacent to the bottom of the gas-liquid separating chamber 1533a, the water 110 on the lower side of the chamber can be discharged through the water discharge opening 1522 without letting the gas 112 on the upper side of the chamber out. It is to be noted that the water which is discharged through the water discharge opening 1522 is accommodated through the water collection line 1538 in the effluent collecting space 1541 of the filling-collecting device 1520 for fuel cells. Also the mixture and water through the water collection line 1538 is thus circulated by the pressure applied in the cathode 1506 by drive of the air supply pump 1539 so as to deliver the mixture of water and air produced in the cathode 1506 through the discharge opening 1513 to the inside of the water collection line 1538.

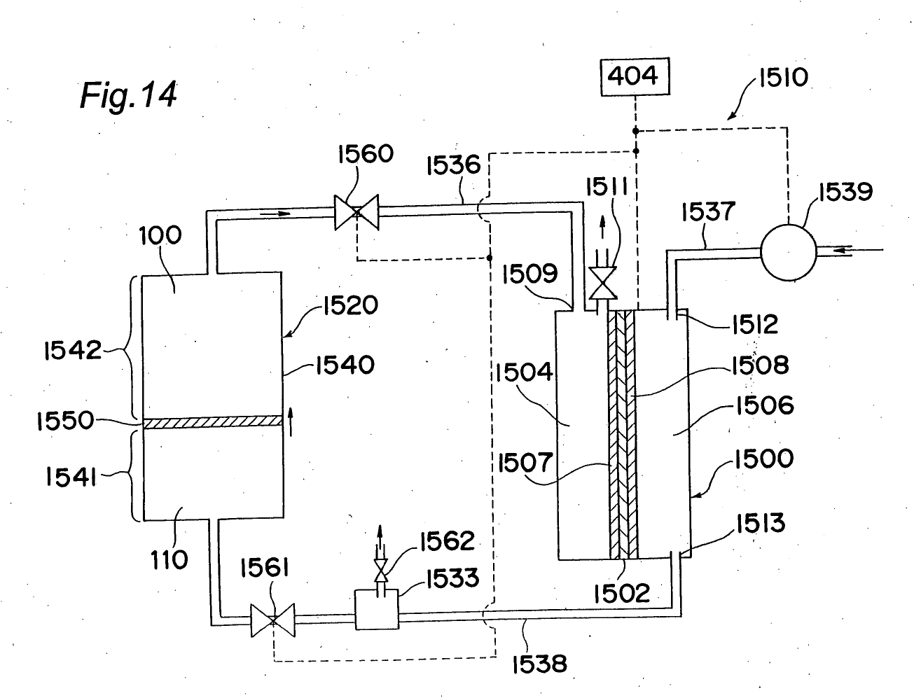

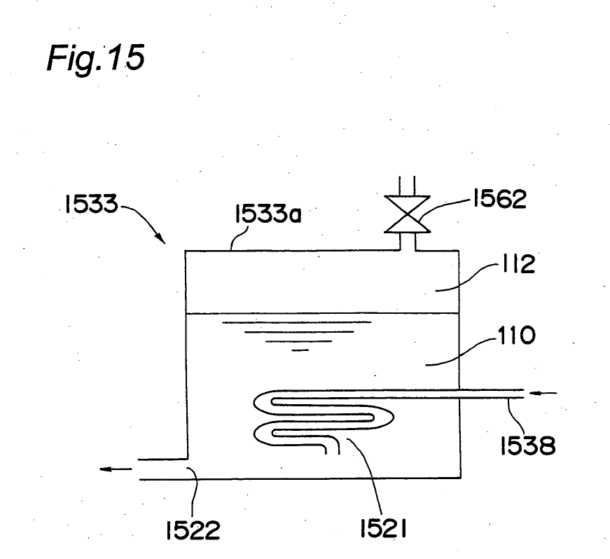

Here, the structure of the partition plate 1550 provided for the filling-collecting device 1520 for fuel cells is described with reference to schematic views shown in FIG. 16A, FIG. 16B, FIG. 17A and FIG. 17B.

As described above, the partition plate 1550 partitions the filling-collecting device 1520 for fuel cells into the fuel accommodating space 1542 for filling for accommodating liquid fuel undiluted solution, and the effluent collecting space 1541 for accommodating water. Since different kinds of fluid from each other are accommodated in the respective partitioned spaces, the partition plate 1550 is required a structure such that the fluids of both chambers are not mixed together. Therefore, as shown in FIG. 16A and FIG. 16B which is an enlarged view of a part shown in FIG. 16A, a packing 1551 is attached to the periphery of the partition plate 1550 so that no space is left between the periphery of the partition plate 1550 and the inner wall 1540b of the filling-collecting device 1520 for fuel cells. Also, in order to enhance the rigidity of the partition plate 1550 against torsion, the partition plate 1550 is formed thickly, the thickness of about 5 mm for example. Also, in order to move the partition plate 1550 stably, as shown in FIG. 17A and FIG. 17B which is a sectional view taken on line A-A′ of FIG. 17A, guide rails 1543 may be arranged inside the filling-collecting device 1520 for fuel cells for guiding the movement of the partition plate 1520. Such guide rails 1543 are preferably arranged along the vertical direction in FIG. 17A, and a plurality of guide rails 1543 are further desirable for achieving more stable movement. It is to be noted that FIG. 17A shows the case in which two guide rails 1543 are provided. Also, in order to leave no space between each guide rail 1543 and the partition plate 1550, packing (not shown) and the like are preferably arranged.

Such a fuel cell system 1510 is provided with a control unit 404 for relating each operation related to power generation in the fuel cell system 1510 to one another for comprehensive control. The control unit 404 can supply air to the cathode 1506 by the drive of the air supply pump 1539 and can control electric energy generated in the fuel cell body 1500 and the like. The control unit 404 may open/close each valve and regulate the openness thereof using the regulating valve 1560 and the valve 1561 as an automatic control valve.

In the fuel cell system 1510 which has such functions and a structure, the description is given for the supply (resupply) operation of liquid fuel when power is generated and the collection operation of produced water. It is to be noted that the following respective operations are conducted by relating one another by the control unit 404 of the fuel cell system 1510 for comprehensive control.

First, such state is set as an initial state that in the filling-collecting device 1520 for fuel cells, methanol solution of 100 ml is accommodated in the fuel accommodating space 1542 for filling whose concentration is 63.8 wt % in weight percent as liquid fuel undiluted solution and a quantity of water is accommodated in the effluent collecting space 1541. At this time, for example, the regulating valve 1560 and the valve 1561 are closed.

After that, the regulating valve 1560 and the valve 1561 are opened as well as the air supply pump 1539 is activated to supply air through the air supply line 1537 to the inside of the cathode 1506. Since air is thus supplied to the inside of the cathode 1506, pressure is also applied on the inside of the effluent collecting space 1541 through the water collection line 1538. Consequently, the partition plate 1550 is energized to move toward the side of the fuel accommodating space 1542 for filling and the volume of the fuel accommodating space 1542 for filling is decreased so that the accommodated liquid fuel undiluted solution is supplied to the inside of the anode 1504 through the fuel supply line 1536. At the time of this supply, when gas exists in the anode 1504, the gas is discharged to outside through the discharge valve 1511.

Since liquid fuel is supplied to the anode 1504, anode reaction is produced in the anode 1504 using the liquid fuel, whereas cathode reaction is produced using air, i.e. oxygen, supplied in the cathode 1506. Thus, a prescribed electric energy is generated in an power generation circuit (not shown). Since power is thus generated in the fuel cell body 1500, the liquid fuel whose amount corresponds the amount of the electric energy generated in the anode 1504 is consumed, whereas the water whose amount corresponds the amount of the electric energy generated in the cathode 1506 is produced.

The water produced in the cathode 1506, as the mixture of the water and air, is delivered from the inside of the cathode 1506 through the discharge opening 1513 to the water collection line 1538 by the pressure applied by the air supply pump 1539. After that, the effluent is introduced to the gas-liquid separating device 1533, and at the time of the introduction, water vapor and the like contained in the mixture which are condensed to be liquefied in the inlet pipe 1521 are introduced to the inside of the gas-liquid separating chamber 1533a. In the gas-liquid separating chamber 1533a, the gas 112 is accommodated on the upper side thereof and the water 110, which is effluent, is accommodated on the lower side thereof. As a result, the mixture is separated into the gas 112 and the water 110 in the gas-liquid separating chamber 1533a.

After that, the water 110 which is the effluent accommodated on the lower side of the gas-liquid separating chamber 1533a, is fed through the water discharge opening 1522 and water collection line 1538 into the effluent collecting space 1541 to be collected. Such a water feeding operation is made possible by the state in which the air supply pump 1539 applies pressure on the inside of the gas-liquid separating chamber 1533. It is to be noted that when the pressure in the gas-liquid separating chamber 1533a is equal to or higher than a prescribed pressure, the pressure regulating valve 1562 discharges gas to keep the prescribed pressure. For example, the prescribed pressure in the gas-liquid separating chamber 1533a may be an arbitrary pressure in the range 2 to 10 kPa and the pressure of about 5 kPa is preferable. Also, instead of the case in which water is fed into the effluent collecting space 1541, water and gas (air and the like) contained in the water may be fed into the effluent collecting space 1541.

Also, in the filling-collecting device 1520 for fuel cells, water is collected in the effluent collecting space 1541 so that pressure is further applied on the inside of the effluent collecting space 1541 to further energize the partition plate 1550 toward the side of the fuel accommodating space 1542 for filling. On the other hand, liquid fuel is consumed in the anode 1504 to decrease the pressure thereof, and the decreased pressure also decreases the pressure of the fuel accommodating space 1542, for filling through the fuel supply line 1536. Therefore, since the pressure of the fuel accommodating space 1542 for filling lowers than the pressure of the effluent collecting space 1541, pressure difference is generated between both chambers to move the energized partition plate 1550 toward the side of the fuel accommodating space 1542 for filling to reduce the volume of the fuel accommodating space 1542 for filling. As a result, part of the liquid fuel undiluted solution accommodated in the fuel accommodating space 1542 for filling is supplied to the anode 1504 through the fuel supply line 1536 so as to resupply the liquid fuel consumed in the anode 1504.

The liquid fuel which is thus resupplied to the anode 1504 is consumed by being employed for power generation, whereas water is produced with the power generation in the cathode 1506. Since these operations are continuously repeated, the resupply operation of the liquid fuel consumed in the anode 1504 and the collecting operation of the water produced in the cathode 1506 are conducted simultaneously and continuously, so that a prescribed electric energy is generated in the fuel cell body 1500 continuously.

Also, these liquid fuel resupply operation and water collecting operation are made possible by the air supply pump 1539, which supplies air to the inside of the cathode 1506 so as to apply pressure on the inside of the cathode 1506. In other words, the air supply pump 1539 has a function to supply air to the inside the cathode 1506 with a pressure which can resupply the liquid fuel undiluted solution accommodated in the fuel accommodating space 1541 for filling to the inside of the anode 1504 through the fuel supply line 1536 by applying pressure through the water collection line 1538 on the effluent collecting space 1541 so as to move the partition plate 1550 (for example, has such a discharge pressure).

After that, when the liquid fuel undiluted solution in the fuel accommodating space 1542 for filling is completely consumed, or when power generation is stopped, the drive of the air supply pump 1539 is stopped as well as the regulating valve 1560 and the valve 1561 are closed.

It is to be noted that it is preferable that the volume of the liquid fuel consumed by power generation is roughly the same as the volume of the water to be produced, since the liquid fuel whose amount is roughly equal to the amount of the liquid fuel consumed for power generation is supplied using the water which is produced by the power generation, as well as the water is collected in this fuel cell system 1520. That is, the liquid fuel whose concentration can satisfy such a condition, for example whose concentration may be an arbitrary concentration in the range from 60 to 70 wt %, and for example, the methanol solution whose concentration is about 63.8 wt % is preferable to be employed.

The fuel cell system of the third embodiment can achieve the following various effects.

The liquid fuel which is supplied from the filling-collecting device 1520 for fuel cells to the anode 1504 is diffused through the diffusion layer 1507 which has hydrophilic property, so that the liquid fuel can be supplied to the membrane electrode assembly 1502 which quickly forms a catalyst. Particularly, even when the end of the fuel supply line 1536 is arranged on the upper side of the anode 1504 so that the liquid fuel to be supplied through the end is supplied on the upper side of the diffusion layer 1507, the capillary phenomenon by the hydrophilic property of the diffusion layer 1507 or the action of gravity can diffuse the liquid fuel so as to supply the liquid fuel over the entire surface of the membrane electrode assembly made up of the membrane electrode assembly 1502 evenly and efficiently.

Also in the cathode 1506, the water produced by power generation can be discharged to the separator side by the diffusion layer 1508 which has hydrophobic property. The discharge of the water can be conducted efficiently to the outside of the cathode 1506 since the diffusion layer 1508 has hydrophobic property. Also, since the diffusion layer 1508 has hydrophobic property and the air supply pump 1539 applies pressure, there is also an effect that the crossover of the liquid fuel transmitted from the side of anode 1504 through the membrane electrode assembly 1502 can be decreased.

Also, water is produced as effluent in the cathode 1506 by the power generation in the fuel cell system 1510, and since the water thus produced can be collected in the effluent collecting space 1541 of the filling-collecting device 1520 for fuel cells, the water are not discharged. Consequently, the fuel cell system 1510 can be employed as the fuel cell system for portable electronic devices which are characterized in that the devices can not employ fuel cell systems associated with drainage and the like.

Also, since such water collection is conducted by delivering produced water through the water collection line 1538 to the effluent collecting space 1541 by the pressure applied in the cathode 1506 which is associated with the air supply by the air supply pump 1539 to the cathode 1506, power equipment for exclusive use in application on such water collection (for example, a pump for collecting effluent and the like) is not required. Consequently, the structure of the auxiliary device system in the fuel cell system 1520 can be simplified.

Furthermore, without arranging a water collection tank and the like for exclusive use in application on the water thus collected, the filling-collecting device 1520 for fuel cells, where the accommodated liquid fuel decreases with power generation, is partitioned by the partition plate so that the water can be collected therein. As a result, the structure of the auxiliary device system can be further simplified.

Also, although not only water but also air and the like which are mixed with the air, i.e. as a mixture, are delivered from the cathode 1504 to the inside of the water collection line 1538, since the gas-liquid separating device 1533 is arranged on the midway of the water collection line 1538, the mixture can be separated into gas and liquid so that water which is liquid can be collected in the effluent collecting space 1541. Consequently, water can be collected efficiently by using the filling-collecting device for fuel cells whose capacity is limited.

Also, the inlet pipe 1521, which is the end of the water collection line 1538, is arranged in the gas-liquid separating device 1533 so as to be immersed in the water which is accommodated in the gas-liquid separating chamber 1533a as effluent as well as so as to increase the contact area with the water, so that the water vapor contained in the mixture can be collected in a condensed and liquefied state. This also prevents water from being discharged to outside in the form of water vapor, so that the fuel cell system can be provided which is suitable for the power source for portable electronic devices.

Also, although liquid fuel is consumed in the anode 1504 with power generation, since the consumed liquid fuel can be resupplied by the pressure applied in the effluent collecting space 1541 by water collection so as to move the partition plate 1550 toward the side of the fuel accommodating space 1542 for filling, fuel supply facilities for exclusive use in application on the resupply of the liquid fuel (a fuel supply pump for filling and the like) are not required. Consequently, the structure of the auxiliary device system can be further simplified.

Since the structure of the auxiliary device system is thus simplified, the fuel cell system can be miniaturized as well as the electric energy self-consumed in the auxiliary device can be reduced. As a result, the fuel cell system suitable for the power source for portable electronic devices can be provided, which is miniaturized and can generate power efficiently.

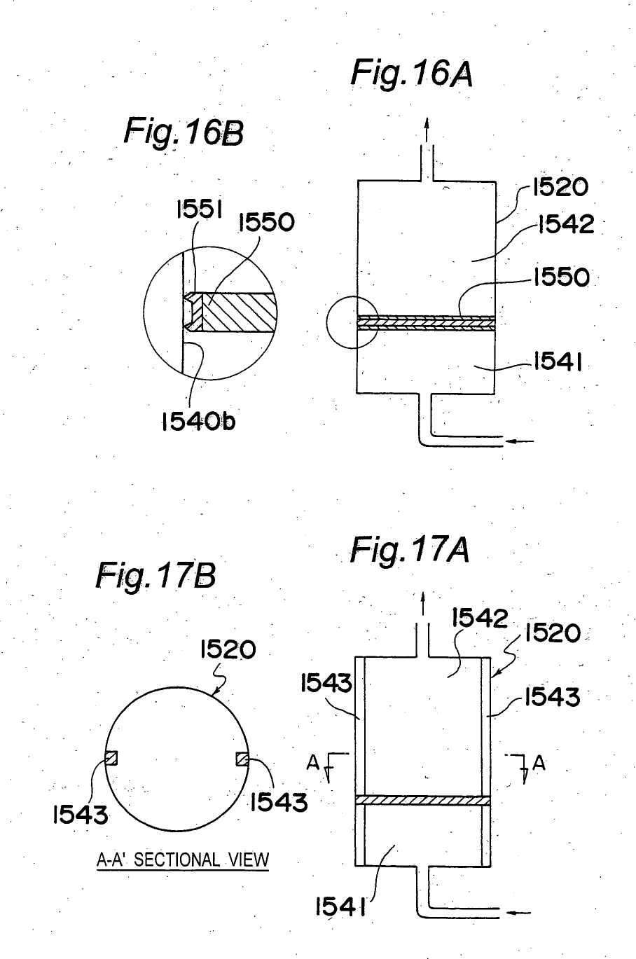

It is to be noted that the filling-collecting device 1520 for fuel cells of the third embodiment is not limited to the third embodiment and is applicable to other various embodiments. FIG. 18 shows the schematic structure of a modified example of the filling-collecting device for fuel cells employed in the fuel cell system of the third embodiment of the present invention. It is to be noted that since the whole structure of the fuel cell system is roughly the same as the structure of the fuel cell system 1510 of the third embodiment and the description thereof is omitted here.

As shown in FIG. 18, a filling-collecting device 1620 for fuel cells is provided with a fuel accommodating space 1642 for filling which is a chamber for accommodating liquid fuel undiluted solution 100, partitioned by a partition plate 1650, and an effluent collecting space 1641 for accommodating the water (or mixture of water and gas) sent from a water collection line 1638 so as to be collected. It is to be noted that the filling-collecting device 1620 for fuel cells is provided with a level sensor 1652 for detecting the intake amount (i.e., remaining amount) of the liquid fuel undiluted solution 100.

For the level sensor 1652, a magnetic sensor may be employed, for example. Since a small portion to be detected which is made up of magnetic material is embedded in the end of the side face of the partition plate 1620 (at the right end in the figure), the level sensor 1652 can detect the portion to be detected 1653 contactlessly. Consequently, the movement position of the partition plate 1650 can be detected, and the intake amount of the liquid fuel accommodated in the fuel accommodating space 1642 for filling can also be detected. It is to be noted that the intake amount of the liquid fuel thus detected can also be displayed by entering into the control unit 404 and the like so that the intake amount is recognizable from the outside of the fuel cell system.

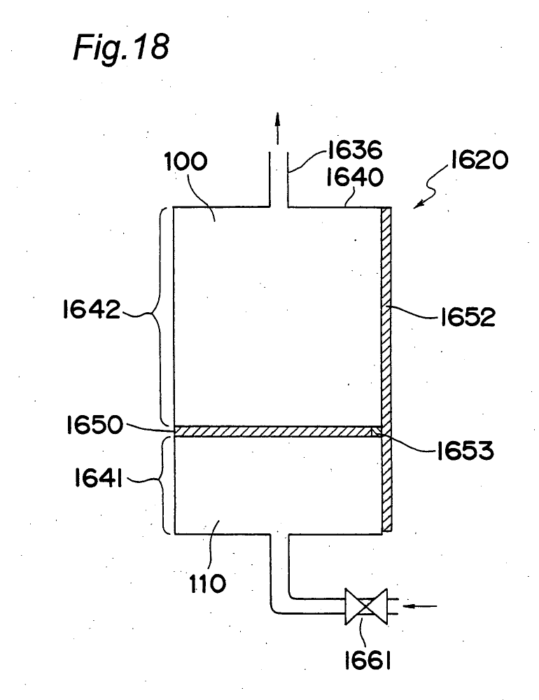

FIG. 19 is a schematic view showing the structure in appearance of the filling-collecting device for fuel cells of FIG. 18.

As shown in FIG. 19, the filling-collecting device 1620 for fuel cells is provided with a fuel checking window 1654 which is an example of a view window through which the remaining amount of the accommodated liquid fuel is visible from the outside.

As shown in FIG. 19, the fuel checking window 1654 is structured by making up the partition plate 1650 of the filling-collecting device 1620 for fuel cells in a color with excellent visibility, for example white, so that the outer case of the filling-collecting device 1620 for fuel cells is visibly provided with the partition plate 1650. Since a scale for reading fuel intake amount is arranged in the marginal portion of the fuel checking window 1654, it is possible to determine how much amount of the liquid fuel 100 exists in the fuel accommodating space 1642 for filling and whether liquid left is the liquid fuel 100 or the water 110 which is effluent. Consequently, the remaining amount of liquid fuel can be checked reliably in the filling-collecting device 1620 for fuel cells, as well as the fuel cell system which generates power efficient since no electric power is self-consumed for the check can be provided.

It is to be noted that although this example relates to the case in which the color of the partition plate 1650 is white, fluorescent colors and luminous colors can also be employed.

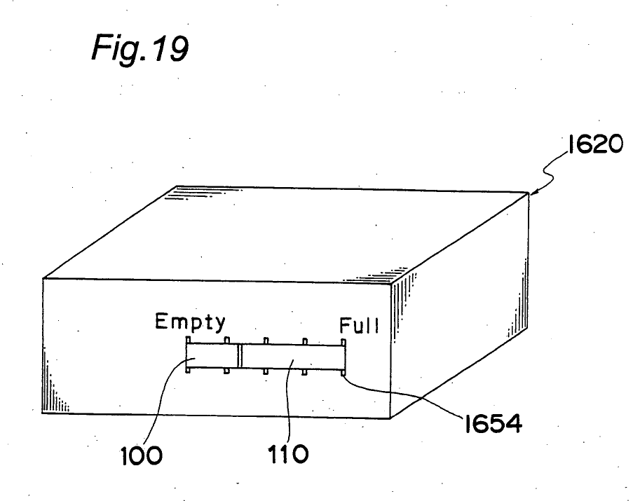

Next, FIG. 20 shows a schematic view showing an alternative modified example of the filling-collecting device 35 for fuel cells employed for the fuel cell system of the third embodiment of the present invention.

As shown in FIG. 20, the filling-collecting device 1621 for fuel cells is provided with a fuel accommodating space 1642 for filling which is a chamber partitioned by a partition plate 1657, for accommodating liquid fuel 100, and an effluent collecting space 1641 for accommodating the water or mixture of water and gas delivered through a water collection line so as to be collected. The filling-collecting device 1621 for fuel cells is also provided with a position sensor 1654 for detecting the intake amount of the liquid fuel 100.

For a position sensor 36, a magnetic sensor and an electrostatic sensor may be employed for example, and it is preferable that a position sensor 1654 is provided at a plurality of positions within the moving range of the partition plate 1657. Also, since a small portion to be detected 1655 which is made up of magnetic material is embedded in the end of the side face of the partition plate 1657, the portion to be detected 1655 of the partition plate 1567 which is located at the location of the position sensor 1654 can be detected contactlessly so as to detect the movement position of a movable partition 1657.

Also, since this detection result by the position sensor 1654 is output by a control unit and the like, the remaining amount of fuel is notified to portable electronic devices and the like for which this fuel cell system is employed as power source.

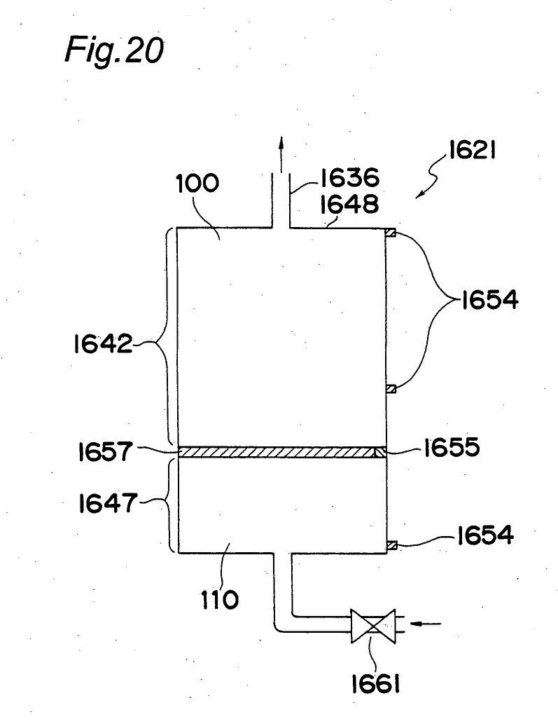

Next, FIG. 21 is a schematic view showing the schematic structure of a further alternative modified example of the filling-collecting device 35 for fuel cells employed in the fuel cell system of the third embodiment of the present invention. The whole structure of the fuel cell system is the same as the structure of the fuel cell system 1501 of the third embodiment.

As shown in FIG. 21, the filling-collecting device 1622 for fuel cells is partitioned by a partition plate 1658 into a fuel accommodating space 1642 for filling for accommodating liquid fuel 100, and an effluent collecting space 1641 for accommodating water or a mixture of water and gas so as to be collected. The filling-collecting device 1622 for fuel cells is also provided with a fuel resupply connector 1643 for filling the liquid fuel 100 in the fuel accommodating space 1642 for filling, and a connector 1644 for collecting water for collecting water 110 accommodated in the effluent collecting space 1641. The connector 1644 for collecting water and the fuel resupply connector 1643 are respectively provided with a leakage prevention mechanism. It is to be noted that when not only water but also gas are accommodated in the effluent collecting space 1641, gas as well as water can be collected through the connector 1644 for collecting water.

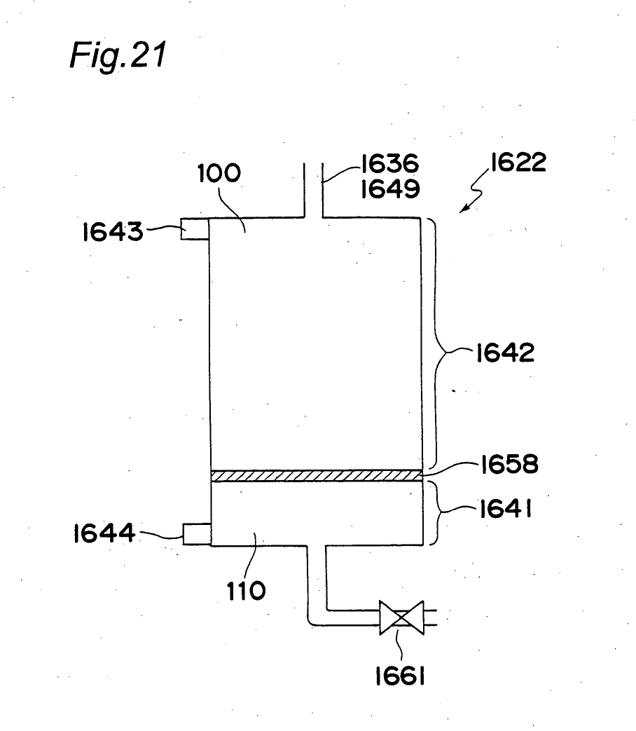

FIG. 22 is a schematic view showing a state in which a filling-collecting device 1622 for fuel cells and a reusing device 3600 are connected at the time of regeneration. The reusing device 3600 shown in FIG. 22, like the reusing device 3300 shown in FIG. 8, is provided with a reusing device casing 3610, a piston 3620 which is movable along the axial direction 3610a of the reusing device casing 3610, arranged in the reusing device casing 3610, and a plug part 3635 and a plug part 3636 which are respectively engaged with the fuel resupply connector 1643 and the connector 1644 for collecting water arranged in the filling-collecting device 1622 for fuel cells.

The piston 3620 has a partition plate 3621 for partitioning the interior of the reusing device casing 3610 into an effluent accommodation part 3611 and a filling fuel supply part 3612, a rod 3622 which is protrusively provided on the partition plate 3621, extending along the axial direction 3610a through the reusing device casing 3610 to reach outside.

The regenerating operation of the filling-collecting device 1622 for fuel cells using the reusing device 3600 which is thus structured is hereinafter described. It is to be noted that the reusing device 3600 is set to a state in which the reusing device 3600 is filled with the fuel 102 for filling, and the filling-collecting device 1622 for fuel cells is set to a state in which the filling-collecting device 1622 for fuel cells is filled with the effluent 110 to some extent or completely.

As shown in FIG. 22, the connector 1644 for collecting water of the effluent collecting space 1641 in the filling-collecting device 1622 for fuel cells and the plug part 3636 of the effluent accommodation part 3611 in the reusing device 3600 are connected, as well as the fuel resupply connector 1643 in the fuel accommodating space 1642 for filling of the filling-collecting device 1622 for fuel cells and the plug part 3635 in the filling fuel supply part 3612 of the reusing device 3600 are connected. As a result, the effluent collecting space 1641 is communicated with the effluent accommodation part 3611, as well as the fuel accommodating space 1642 for filling is communicated with the filling fuel supply part 3612. It is to be noted that FIG. 8 shows a state before regeneration operation is conducted.

Next, an operator presses the rod 3622 of the piston 3620 along the axial direction 3610a. Since the piston 3620 is pressed toward the side of the filling fuel supply part 3612, the fuel 102 for filling accommodated in the filling fuel supply part 3612 of the reusing device 3600 is supplied to the fuel accommodating space 1642 for filling of the filling-collecting device 1622 for fuel cells through the plug part 3635 and the fuel resupply connector 1643. Since the fuel 102 for filling is thus supplied to the fuel accommodating space 1642 for filling, the partition plate 1658 of the filling-collecting device 1622 for fuel cells presses the effluent 110 in the effluent collecting space 1641. Consequently, the effluent 110 is supplied to the effluent accommodation part 3611 of the reusing device 3600 through the connector 1644 for collecting water and the plug part 3636. As a result, while the filling-collecting device 1622 for fuel cells is filled with the fuel 102 for filling, the reusing device 3600 is filled with the effluent 110. That is, in the regeneration of the filling-collecting device 1622 for fuel cells, liquid fuel can be filled in and water can be collected simultaneously.

It is to be noted that the connector 1644 for collecting water and the plug part 3636, and the plug part 3635 and the fuel resupply connector 1643 are achieved by the respective connectors which are made up of the socket part and the plug part as shown in FIG. 10A and FIG. 10B, for example.

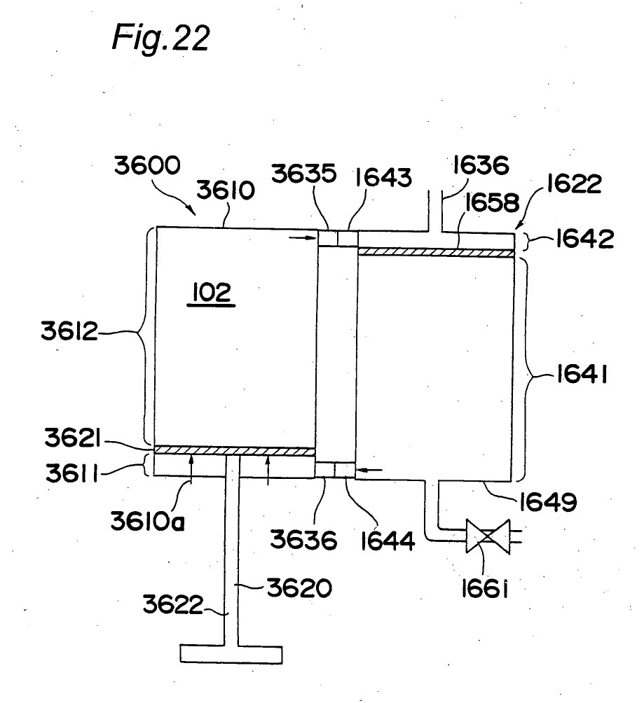

It is to be noted regarding the locations of the fuel resupply connector 1643 and the connector 1644 for collecting water in the filling-collecting device 1622 for fuel cells, as shown in the schematic views of the filling-collecting device 1642 for fuel cells of FIG. 23A and FIG. 23B, the fuel resupply connector 1643 is preferably arranged at a position higher than the upper limit position in the figure within the moving range of the partition plate 1658 (see FIG. 23A), and the connector 1644 for collecting water is preferably arranged at a position lower than the lower limit position in the figure within the moving range (see FIG. 23B), respectively. This arrangement allows the capacity of the filling-collecting device 1622 for fuel cells to be optimized so as to resupply liquid fuel and to collect water.

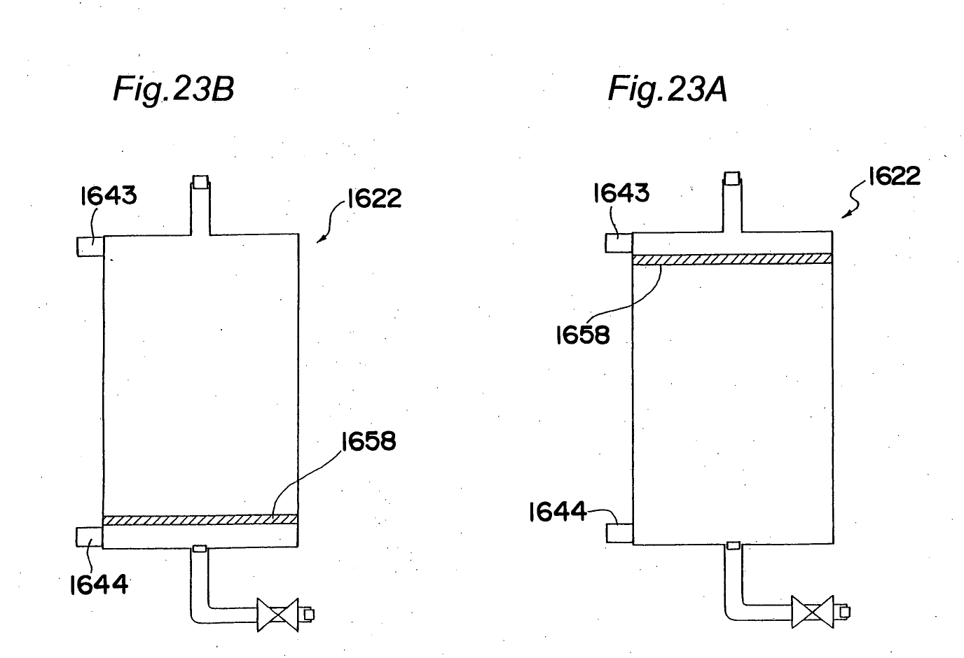

Next, FIG. 24 is a schematic view showing the schematic structure of the fuel cell system 1710 of the fourth embodiment of the present invention. As shown in FIG. 24, although the fuel cell system 1710 is provided with a fuel cell body 1700 and the like whose structures are different from those of the fuel cell system 1510 of the third embodiment, the structure of the rest of the auxiliary device system is similar to the structure of the fuel cell system 1510. Hereinafter, the description is given only for these different structures. It is to be noted that, there are arranged a fuel cell body 1700, an air supply pump 1739, a gas-liquid separating device 1733, a valve 1761, a filling-collecting device 1720 for fuel cells, an effluent collecting space 1741, a fuel accommodating space 1742 for filling and a regulating valve 1760, in the fuel cell system 1710 as shown in FIG. 24.

As shown in FIG. 24, the fuel cell system 1710 arranges, in its inner space, an anode 1704 of the fuel cell body 1700, as well as is provided with a fuel mixing tank 1732 for accommodating the liquid fuel supplied from the filling-collecting device 1720 for fuel cells so that the liquid fuel can be supplied to the anode 1704.

Also, the anode 1704 of fuel cell body 1700 is provided with a fuel supply opening 1709 which is arranged in the lower part of the figure, and a discharge opening 1714 for gases such as carbon dioxide, which is arranged in the upper part of the figure. Also, in this fuel supply opening 1709, the anode 1704 is arranged so as to be immersed in the liquid fuel accommodated in the fuel mixing tank 1732. This allows liquid fuel to be supplied to the inside of the anode 1704 through the fuel supply opening 1704. Also, the fuel mixing tank 1732 is provided with a discharge valve 1711 for discharging gases such as carbon dioxide.

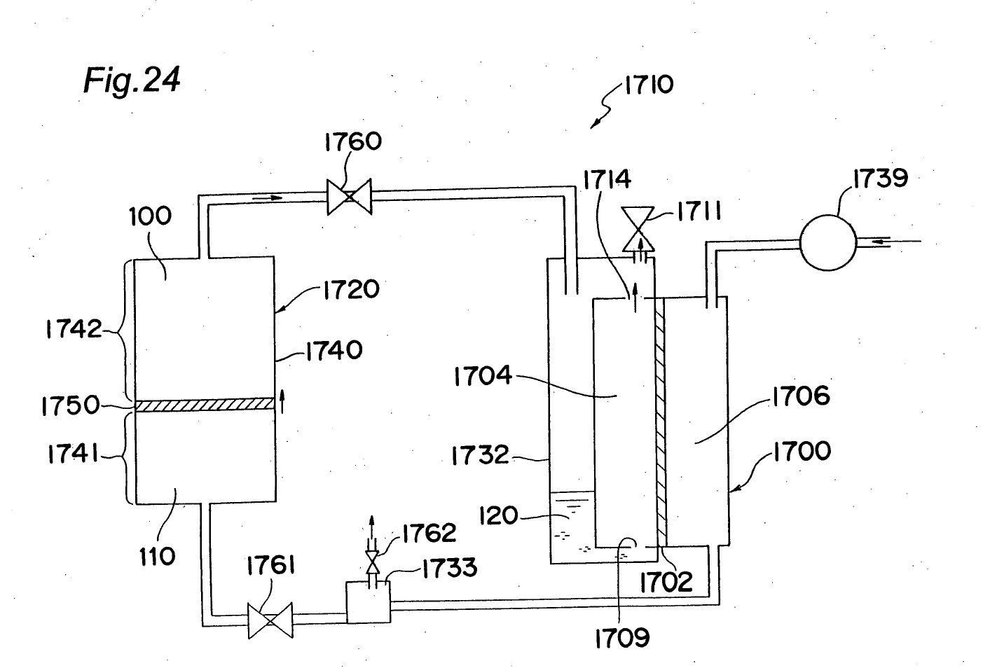

Here, FIG. 25 is a schematic view showing the structure of the fuel cell body 1700 in further detail. As shown in FIG. 25, the fuel cell body 1700 is provided with an anode side diffusion layer 1704d and a cathode side diffusion layer 1706d, a membrane electrode assembly 1702 and an anode side catalyst layer 1702a and cathode side catalyst layer 1702b which are arranged between the anode side diffusion layer 1704d and the cathode side diffusion layer 1706d, an anode side separator 1704s and a cathode side separator 1706s, and a housing 1704h and a housing 1706h. The electrolyte membrane 1702, the anode side catalyst layer 1702a and the cathode side catalyst layer 1702b are called a membrane electrode assembly. As the electrolyte membrane 1702, for example, an electrolyte membrane whose crossover of liquid fuel is made 1/10 of a conventional electrolyte membrane is employed. The membrane electrode assembly allows platinum and ruthenium or alloyed metal of platinum and ruthenium to be supported on a carbon powder carrier dispersedly as the anode catalyst 1702a on one surface of the electrolyte membrane 1702, and allows platinum fine particles to be supported on a carbon carrier dispersedly as the cathode catalyst 1702b on the other surface of the electrolyte membrane 1702.

The diffusion layer 1704d on the anode side is carbon paper to which hydrophilic treatment is applied for example, and the diffusion layer 1706d on the cathode side is carbon paper to which hydrophobic treatment is applied for example. It is to be noted that in such hydrophilic property treatment, hydrophilic property can be enhanced by activating carbon paper by water vapor. In hydrophobic property treatment, hydrophobicity can be imparted by impregnating carbon paper with fluororesin dispersions such as polytetrafluoroethylene. The fuel cell body 1700 can be formed by making the respective diffusion layers into close contact with the membrane electrode assembly, and then fixing the respective diffusion layers through the anode side separator 1704s and the cathode side separator 1706s by the housing 1704h and the housing 1706h. The respective diffusion layer 1704d and diffusion layer 1706d are also used as electrodes.

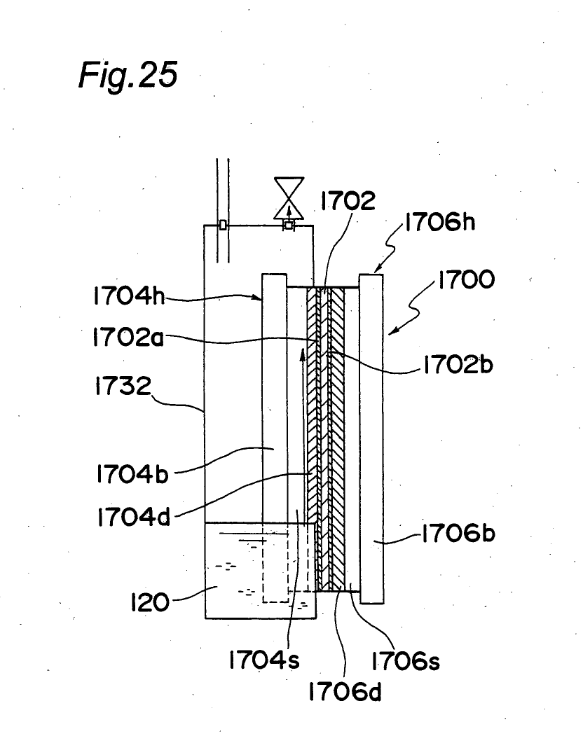

FIG. 26A shows a front view of the cathode side separator 1706s, and FIG. 26B is a sectional view taken on line B-B′ of the cathode side separator 1706s of FIG. 26A.

As shown in FIG. 26A and FIG. 26B, the cathode side separator 1706s, for example, is made up of a planar body 501 of a nonconductive resin flattened in the thickness direction, and grooves 502 are arranged on one surface thereof as examples of irregularities. The cathode side separator 302s and the membrane electrode assembly are in contact with each other so that the surface of the side on which the grooves 502 are arranged, presses against the cathode side diffusion layer 1706d to form the area surrounded by the grooves 502 and the cathode side diffusion layer 1706d as a path for air. The grooves 502, which are arranged on the surface of the cathode side separator 1706s, are arranged so as to wind through between the upper end and lower end of the planar body 501. Also, since the grooves 502 are communicated with the inlet opening 503 which is connected to the air supply opening of the cathode l706, and with the discharge opening 504 which is connected to the discharge opening of the cathode 1706, the air supplied from the air supply opening of the cathode 1706 is discharged from the inlet opening 503 through the grooves 502 via the discharge opening 504 from the discharge opening of the cathode 1706 to the outside.

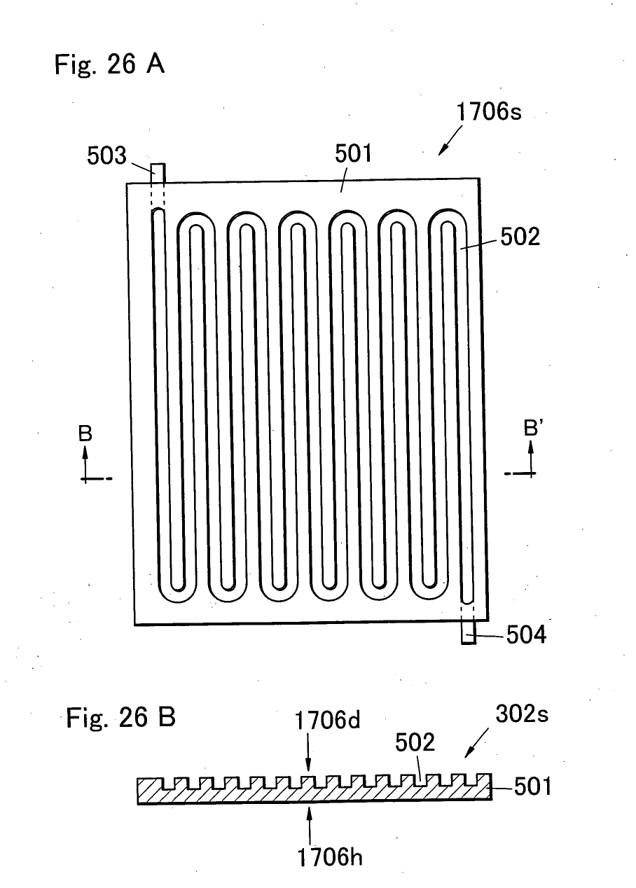

FIG. 27 is a frame format showing the structure of the anode side separator 1704s which is employed for the anode 1704.

As shown in FIG. 27, the anode side separator 1704s, whose body 510 is formed into a corrugated plate shape flattened in the thickness direction (as examples of irregularities), which is built in so that the vertex line 515 of the wave is along the direction which connects the fuel supply opening and discharge opening of the anode 1704. In this embodiment, the distance between the adjacent vertex lines 515 of the wave is about 1 to 5 mm, and the thickness of the separator 1704s, i.e. the amplitude of the wave is preferably about 1 to 5 mm. For example, the separator 1704s arranges four or more grooves on the side of the anode 1704.

Also, the anode side separator 1704s forms a path 511 and a path 512 for letting liquid fuel through in the bottom part of the wave which is surrounded by the inner wall of the housing 1704h in contact with the anode side separator 1704s, and the vertex line 515 adjacent to the surface of the diffusion layer 1704d (i.e., membrane electrode assembly). Since the cross section of the anode side separator 1704s shown in FIG. 27 is sine-wave shaped from above, the area of the path 512 on the housing side is roughly equal to the area of the path 511 on the membrane electrode assembly side.

Since the discharge opening of the fuel cell body 1700 is arranged at a position higher than the position of the fuel supply opening thereof, liquid fuel flows into the path 511 and path 512 of the anode 1704, so that the carbon dioxide produced by the anode reaction using the liquid fuel moves upwards in the direction of the discharge opening of the anode 1704, to be discharged. Together with this elevation of the carbon dioxide, the liquid fuel in the anode 1704 moves in the abovementioned direction so as to be discharged from the discharge opening of the anode 1704 to outside. When the liquid fuel in the anode 1704 moves upwards, the liquid fuel accumulated in the fuel mixing tank 1732 flows into the anode 1704 from the fuel supply opening of the anode 1704. Also, the carbon dioxide produced in the anode 1704 can be discharged efficiently.

It is to be noted that for the diffusion layer, carbon cloth may be substituted for the carbon paper. As the electrolyte membrane 1702, for example, crossover can be reduced by using Dupont's Nafion (trade name) triply. Also, as the electrolyte membrane 1702, for example, a fine-pore filling electrolyte membrane, i.e., a porous membrane having fine pores of submicron order in which electrolyte polymer is filled, and ceramic porous material in which electrolyte polymer is filled may be employed.

In the fuel cell system 1710 thus structured, the fuel which is supplied from the filling-collecting device 1720 for fuel cells to the fuel mixing tank 1732, is supplied through the fuel supply opening 1709 to the inside of the anode 1704. In the anode 1704, while the liquid fuel is sucked and diffused by the capillary phenomenon of the diffusion layer 1704d having hydrophilic property, the liquid fuel is supplied on the surface of the membrane electrode assembly 1702 so as to produce anode reaction. On the other hand, in the cathode 1706, the water produced on the surface of the membrane electrode assembly 1702 by cathode reaction, is discharged by the diffusion layer 1706d. Since the diffusion layer 1706d has hydrophobic property, water can be discharged to the outside of the cathode 1706 with an excellent drainage property. Since the diffusion layer 1706d has hydrophobic property and the air supply pump 1739 applies pressure, there is also an effect that the crossover of transmitted liquid fuel from the side of the anode 1704 through the membrane electrode assembly 1702 can be decreased.

It is to be noted that although the fourth embodiment relates to the example in which carbon paper is employed as the diffusion layer, carbon cloth and blowing metallic material may also be employed.

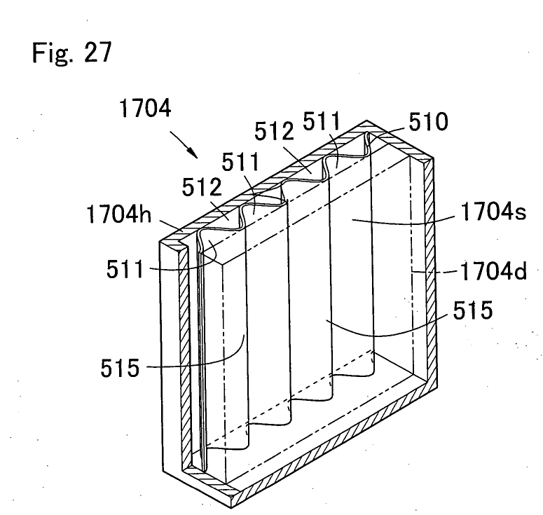

FIG. 28 is a schematic structural diagram of the fuel cell system of the fifth embodiment of the present invention. As shown in FIG. 28, the fuel cell system 1810 is provided with a fuel cell body 1800 which is a power generation section for generating power by converting chemical energy of fuel into electrical energy electrochemically, and an auxiliary device system for supplying fuel and the like to the fuel cell body 1800 and the like. This fuel cell body 1800 is the fuel cell system which employs a direct methanol fuel cell (DMFC) for generating power with methanol solution which is an example of an organic liquid fuel as a fuel, by taking out protons directly from this methanol.

As shown in FIG. 28, the fuel cell body 1800 is provided with an anode (fuel electrode) 1804, a cathode (air electrode) 1806 and a membrane electrode assembly 1802. The anode 1804 reacts supplied methanol oxidatively to produce reaction for taking out protons and electrons (anode reaction). The electron moves to the cathode 1806 through an external circuit (not shown) which electrically connects the anode 1804 and the cathode 1806, and the proton moves to the cathode 1806 through the membrane electrode assembly 1802. Also, the cathode 1806 produces reaction for deoxidizing the oxygen supplied from outside and the proton which moves from the anode 1804 through the membrane electrode assembly 1802 by the electron which passes through the external circuit so as to produce water (cathode reaction). Thus, oxidative reaction is conducted in the anode 1804 and reductive reaction is conducted in the cathode 1806 respectively so as to pass electrons through an electrode wire (not shown), so that power is generated.

Specifically, regarding the membrane electrode assembly 1802, for example Dupont's Nafion (trade name) is employed as an electrolyte membrane, and on one surface of the electrolyte membrane, platinum and ruthenium or alloyed metal of platinum and ruthenium are dispersedly allowed to be supported on a carbon powder carrier as an anode catalyst for anode 1804. The membrane electrode assembly 1802 is built up, for example, by making an electrode and diffusion layer in one made up of carbon paper (not shown) into close contact with the anode catalyst and the cathode catalyst respectively, and then fixing both ends of the membrane electrode assembly 1802 to a housing through an anode side separator and a cathode side separator.

Also, as shown in FIG. 28, the anode 1804 is provided with a fuel supply opening 1809 and a water supply opening 1830 for supplying methanol and water required for conducting the anode reaction to the inside of the anode, and a discharge opening 1831 for discharging the carbon dioxide produced in the anode reaction and the remaining methanol solution which has not been consumed in reaction from the inside.

Also, the cathode 1806 is provided with an air supply opening 1812 for using air for example, to supply oxygen used for producing the cathode reaction and for supplying the air to the inside, and a discharge opening 1813 for discharge water as an example of a product produced by the cathode reaction (both cases included of either condition of liquid phase or vapor phase, and a condition in which liquid phase or vapor phase are contained) and air which has not been used for the reaction. It is to be noted that this product contains water in major proportions, but also sometimes contains formic acid, formic acid methyl and methanol (by crossover which will be described).

Next, the structure of the auxiliary device system of the fuel cell system 1810 is described. As the structure of the auxiliary device system, an auxiliary device structure for supplying methanol solution to the anode 1804 of the fuel cell body 1800, an auxiliary device structure for supplying air to the cathode 1806, and an auxiliary device structure for collecting the effluents produced in the cathode 1806 are provided.

As shown in FIG. 28, as the auxiliary device structure for the fuel supply, there are arranged a fuel filling-collecting device 1820 for fuel cells for accommodating methanol solution as liquid fuel undiluted solution so that the liquid fuel undiluted solution can be supplied to the anode 1804, a fuel supply line 1871 for connecting the fuel filling-collecting device 1820 for fuel cells to the anode 1804, and the regulating valve 1860 for fuel which is arranged on the midway of the fuel supply line 1871. In the anode 1804 of the fuel cell body, a concentration detector 1832 is arranged for detecting the concentration of the fuel in the anode.

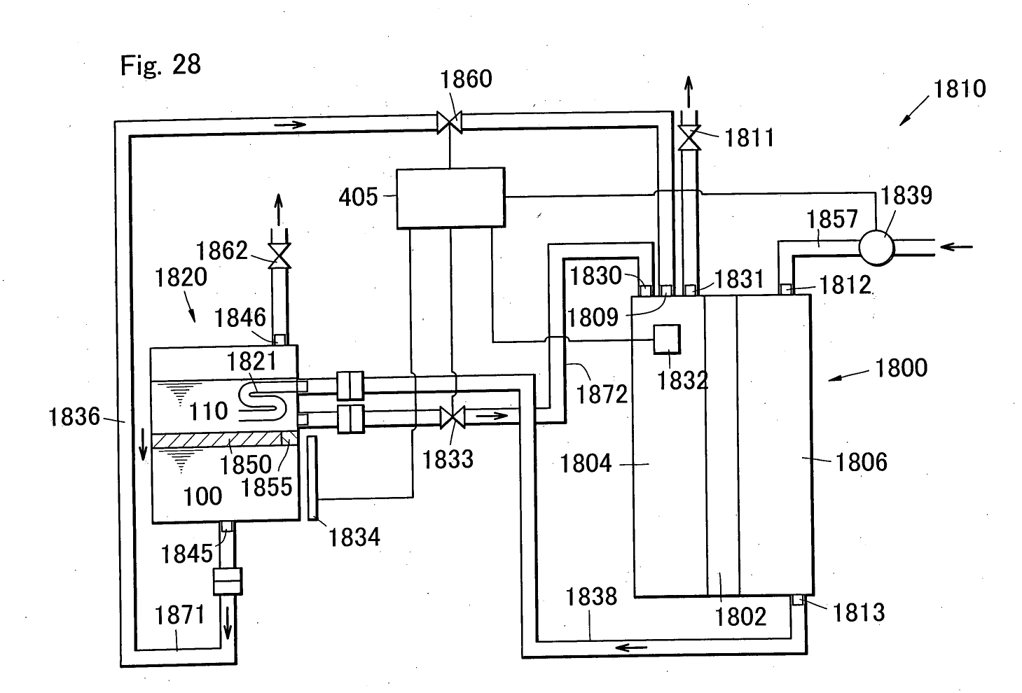

First, the description is given for a filling-collecting device for fuel cells. FIG. 29 is a frame format showing the structure of the filling-collecting device for fuel cells employed for the fuel cell system of FIG. 28. The filling-collecting device 1820 for fuel cells, as shown in FIG. 29, is provided with a container body 1840, a fuel accommodating space 1842 for filling, an effluent collecting space 1841, a partition plate 1850, an effluent inlet opening 1843, a radiating pipe 1821, a water feeding opening 1844, a fuel feeding opening 1845, a gas discharge opening 1846, and a pressure regulating valve 1862.

In the filling-collecting device 1820 for fuel cells, the inside of the container body 1840 is partitioned by the partition plate 1850 so that the effluent collecting space 1841 is formed on the upper side and that the fuel accommodating space 1842 for filling is formed on the lower side. In FIG. 29, the partition plate 1850 is arranged so as to move in parallel up and down, so that the volumes of the effluent collecting space 1841 and fuel accommodating space 1842 for filling are varied by changing the position of the partition plate 1850.

Undiluted solution of liquid fuel is accumulated in the fuel accommodating space 1842 for filling. As undiluted solution of liquid fuel, although methanol and dimethyl ether, and their solutions and the like may can be employed, the methanol whose concentration is 63.8 wt % is employed in this embodiment.

In the effluent collecting space 1841, water is accumulated in the initial application. A smaller occupancy of the effluent collecting space 1841 in the filling-collecting device 1820 for fuel cells, specifically equal to or lower than 20% is preferable. When the occupancy is higher than 20%, the initial fuel occupancy in the filling-collecting device 1820 for fuel cells decreases, and consequently, the amount of fuel to be stored is reduced, The partition plate 1850 is a component for separating the fuel accommodating space 1842 for filling from the effluent collecting space 1841, and a material which has low water or liquid fuel permeability is used therefor. As the material, for example, polymeric resins such as polyethylene terephthalate, polycarbonate, Teflon (trademark) and the like, glass and metals such as aluminum and stainless may be employed. Although the partition plate whose the thickness is thinner is preferable for improving initial fuel occupancy in the filling-collecting device for fuel cells, the partition plate which is too thin potentially leads to lack of strength when pressure is applied, corresponding to the pressure high enough to discharge the fuel in the fuel accommodating space 1842 for filling. Therefore, the structure including a material and form employed for the partition plate is varied by the design of the fuel cell system which employs the filling-collecting device for fuel cells and the like.

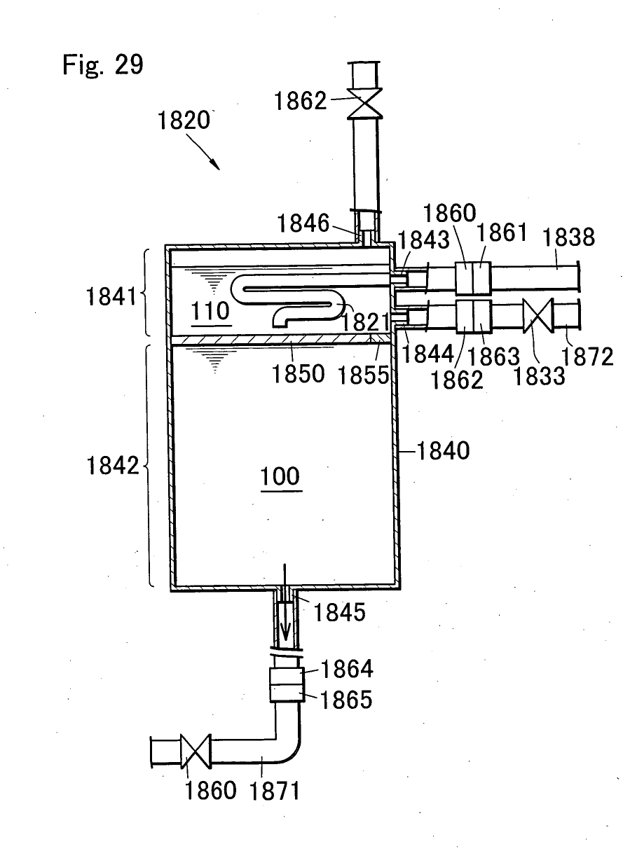

The partition plate 1850, as shown in FIG. 30, is provided with rubber packing 1851 on the periphery of the partition plate body 1850a so as to improve the closeness between the partition plate 1850 and the container body 1840. Also, as shown in FIG. 28 and FIG. 29, a magnet 1855 is arranged in part of the periphery of the partition plate body 1850a. The magnet 1855, as will be described in detail later, is used for detecting the position of the partition plate 1850, being utilized in a process for calculating the remaining amount of the liquid fuel accumulated in the fuel accommodating space 1842 for filling.

When the thickness of the partition plate 1850 is thin, the partition plate 1850 becomes potentially difficult to move in parallel as a whole for example, consequently the thickness of the partition plate 1850 T is preferably formed thick to some extent.

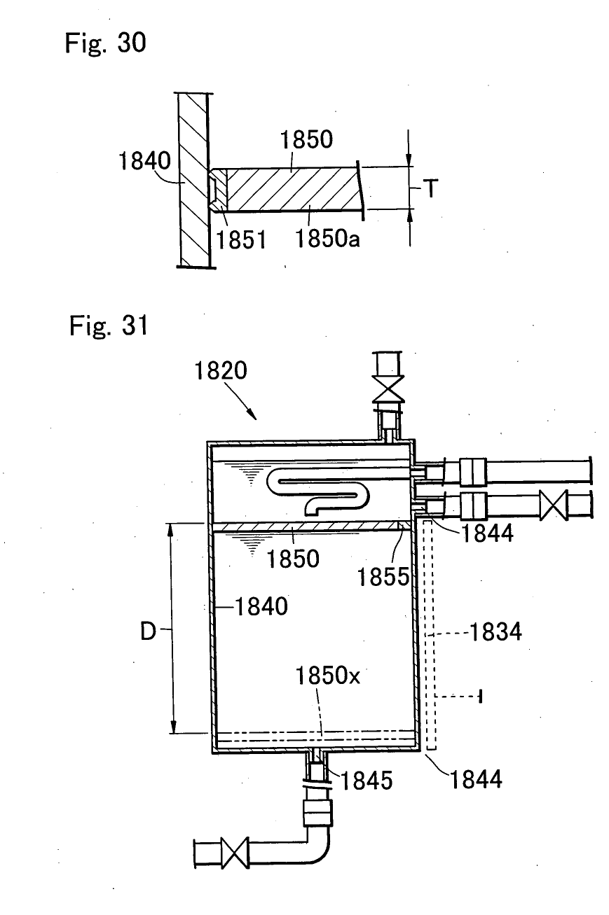

Also, as shown in FIG. 31, the partition plate 1850 moves in parallel in the container body 1840 along the distance D of an upper limit position to a lower limit position. When the partition plate 1850 is located at an upper limit position, which means a condition in which the largest amount of fuel is accumulated in the fuel accommodating space 1842 for filling, the upper limit position is just below the water feeding opening 1844 and lower than the lower end of the radiating pipe 1821. Also, when the partition plate 1850 is located at the lower end position shown as 1850x in FIG. 31, which means a condition in which fuel is to be supplied, the position may be at the lowest end of the container, but some allowance is preferably added.

A material for the container body 1840 is not limited to a specific material provided that the material has enough strength against the pressure applied on the effluent collecting space 1841 without being damaged and leaking water and liquid fuel. For example, polymeric resins such as polyethylene terephthalate, polycarbonate, Teflon (trademark) and the like, glass and metals such as aluminum and stainless may be employed. It is to be noted that the material requires to be nonmagnetic material so that the magnetic field of the magnet 1855 attached to the partition plate 1850 can reach the outside of the container. Based on these conditions, polymeric resins are particularly suitable in terms of their lightweight property and strength.

The effluent inlet opening 1843 is removably connected to the cathode 1806 of the fuel cell body 1800 through the connector 1860 and the connector 1861 by the effluent supply pipe 1874 so that the effluent which contains the water and air discharged from the cathode 1806 is fed to the effluent collecting space 1841. The effluent from the cathode 1806, whose temperature is about 60 to 80° C., contains water, water vapor and air and the like. The effluent inlet opening 1843 is connected to the radiating pipe 1821, and the effluent from the cathode solidifies to be separated into water and air while the effluent passes through the radiating pipe 1821. It is to be noted that when water is accumulated in the effluent collecting space 1841, the water functions as a cooling medium of the radiating pipe 1821, which separates water from air in a shorter time.

The pressure regulating valve 1862, which is arranged to connect to the gas discharge opening 1846 of the container body 1840, when the pressure of the effluent collecting space 1841 is equal to or higher than a prescribed pressure, automatically reduces the pressure. For the pressure regulating valve 1862, polymeric resins such as polyethylene and polypropylene, and metals such as aluminum and stainless can be employed. A gas-liquid separating film (not shown) is arranged in the gas discharge opening 1846 so as to prevent water and the like from leaking out from the pressure regulating valve. Examples of the material for the gas-liquid separating film contain fluorine-based FEP resins, whose thickness is usually about 10 to 1000μ.

The water feeding opening 1844 is removably connected to a pipe 1872 which is connected on the side of the anode 1804 of the fuel cell body 1800 through the connector 1862 and the connector 1863, and supplies the water accumulated in the effluent collecting space 1841 to the side of the anode 1804. In order to control the amount of the water which is supplied to the fuel cell body 1800 through the water feeding opening 1844, a water valve 1833 is arranged in the pipe 1872 which connects the effluent collecting space 1841 to the anode 1804, as will be described later in detail.

The fuel feeding opening 1845, which is arranged adjacent to the bottom of the filling-collecting device 1820 for fuel cells, is removably connected to one end of the fuel supply pipe 1871 through a connector 1864 and a connector 1865. This allows the liquid fuel undiluted solution accommodated in the fuel accommodating space 1842 for filling to be fed through the fuel supply pipe 1871. The thrust for feeding liquid fuel undiluted solution at this time, as will be described later in detail, is the biasing force of the partition plate 1850 toward the fuel accommodating space 1842 for filling, caused by the increased pressure in the effluent collecting space 1841.

Next, as the auxiliary device structure of air supply, there are provided an air supply pipe 1857 whose one end is connected to the air supply opening 1812 of the cathode 1806, and an air supply pump 1839 which is arranged on the midway of the air supply pipe 1857, for supplying air through the air supply pipe 1857 to the inside of the cathode 1806. As this air supply pump 1839, a pump which is small-sized and requires little power is preferably employed, and for example, a motor-type pump (with a check valve, discharge rate: 0-2 L/min., discharge pressure: 30 kPa) is employed which supplies air at the rate of 1 L/min. when used, for example. Also, when power is generated in the fuel cell body 1800, the air supply pump 1839 is driven to supply oxygen of necessity to the inside of the cathode 1806, and when the power generation is stopped, the drive of the air supply pump 1839 is also stopped. It is to be noted that when power generation is stopped, fuel supply is also stopped by closing the regulating valve 1860 for fuel.

As the auxiliary device structure for collecting the water, there are arranged an effluent feed line 1838 which connects the discharge opening 1813 of the cathode 1806 with the effluent inlet opening 1843 of the filling-collecting device 1820 for fuel cells so as to supply the effluent which contains the water and air produced in the cathode 1806 to the filling-collecting device 1820 for fuel cells to be collected, a water feed line 1872 which connects the water feeding opening 1843 of the effluent collecting space 1841 of the filling-collecting device 1820 for fuel cells with the cathode 1806 of the fuel cell body 1800 so as to supply the water accommodated in the effluent collecting space 1841 of the filling-collecting device 1820 for fuel cells, to the fuel cell body 1800, and a water valve 1833 for regulating the amount of the water which passes through the water feed line 1872.

The thrust for effluent circulation in the effluent feed line 1838, which is the pressure applied by the drive of the air supply pump 1839 in the cathode 1806, is generated by the effluents produced in the cathode 1806 to be delivered to the inside of the effluent feed line 1838 through the discharge opening 1813.

On the other hand, the thrust for water circulation in the water feed line 1872, as will be described later in detail, is the pressured applied in the effluent collecting space 1841 of the filling-collecting device 1820 for fuel cells.

The fuel cell system 1810 of FIG. 28 is provided with a control unit 405 for controlling the operations of the respective devices and components. The control unit 405 controls comprehensively as well as relates the respective operations regarding the fuel cell system 1810 such as the air supply operation by the air supply pump 1839 and the openness regulating operation by the water valve 1833 and the regulating valve 1860 for fuel, to one another so that the material balance which will be described later is established, based on the output from the concentration detector 1832 arranged in the anode 1804 of the fuel cell body 1800.

The control unit 405, when power is generated in the fuel cell body 1800, drives the air supply pump 1839 to supply air to the side of the cathode 1806, as well as opens the regulating valve 1860 for fuel and the water valve 1833 (as required) to supply liquid fuel and water to the side of the anode 1804. When the power generation is stopped, the control unit 405 stops the drive of the air supply pump 1839 and closes the water valve 1833 and the regulating valve 1860 for fuel.

There is arranged a hole generator 1834 adjacent to the filling-collecting device 1820 for fuel cells, for detecting the magnetic field which is emitted from the magnet 1855 arranged on the partition plate 1850 of the fuel cell contactlessly, so as to detect the position of the magnet 1855 to send the information thereof to the control unit 405. The control unit 405 calculates the remaining amount of the fuel in the filling-collecting device 1820 for fuel cells based on the position of the partition plate 1850.

Next, a description is given for the operation of each component when power is generated in the fuel cell system 1810 of FIG. 28.

First, in the fuel cell system 1820 of FIG. 28, the air supply pump 1839 is driven by the direction of the control unit 405 to supply air, i.e., oxygen to the cathode 1806 through the air supply pipe 1857 and the air supply opening 1812. The air which has passed through the cathode is fed to the filling-collecting device for fuel cells to apply pressure thereon. Since reaction has not been produced in the cathode in the initial application, only air is introduced in the filling-collecting device for fuel cells. At this time, for example, the methanol solution (liquid fuel) whose concentration is 63.8 wt %, is supplied to the anode 1804 of the fuel cell body 1800 by applying higher pressure by the pressure regulating valve 1862 than during operation time.

After that, anode reaction proceeds in the anode 1804, whereas cathode reaction proceeds in the cathode 1806, by supplying fuel to the anode. The carbon dioxide which is produced in the anode 1804 by the proceeding of the anode reaction, is discharged to the outside of the fuel cell body 1800 through the discharge opening 1831. When a hydrogen ion produced by the anode reaction, transmits to the cathode to start cathode reaction, electric energy is generated between the anode 1804 and the cathode 1806, i.e., an power generation circuit.

The effluent which contains water and air produced by cathode reaction in the cathode 1806, since the effluent contains water and air, and the air supply pump 1839 applies pressure on the inside of the cathode 1806, is delivered to the effluent feed line 1838 through the discharge opening 1813. The delivered effluent is supplied to the filling-collecting device 1820 for fuel cells through the effluent feed line 1838.

Since power is thus generated, the methanol and water in the anode 1804 are consumed. As a result, the methanol whose amount is corresponding to the decreased amount of the methanol solution in the anode 1804 is supplied from the fuel accommodating space 1842 for filling of the filling-collecting device 1820 for fuel cells. Also, water is supplied from the effluent collecting space 1841 of the filling-collecting device for fuel cells as required. The amounts of methanol and water to be supplied are determined by controlling the openness positions of the regulating valve 1860 for fuel and the water valve 1833 by the control unit 405.

Since these operations are conducted continuously and repeatedly, a required electric energy (a prescribed electric energy) is continuously generated in the fuel cell body 1800. On the other hand, when power generation is stopped in the fuel cell system 1810, the air supply pump 1839 is stopped as well as the fuel valve 1860 and the water valve 1833 are closed.

Next, a description is given for the specific example of the material balance of the fuel cell system 1810 of FIG. 28. The example shows the material balance in a condition in which things are ideally conducted, but error factors actually exist including the crossover in the fuel cell body 1800, the leakage of water produced on the side of the cathode 1806 and the unreacted fuel supplied to the side of the anode 1804. In this example, since the methanol solution whose concentration is 63.8 wt %, accumulated in the fuel accommodating space 1842 for filling of the filling-collecting device 1820 for fuel cells is composed of methanol and water which are mixed together at the same rate as the methanol and water which are consumed at the time of power generation, the methanol solution is reacted in the anode in just proportion.

It is to be noted that although the membrane electrode assembly 1802 of the fuel cell body 1800 is basically formed so as not to allow methanol and water to pass therethrough, methanol and water pass through the membrane electrode assembly 1802, so-called crossover generates. This crossover tends to increase in amount as the concentration of methanol solution becomes higher.

The reduction of crossover can be achieved, for example, by using a plurality of (for example, three) films which make up of the membrane electrode assembly 1802 in piles.

In the following description for material balance, in order to make the description simplified for clear understanding, the description is given on the assumption that no crossover generates in a membrane electrode assembly.

At the start of power generation, 11.7 ml of fuel is supplied to the anode 1804 by the air pressure of the air supply pump 1839 on the cathode side. At this time, the fuel undiluted solution amount decreases to 88.3 ml. In the anode 1804, 6.4 g (8.1 ml) of methanol in liquid fuel and 3.6 g (3.6 ml) of water are consumed, whereas 10.8 g (10.8 ml) of water is produced in the cathode 1806. When fuel is supplied to the anode 1804, reactions proceed in the anode 1804 and the cathode 1806 respectively so that power generation is started.

Next, 10.8 g (10.8 ml) of water produced in the cathode 1806 is introduced to the effluent collecting space 1841 of the filling-collecting device 1820 for fuel cells. At this time, the capacity of the effluent collecting space 1841 is increased by increased water to apply pressure on the partition plate 1850 toward the side of the fuel accommodating space 1842 for filling, so that 10.8 g (10.8 ml) of liquid fuel is supplied by the increased volume of water to the anode.

In order to supply the liquid fuel whose amount is the same as the amount supplied in the first round, the valve openness is regulated by the control unit 405, as well as the pressure regulating valve 1862 applies higher pressure than normal to move the partition plate 1850 so that 0.9 ml of fuel is supplied to make up the shortfall thereof. At this time, the amount of the liquid fuel undiluted solution accommodated in the fuel accommodating space 1842 for filling of the filling-collecting device 1820 for fuel cells decreases to 76.6 ml after the power generation by the liquid fuel supply. Also, 10.8 ml of water produced in the cathode 1806 is accommodated in the effluent collecting space 1841. Therefore, at this point, 87.4 ml of liquid in total of 76.6 ml of liquid fuel and 10.8 ml of water is accommodated in the filling-collecting device 1820 for fuel cells.

Since power generation, resupply of liquid fuel and collection of produced water are repeatedly conducted, the amount of the liquid fuel undiluted solution 100 which is accommodated in the fuel accommodating space 1842 for filling of the filling-collecting device 1820 for fuel cells gradually decreases, whereas the amount of the water 110 which is stored in the effluent collecting space 1841 increases. With the decreased liquid fuel undiluted solution 100 and the increased water 110 which is accommodated in the effluent collecting space 1841 in amount, the partition plate 1850 of the filling-collecting device 1820 for fuel cells moves toward the side of the fuel accommodating space 1842 for filling to apply pressure on the fuel accommodating space 1842 for filling. Also, since the air which is blown out from the cathode 1806 actually flows in the effluent collecting space 1841 of the filling-collecting device 1820 for fuel cells together with water, the pressure of the effluent collecting space 1841 of the filling-collecting device 1820 for fuel cells is increased by air pressure, thus acting as the biasing force for pressing the partition plate 1850. It is to be noted that when the pressure of the effluent collecting space 1841 becomes too high, the pressure regulating valve 1862 arranged on the exterior wall of the effluent collecting space 1841 is opened so as to be regulated to a prescribed pressure automatically.

Together with the consumption of the liquid fuel undiluted solution 100, the partition plate 1850 moves toward the side of the fuel accommodating space 1842 for filling. As described above, the magnet 1855 is arranged on the partition plate 1850, the magnetic field emitted from the magnet, transmits the fuel cell container body 1840, and is detected by the hole generator 1834 which is arranged adjacent to the filling-collecting device 1820 for fuel cells. The hole generator 1834, which is arranged contactlessly with the magnet 1855, detects the position of the magnetic field from the magnet 1855, measures the position of the partition plate 1850, and sends the information thereof to the control unit 405.

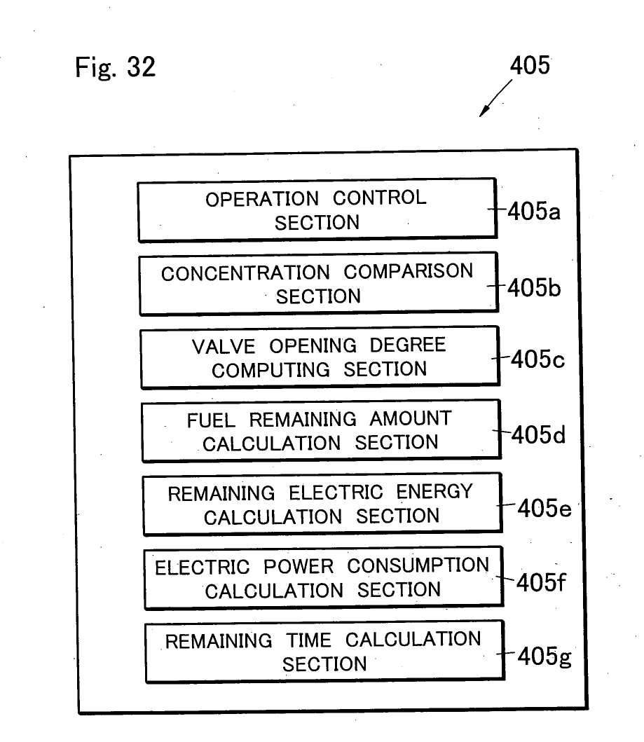

Next, the control unit 405 is described. FIG. 32 is a block diagram showing the structure of the control unit 405. As described above, the control unit 405 controls each operation of the fuel cell. Specifically, the control unit 405 operates and controls the fuel cell system, regulates and controls the concentration of fuel supplied to the anode side of the fuel cell body 1800, and detects the amount of the fuel left in the filling-collecting device for fuel cells. The control unit 405 has functional blocks such as an operation control section 405a, a concentration comparison section 405b, a valve openness computing section 405c, a fuel remaining amount calculation section 405d, a remaining electric energy calculation section 405e, an electric power consumption calculation section 405f, a remaining time calculation section 405 g, respectively.

The operation control section 405a is in charge of operation and control of the whole fuel cell system, including the activation and stopping of an auxiliary device. Various kinds of information required for operation and control is accumulated in the operation control section so that the abovementioned material balance may be established.

The concentration comparison section 405b and the valve openness computing section 405c regulates and controls the concentration of the fuel supplied to the anode side of the fuel cell body 2. The concentration comparison section 405c compares the concentration information of the fuel in the anode output from the concentration detector 1832, with a preset value stored in advance, so as to detect whether the concentration of the fuel in the anode is within an appropriate range. When the concentration of the fuel in the anode is not within an appropriate range in the result, in order to put the concentration within an appropriate range, the valve openness computing section 405c computes the openness of the water valve 1833 and regulating valve 1860 for fuel which determine the amounts of the fuel and water supplied to the anode, and the operation control section operates the water valve 1833 and the regulating valve 1860 for fuel to regulate the amount to be supplied.

The fuel remaining amount calculation section 405d, the remaining electric energy calculation section 405e, the electric power consumption calculation section 405f and the remaining time calculation section 405 g detect the amount of the fuel which is left in the filling-collecting device for fuel cells. The fuel remaining amount calculation section 405d computes the amount of the remaining fuel which is accommodated in the filling-collecting device for fuel cells, based on the information on the position of the partition plate 1850 detected by the hole generator 1834.

The electric power consumption calculation section 405e calculates the remaining amount of electric power which can be generated by the liquid fuel accommodated in the filling-collecting device for fuel cells, based on the fuel remaining amount computed by the fuel remaining amount calculation section 405d and on the concentration of the fuel accommodated in the filling-collecting device for fuel cells.

Also, the electric power consumption calculation section 405f calculates the anticipated amount of the generated output per one hour, based on the electric power which the fuel cell system currently generates. The remaining time calculation section 405 g calculates the anticipated time left to generate power by the liquid fuel accommodated in the filling-collecting device for fuel cells, based on the remaining amount of electric power which can be generated calculated by the electric power consumption calculation section 405e and on the anticipated amount of the generated output per one hour calculated by the electric power consumption calculation section 405f. The remaining amount of the fuel accommodated in the filling-collecting device for fuel cells and the information on the anticipated time to generate power are output to an electronic device on which the fuel cell system of the outside of the control unit is mounted, so that the remaining amount and the information can be utilized for an indicator of electronic devices, displaying the remaining amount of fuel. It is to be noted that, as a modified example of calculating method of the anticipated amount of the generated output per one hour calculated by the electric power consumption calculation section 405f, the anticipated amount of the generated output per one hour may be calculated by storing the change of power generated by the fuel cell with time in advance, based on the change with time.

It is to be noted that although the description of material balance relates to the case for clear understanding, in which the methanol as liquid fuel supplied to the anode 1804 is completely consumed, methanol being then resupplied from the filling-collecting device 1820 for fuel cells in an initial condition, methanol is continuously resupplied in an actual operation. In this embodiment, power generation can be repeatedly continued until the liquid fuel undiluted solution 100 accumulated in the filling-collecting device 1820 for fuel cells is completely consumed, the total volume of the filling-collecting device 1820 for fuel cells never increases even when all the water produced in power generation is collected, and fuel can be filled in as much as the capacity of the filling-collecting device 1820 for fuel cells without preparing another tank for collecting water.

Also, since the water and air which are accumulated in the effluent collecting space 1841 of the filling-collecting device 1820 for fuel cells energize the partition plate 1850 to move toward the side of the fuel accommodating space 1842 for filling, a pump and the like are not required as a power source for feeding the liquid fuel 100 from the filling-collecting device 1820 for fuel cells, so that the self-consumed electric power of the fuel cell system 1810 can be reduced. Also, since the remaining amount of the fuel in the filling-collecting device 1820 for fuel cells can be calculated by the position of the partition plate 1850, the information can be used for indicating the timing for replacement of the filling-collecting device 1820 for fuel cells.

It is to be noted that although the fifth embodiment relates to the example in which a plurality of electrolyte membranes are used in piles so as to decrease crossover, a fine-pore filling electrolyte membrane, i.e., a porous film having fine pores of submicron order in which electrolyte polymer is filled, and ceramic porous material in which electrolyte polymer is filled may be employed.

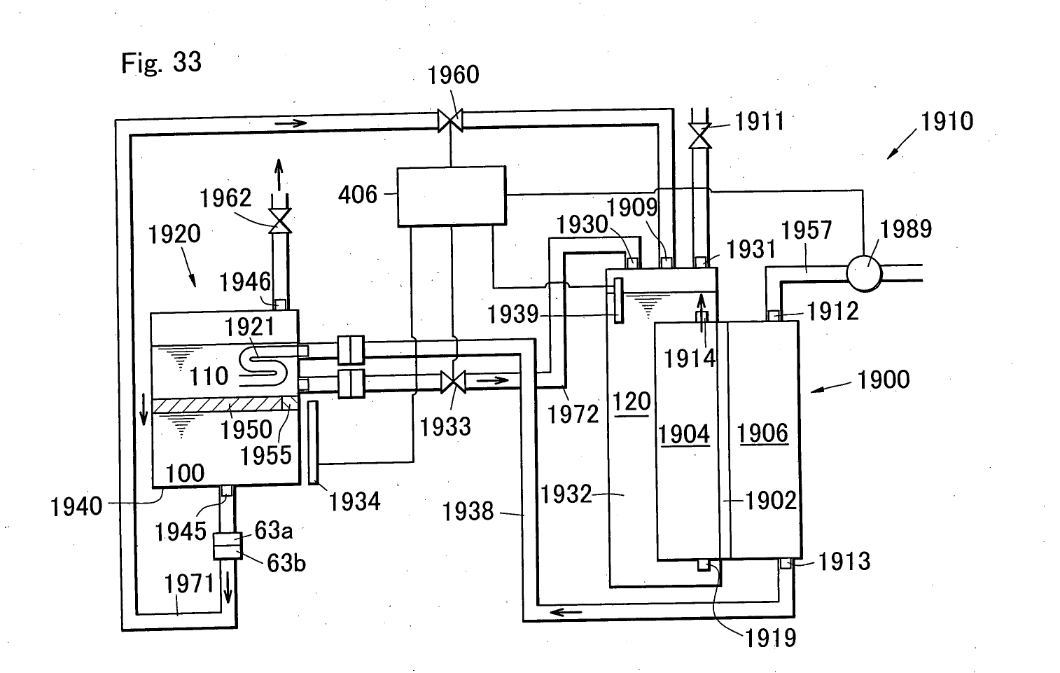

Description is now given of a fuel cell system according to the sixth embodiment of the present invention. FIG. 33 is a schematic structural view showing the fuel cell system in the second embodiment of the present invention. A fuel cell system 1910 in the present embodiment is almost identical in structure to the fuel cell system 1810 in the fifth embodiment, and therefore description herein will be focused on difference therebetween.

The fuel cell system 1910 of this embodiment is the fuel cell system which uses a direct methanol fuel cell (DMFC) for generating power by taking out protons directly from methanol, and the structure of the fuel cell body 1900 is almost the same as the structure of the fuel cell system 1810 of the first embodiment except that the side of the anode 1904 of the fuel cell body 1900 is arranged so as to be immersed in the fuel mixing tank 1932 which is an auxiliary device for fuel supply as shown in FIG. 33.

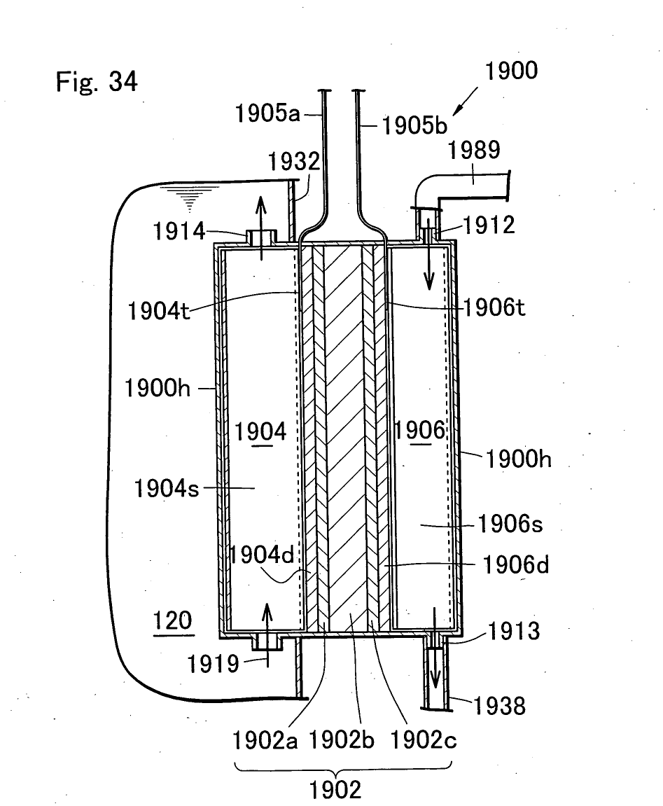

FIG. 34 shows the schematic structure of the fuel cell body which is employed for the fuel cell system of FIG. 33. As shown in FIG. 33 and FIG. 34, the fuel cell system 1910 is composed of a fuel cell body 1900 that is a power generation portion for generating electric power by electrochemically converting chemical energy of fuel to electric energy, and an auxiliary equipment system for operation such as feeding fuel or the like necessary for the power generation to the fuel cell body 1900. Moreover, the fuel cell system 1910 is a Direct Methanol Fuel Cell (DMFC) for generating electric power with use of a methanol solution exemplifying organic liquid fuel as fuel by directly extracting protons from the methanol.

As shown in FIG. 33 and FIG. 34, the fuel cell body 1900 is provided with an anode (fuel electrode) 1904, a cathode (air electrode) 1906 and a membrane electrode assembly 1902. The membrane electrode assembly 1902 is formed by bonding a catalyst layer 1902a and a catalyst layer 1902c onto both sides of the electrolyte membrane 1902b. The anode 1904 produces reaction to take out protons and electrons by deoxidizing supplied methanol (anode reaction).

The anode 1904 is provided with a fuel supply opening 1919 for supplying methanol solution required for the anode reaction to the inside, and a discharge opening 1914 for discharging the carbon dioxide produced by the anode reaction and the methanol solution left unused for the reaction. The discharge opening 1914 is arranged at a position higher than the position of the fuel supply opening 1919.

The cathode 1906 is composed of, for feeding oxygen necessary for the cathode reaction with use of, for example, air, an air feed port 1912 for feeding the air to the inside of the cathode 1906, and a discharge port 1913 for discharging water (including water in both liquid phase or gas phase, and water in the mixed state of the both phases) that exemplifies the product produced by the cathode reaction from the inside. It is to be noted that the product contains water as a primary ingredient, and may contain other ingredient such as formic acid, methyl formate and methanol (by later-described cross over).

The electrons move to the anode 1904 through electrode lines 1904t, 1906t which are electrically connected to electrodes 1905a, 1905b provided on the anode 1904 and the cathode 1906, whereas the protons move to the cathode 1906 through the membrane electrode assembly 4. The cathode 1906 performs a reaction (cathode reaction) to reduce the oxygen fed from the outside, the protons moved from the anode 1904 through the membrane electrode assembly 1902, and the electrons flowing in through the outside circuit so as to product water. Thus, an oxidative reaction in the anode 1904 and a reduction reaction in the cathode 1906 are respectively performed and electrons are sent through the electrodes line 1905a, 1905b by which power generation is carried out.

In FIG. 34, the membrane electrode assembly 1900 in the fuel cell body 1902 may use, for example, a Nafion 117 (trade name) made by du Pont as an electrolyte 1902b, and on one surface of the electrolyte 1902b, there is formed as an anode catalyst 1902c of the anode 1902a, carbon powder carriers with platinum and ruthenium, or an alloy of platinum and ruthenium being dispersed therein, while on the other surface, there is formed as a cathode catalyst 1902c of the cathode 1906, carbon carriers with platinum particles being dispersed therein. On the both sides of the membrane electrode assembly 1902, electrodes-cum-diffusion layers 1904d, 1906d made of, for example, carbon paper are respectively brought into intimate contact with the anode catalyst 1902a and the cathode catalyst 1902c, and then fixed to a housing 1900h through an anode-side separator 1904s and a cathode-side separator 1906s, by which the membrane electrode assembly 1902 is assembled.

The cathode side separator 1906s, which is the same as the cathode side separator 1706s of the fourth embodiment, is made up of a planar body of a nonconductive material flattened in the thickness direction as shown in FIG. 26A and FIG. 26B. The anode side separator 1904s, which is the same as the anode side separator 1704s of the fourth embodiment, whose body is formed into a corrugated plate shape flattened in the thickness direction as shown in FIG. 27, and which is built in so that the vertex line of the wave is along the direction which connects the fuel supply opening 1919 and discharge opening 1914 of the anode.

As described above, in the fuel cell body 1900, since the discharge opening 1914 thereof is arranged at a position higher than the position of the fuel supply opening 1919, liquid fuel flows into the path of the anode (see 511 and 512 of FIG. 27), so that the carbon dioxide produced by anode reaction moves upwards in the direction of the discharge opening 1914 of the anode 1904, to be discharged. Together with the elevation of the carbon dioxide, the fuel in the anode also moves upwards so as to be discharged from the discharge opening 1914 of the anode, to outside. When the fuel in the anode moves upwards, the liquid fuel 120 accumulated in the fuel mixing tank 1932 flows into the anode 1904 from the fuel supply opening of the anode. The supply and discharge of liquid fuel are thus conducted in the anode 1904 with carbon dioxide produced by anode reaction as its thrust, which allows the liquid fuel 120 to be convected in the fuel mixing tank 1932.

It is to be noted that in the embodiment, the fuel feed port 1919 and the discharge port 1914 are relative and therefore the both sides may be switched depending on the disposition direction of the fuel cell body 1900. For example, in the case where the fuel cell body 1900 is disposed upside down from the disposition direction shown in FIG. 34, a port defined by reference numeral 1919 is at a position higher than a port defined by reference numeral 1914, so that liquid fuel is fed from the port defined by reference numeral 1914 (i.e., the port functions as a fuel feed port), and discharged from the port defined by reference numeral 1919 (i.e., the port functions as a discharge port).

Also, as the auxiliary device structure for fuel supply, there is provided a fuel mixing tank 1932 for accommodating methanol solution as liquid fuel so that the methanol solution can be supplied to the anode 1904. The fuel mixing tank 1932 accumulates the methanol solution whose concentration is lower than the concentration of the liquid fuel undiluted solution accumulated in the filling-collecting device 1920 for fuel cells. Also, a fuel feed line 1971 which connects to the fuel supply opening 1945 of the filling-collecting device 1920 for fuel cells, is communicated with the fuel intake opening 1909 of the fuel mixing tank 1932.

The fuel mixing tank 1932 is arranged integrally with the fuel cell body 1900 so that the anode 1904 of the fuel cell body 1900 can be immersed in the inside of the fuel mixing tank 1932. When the liquid fuel 120 is accommodated in the fuel mixing tank 1932, the anode 1904 is completely immersed in the liquid fuel 120. Since the anode 1904 is thus arranged in the fuel mixing tank 1932, the liquid fuel 120 is supplied to the inside of the anode 1904 through the fuel supply opening 1919 in a condition to be immersed in the liquid fuel 120 constantly, and is discharged from the discharge opening 1914. In the fuel mixing tank 1932, a detector 1939 is arranged for detecting the surface level and concentration of the liquid fuel 120 accumulated in the fuel mixing tank 1932, and the information from the detector 1939 is transmitted to the control unit 406.

Also, into the fuel mixing tank 1932, carbon dioxide gas produced by anodic reaction that progresses at the anode 1904 is let to flow through the discharge opening 1914 of the anode 1904. To exhaust the gas let to flow in in this way outside the fuel mixing tank 1932, an exhaust valve 1911 is provided. This exhaust valve 1911 functions also for degasification in initial injection of liquid fuel into the fuel mixing tank 1932.

Instead of such a case where the fuel mixing tank 1932 is formed integral with the fuel cell body 1900 and the anode 1904 is immersed in the fuel mixing tank 1932, it is also possible that the two members are formed separately and independently as a modification. In such a case, it is preferable to provide, as required, a feed unit for feeding the liquid fuel from the fuel mixing tank 1932 to the anode 1904.

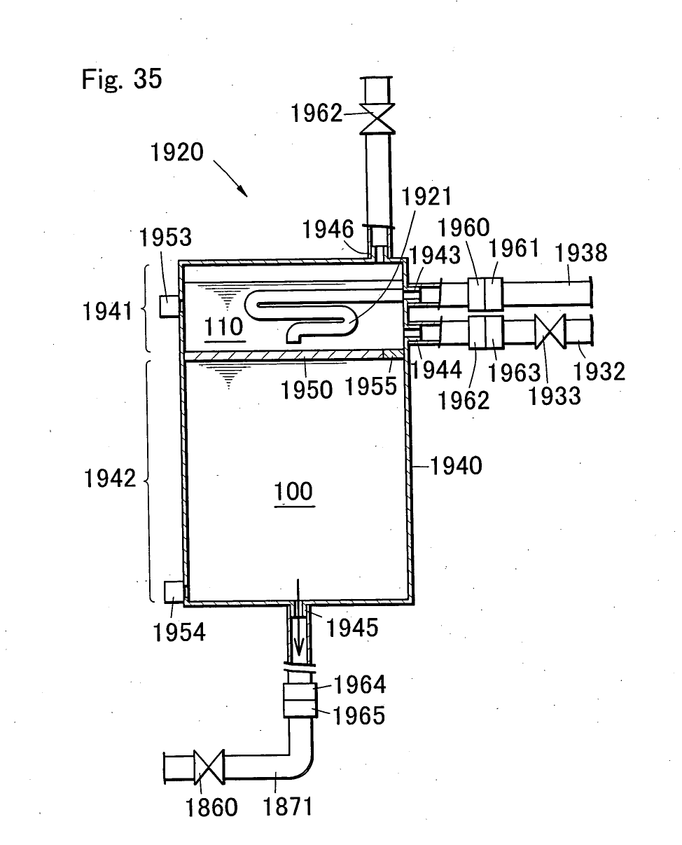

Next, a filling-collecting device 1920 for fuel cells is explained. FIG. 35 is a schematic view showing the structure of the filling-collecting device 1920 for fuel cells employed in the fuel cell system 1910 of FIG. 33. As shown in FIG. 35, the filling-collecting device 1920 for fuel cells is provided with a container body 1940, a fuel accommodating space 1942 for filling, an effluent collecting space 1941, a partition plate 1950, a pressure regulating valve 1962, a fuel supply opening 1945, an effluent inlet 1943, a water feed opening 1944, a radiating pipe 1921, a fuel supply connector 1954 and a water collecting connector 1953.

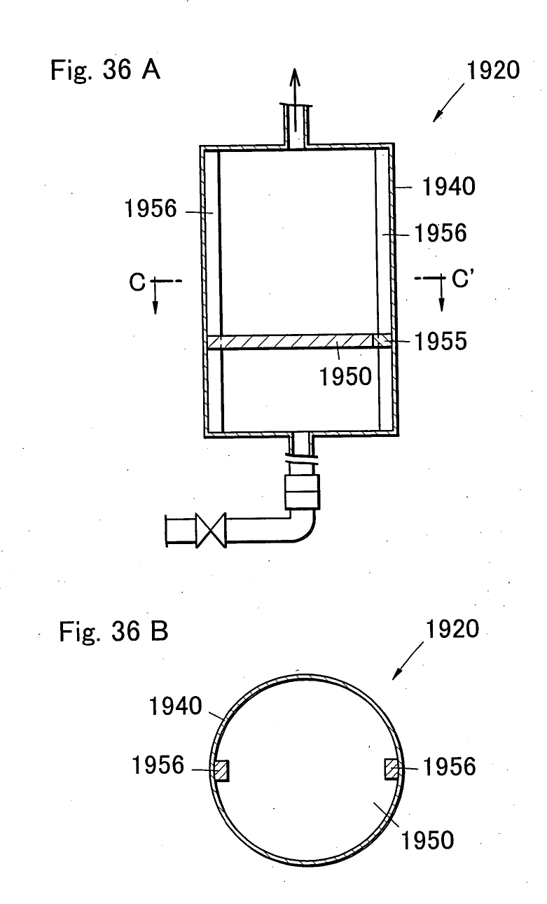

As shown in FIG. 36A, in this embodiment, the container body 1940 has guide bars 1956 provided over the fuel accommodating space 1942 for filling and the effluent collecting space 1942. The guide bars 1956 are provided continuously so as to range from the effluent collecting space 1941 to the fuel accommodating space 1942 for filling in parallel with the move direction of the partition plate 1950. For engagement with the guide bars 1956, cutouts are provided in the partition plate 1950. The guide bars 1956, although not particularly limited in their thickness and number of bars, are preferably made small in their rate of occupancy in terms of volumetric efficiency of the fuel container. The partition plate 1950 is moved in parallel along the guide bars 1956, and therefore may be formed thin without the need for having a specified thickness as in the fifth embodiment.

Also, the partition plate 1950 is provided on a portion of its periphery with a magnet 1955 which is to be used for positional detection of the partition plate by a Hall element 1934 provided outside the filling-collecting device 1920 for fuel cells. A distance D to which the partition plate 1950 is movable ranges between positions where fuel supply by a later-described fuel cartridge as well as water collection can be done by the water collecting connector 1953 and the fuel supply connector 1954. More specifically, the upper-limit position of the partition plate 1950 is immediately below the water feed opening 1944 and lower than the lower end of the radiating pipe 1921. The lower-end position of the partition plate 1950 is immediately above the fuel supply connector 1954, which is a position where the fuel accommodating space 1942 for filling can be fueled.

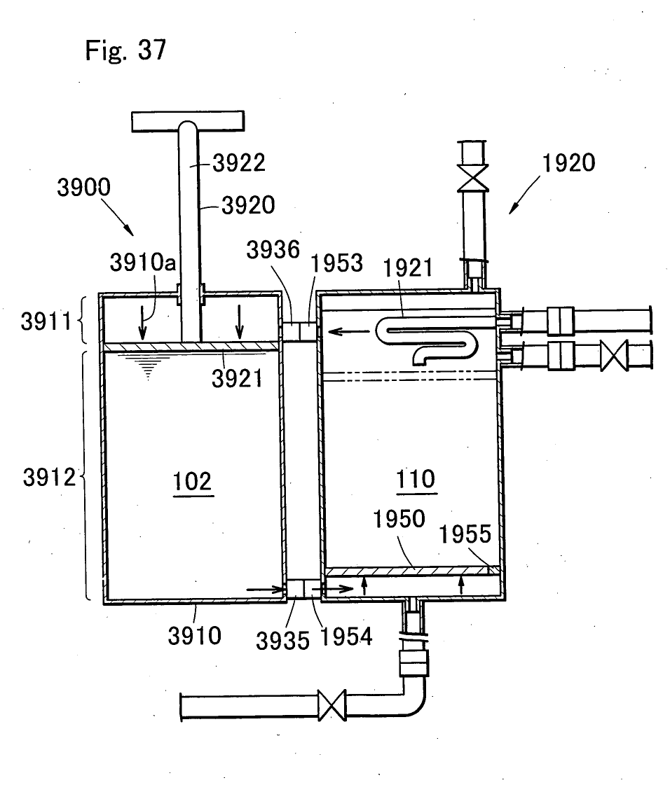

In the filling-collecting device 1920 for fuel cells, the water collecting connector 1953 is fitted to the effluent collecting space 1941 and the fuel supply connector 1954 is fitted to the fuel accommodating space 1942 for filling for fuel supply and water collection. The water collecting connector 1953 and the fuel supply connector 1954 are each provided with a leak prevention mechanism. The water collecting connector 1953 and the fuel supply connector 1954, as shown in FIG. 37, are coupled to a reusing device 3900.

FIG. 37 shows a connection structural view of the filling-collecting device 1920 for fuel cells and the reusing device 3900 in regeneration. Like the reusing device 3300 shown in FIG. 8, the reusing device 3900 is provided with a reusing device casing 3910 and further with a piston 3920 which is arranged in the reusing device casing 3910 and which is movable along the axial direction 3910a of the reusing device casing 3910, and aforementioned plug part 3935 and plug part 3936 which are respectively fitted to the fuel supply connector 1953 and the water collecting connector 1954 provided in the filling-collecting device 1920 for fuel cells.

The piston 3920 has a partition plate 3921 for partitioning the interior of the reusing device casing 3910 into an effluent accommodation part 3911 and a filling fuel supply part 3912, and a rod 3922 which is protrusively provided on the partition plate 3621, extending along the axial direction 3910a through the reusing device casing 3910 to reach outside.

Reusing operation of the filling-collecting device 1920 for fuel cells using the reusing device 3900 constructed as shown above is similar to that of the second embodiment, and so its description is omitted.

Next, a description is given for the operation of each component when power generation is conducted in the fuel cell system 1910 of FIG. 33.

First, in the fuel cell system 1910 shown in FIG. 33, since the anode 1904 is immersed in the fuel mixing tank 1932 and the fuel is present in the anode 1904, the air supply pump 1939 is driven to supply oxygen to the cathode 1906, where power generation is started.

An effluent containing water and air produced by the progress of reaction in the cathode 1906, because of the cathode 1906 being internally pressurized by the air supply pump 1939, is fed out to the effluent feed line 1938 through the discharge opening 1913, thus supplied to the filling-collecting device 1920 for fuel cells.

Water and methanol are consumed by power generation. When the remaining quantity of fuel in the fuel mixing tank 1932 has become small, a signal indicating that is transmitted from the detector 1939 for detecting the liquid level and the fuel concentration of the fuel mixing tank to the control unit 406. The control unit 406, which has received the signal, adjusts the opennesses of the regulating valve 1960 for fuel and the water valve 1933, and feeding necessary amounts of water and methanol to the fuel mixing tank 1932. The water and methanol are fed from the fuel accommodating space 1942 for filling and the effluent collecting space 1941, respectively, of the filling-collecting device 1920 for fuel cells. In this process, depending on whether the concentration of the fuel in the fuel mixing tank 1932 detected by the detector 1939 is higher or lower than the reference value of concentration, the opennesses of the regulating valve 1960 for fuel and the water valve 1933 can be adjusted so that the ratio of water to methanol to be fed to the fuel mixing tank can be changed.

When the liquid level of the fuel mixing tank has lowered below the upper end of the anode, conducting power generation in this state may in some cases involve a case that the fuel cannot be supplied to the whole anode, thus causing a possibility that the fuel cells may be damaged. Because of this, when a signal indicating that the liquid level has lowered below a specified water level, e.g. the discharge opening 1914 is transmitted from the liquid level sensor to the control unit, the water valve 1933 is first opened and water is preferentially fed to a specified level. During this process, when the water has run out or when its concentration has become too thin, the fuel valve is opened to make the fuel fed as well together, as required.

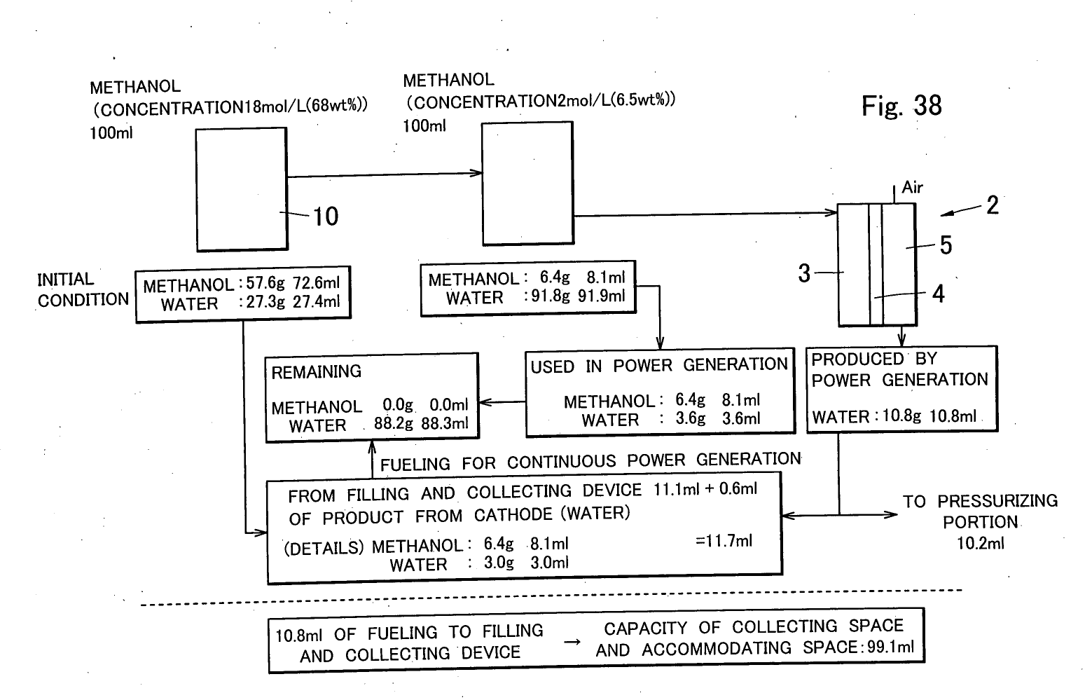

A specific material balance of the fuel cell system 1910 of FIG. 33 is as follows. An ideal material balance of the fuel cell system 1910 of the FIG. 33 is as shown in FIG. 38. It is noted that the membrane electrode assembly 1902 in the fuel cell body 1900, although basically so formed as to prevent methanol and water from passing therethrough, would be subject to occurrence of a so-called crossover that traces of methanol and water are let to pass therethrough. However, the following explanation of material balance is based on an assumption that there occurs no crossover in the membrane electrode assembly 1902, for an easier understanding of the explanation.

In the fuel cell system 1910, 100 ml of methanol aqueous solution having a concentration of 68 wt % is accommodated in the fuel accommodating space 1942 for filling of the filling-collecting device 1920 for fuel cells as a liquid fuel undiluted solution. That is, 57.6 g (72.6 ml) of methanol and 27.3 g (27.4 ml) of water are contained. It is assumed that, in the anode 1904, the liquid fuel undiluted solution is diluted by water fed from the effluent collecting space 1941 of the filling-collecting device for fuel cells and methanol aqueous solution having a concentration of 6.5 wt % is fed.

In this embodiment, which is an example in which the anode 1904 is disposed inside the fuel mixing tank 1932, it is assumed that, for an easier understanding, fuel and water derived from the filling-collecting device 1920 for fuel cells are once supplied to a virtual fuel mixing tank and completely stirred, and then a required amount of methanol aqueous solution of the 6.5 wt % concentration is supplied to the anode from its storage. Actually, not that the fuel in the fuel mixing tank is supplied to the anode by a required amount, but that the anode is immersed in the liquid fuel in the fuel mixing tank as described before and an anode reaction is conducted by using the liquid fuel in the fuel mixing tank. This virtual fuel mixing tank has a volume of 100 ml, equal in volume to the filling-collecting device for fuel cells, and 6.4 g (8.1 ml) of methanol and 91.8 g (91.9 ml) of water are contained therein.

Methanol aqueous solution of the 6.5 wt % concentration is supplied to the anode, causing the power generation to be started, where the methanol stored in the fuel mixing tank is consumed. In the anode 1904, 6.4 g (8.1 ml) of methanol and 3.6 g (3.6 ml) of water are consumed. In the cathode 1906, 10.8 g (10.8 ml) of water are produced.

In this case, since there is a need for supplying methanol aqueous solution that has reduced through consumption in the anode 1904, 11.1 ml (in details, 8.1 ml of methanol and 3.0 ml of water) of liquid fuel undiluted solution corresponding to 6.4 g (8.1 ml) of methanol is supplied from the filling-collecting device 1920 for fuel cells. A shortfall of the water consumed by the anode and the supplied liquid fuel undiluted solution, i.e. 0.6 ml of water, is resupplied to the fuel mixing tank by using the water produced in the cathode 1906 (actually, 10.8 ml of water produced in the cathode is once brought into the effluent collecting space of the filling-collecting device for fuel cells, and then 0.6 ml of water is supplied to the anode through the water feed opening 1944 and the water feed opening 1972).

As a result of fuel supply, the amount of liquid fuel undiluted solution stored in the fuel accommodating space 1942 for filling of the filling-collecting device 1920 for fuel cells after the power generation is reduced to 88.9 ml. Further, 10.2 ml of water is stored in the effluent collecting space, so that a total of 99.1 ml of water and methanol is stored in the filling-collecting device for fuel cells.

Further, when repeated power generation has caused the fed methanol to be consumed in the anode 1904, similarly 6.4 g (8.1 ml) of methanol and 3.6 g (3.6 ml) of water in the liquid fuel are consumed in the anode 1904, and 10.8 g (10.8 ml) of water is produced in the cathode 1906. For the amount of this consumption, 11.1 ml (in details, 8.1 ml of methanol and 3.0 ml of water) of the liquid fuel undiluted solution is supplied from the filling-collecting device for fuel cells. A difference between 3.6 ml of water consumed in the anode and the water supplied from the fuel accommodating space 1942 for filling is supplied to the anode 1904 by using the water produced by the cathode 1906.

As a result of this, at the time point when the second-time methanol supply is terminated, the amount of liquid fuel undiluted solution stored in the fuel accommodating space 1942 for filling of the filling-collecting device for fuel cells becomes 77.8 ml, and the amount of water stored in the effluent collecting space becomes 20.4 ml. Accordingly, the liquid amount of the whole filling-collecting device for fuel cells becomes 98.2 ml, thus making it possible to collect all the water refined by the cathode into the filling-collecting device 1920 for fuel cells within the system without discharging it outside.

Since power generation, resupply of liquid fuel and collection of produced water are repeatedly conducted, the amount of the liquid fuel undiluted solution 100 which is accommodated in the fuel accommodating space 1942 for filling of the filling-collecting device 1920 for fuel cells gradually decreases, whereas the amount of the water 110 which is stored in the effluent collecting space 1941 increases. With the decrease of the liquid fuel undiluted solution and the increase of the water which is accommodated in the effluent collecting space 1941, the partition plate 1950 of the filling-collecting device 100 for fuel cells moves toward the side of the fuel accommodating space 1942 for filling to apply pressure on the fuel accommodating space for filling. Also, since the air which is blown out from the cathode 1906 flows in the effluent collecting space 1941 of the filling-collecting device for fuel cells together with water, the pressure of the effluent collecting space 1941 of the filling-collecting device for fuel cells is increased by air pressure, thus acting as the biasing force for pressing the partition plate. It is to be noted that when the pressure of the effluent collecting space 1941 becomes too high, the pressure regulating valve 1962 provided on the exterior wall of the effluent collecting space is opened so that the pressure is automatically regulated to a specified pressure.

The position of the partition plate 1950 is detected by the Hall element 1934 detecting the position of the magnet 1955 attached to the partition plate 1950, and information about this is transmitted to the control unit 406 so that the remaining quantity in the fuel accommodating space 1942 for filling is calculated. This information about the remaining quantity of fuel is displayed on an electronic device on which the fuel cell system is mounted, so that the information can be utilized for the display of replacement time of the filling-collecting device for fuel cells.

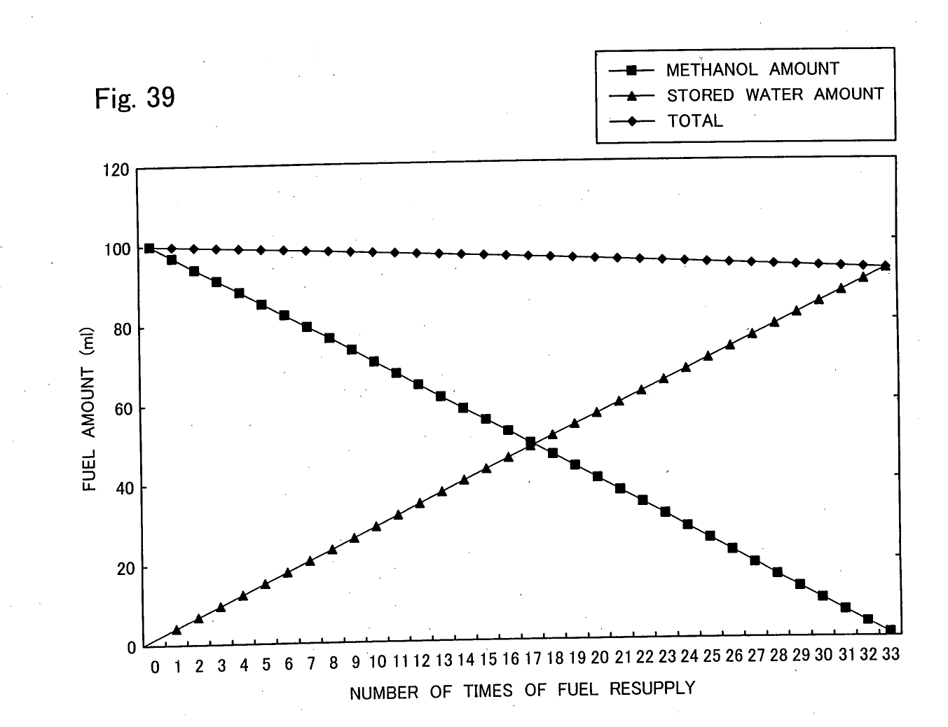

In the above description, for a better understanding, methanol is resupplied from the filling-collecting device for fuel cells after the supplied methanol in the initial state (the methanol being supplied in the fuel mixing tank in the case of above description) is completely consumed. However, in actual operation, methanol is supplied in a continuous mode. Therefore, as in the fuel cell system 1 according to the first embodiment, also in this embodiment, power generation can be continued until the liquid fuel undiluted solution 110 stored in the filling-collecting device for fuel cells runs out, as shown in FIG. 39. Thus, the total volume of the filling-collecting device 1920 for fuel cells never increases even if the water produced in power generation is full collected, and the fuel can be filled up to a permissible volume of the filling-collecting device for fuel cells without preparing any additional tank for water collection.

Further, the water and air stored in the filling-collecting device for fuel cells biases the partition plate 1950 so that the partition plate 1950 is moved toward the fuel accommodating space 1942 for filling, by which the fuel stored in the fuel accommodating space 1920 for filling is discharged therefore, there is no need for providing a pump or the like as a power source for feeding the liquid fuel from the filling-collecting device for fuel cells, and the self power consumption of the fuel cell system can be lessened.

As described hereinabove, in the fuel cell system according to this embodiment, water refined from the cathode is stored in the filling-collecting device for fuel cells without being discharged outside, and used for the feed of the fuel and the water for fuel dilution, thus eliminating the need for a pump for use of feeding these fuel and water. Accordingly, power that is consumed by auxiliary devices is reduced, so that the output efficiency of the fuel cell system can be improved. Further, the remaining quantity of fuel cells can be calculated simply, allowing the user of the electronic device to be notified of replacement time of the filling-collecting device for fuel cells and the like.

Further, the fuel cell system of the fifth embodiment or the sixth embodiment is small in size and free from external discharge of the water content, lending itself to use in portable electronic devices or the like.

In the portable filling-collecting device for fuel cells in this embodiment, instead of using the partition plate for division into the fuel accommodating space and the effluent collecting space, the division into the fuel accommodating space and the effluent collecting space can also be achieved by using, for example, a flexible polymeric film so that similar operation can be executed. However, polymeric films, which are vulnerable to temperature or pressure, are highly likely to subject to deformation or damage.

Furthermore, without being limited to the above-described embodiments, the present invention can be applied in other various modes.

Also, combining any arbitrary embodiments together from among the foregoing various embodiments as required allows their respective effects to be produced.

The entire disclosures of Japanese Patent Application No. 2003-173150 filed on Jun. 18, 2003, Japanese Patent Application No. 2003-173405 filed on Jun. 18, 2003, Japanese Patent Application No. 2003-173446 filed on Jun. 18, 2003, and Japanese Patent Application No. 2004-49953 filed on Feb. 25, 2004, including specification, claims, drawings, and summary are incorporated herein by reference in its entirety.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. A filling-collecting device for fuel cells for use in a fuel cell system equipped with a fuel cell body having an anode, a cathode, and an electrolyte film disposed between the anode and the cathode, the filling-collecting device comprising:
a single container capable of defining a fuel accommodating space for filling for accommodating therein a liquid fuel undiluted solution to be fed to the anode side, and an effluent collecting space for accommodating therein effluents produced in the cathode;
a partition plate which is movably set inside the container along its axial direction and which divides interior of the container into two spaces of the fuel accommodating space for filling and the effluent collecting space; and
an effluent inlet opening and a fuel feed opening each of which is provided in the container, where the effluent inlet opening communicates with the effluent collecting space and serves for taking in effluents containing water and air from the cathode side of the fuel cell body, and the fuel feed opening communicates with the fuel accommodating space for filling and serves for feeding the liquid fuel undiluted solution stored inside thereof to the anode side of the fuel cell body, wherein
the partition plate is moved so as to narrow the fuel accommodating space for filling due to a pressure difference between pressures generated in the fuel accommodating space for filling and in the effluent collecting space so that the pressure of the fuel accommodating space for filling becomes lower, whereby the liquid fuel undiluted solution is fed from the fuel accommodating space for filling through the fuel feed opening and whereby the effluents produced on the cathode side is collected into the effluent collecting space through the effluent inlet opening.

2. A filling-collecting device for fuel cells for use in a fuel cell system equipped with a fuel cell body having an anode, a cathode and an electrolyte membrane disposed between the anode and the cathode, the filling-collecting device comprising:
a single container capable of defining a fuel accommodating space for filling for accommodating therein a liquid fuel undiluted solution to be fed to the anode side, and an effluent collecting space for accommodating therein effluents produced in the cathode;
a partition plate which is movably set inside the container along its axial direction and which divides interior of the container into two spaces of the fuel accommodating space for filling and the effluent collecting space; and
an effluent inlet opening, a water feed opening and a fuel feed opening each of which is provided in the container, where the effluent inlet opening communicates with the effluent collecting space and serves for taking in effluents containing water and air from the cathode side of the fuel cell body, the water feed opening serves for feeding the water stored in the effluent collecting space to the anode side of the fuel cell body, and the fuel feed opening communicates with the fuel accommodating space for filling and serves for feeding the liquid fuel undiluted solution stored inside thereof to the anode side of the fuel cell body, wherein
when the effluents stored in the effluent collecting space via the effluent inlet opening has caused an internal pressure of the effluent collecting space to become higher than a pressure of the fuel accommodating space for filling, thereby making the partition plate to be moved toward the fuel accommodating space for filling to pressurize the fuel accommodating space for filling, whereby the liquid fuel undiluted solution can be discharged through the fuel feed opening and whereby the water can be discharged through the water feed opening.

3. The filling-collecting device for fuel cells as claimed in claim 2, further comprising a gas-liquid separating mechanism which is provided in the effluent collecting space and which serves for separating water and air from the effluents to store the water in the effluent collecting space and to discharge the air outside the effluent collecting space.

4. The filling-collecting device for fuel cells as claimed in claim 3, wherein the gas-liquid separating mechanism is a heat exchanger which communicates with the effluent inlet opening and has a tube member provided inside the effluent collecting space and which condenses water content contained in the effluents into liquefied water by using a refrigerant given by water collected into the effluent collecting space.

5. The filling-collecting device for fuel cells as claimed in claim 1, further comprising a pressure regulating mechanism which is provided in the effluent collecting space and which regulates the internal pressure of the effluent collecting space due to the effluents derived from the fuel cell body.

6. The filling-collecting device for fuel cells as claimed in claim 5, wherein the pressure regulating mechanism is a pressure regulating valve which is provided in the container so as to communicate with the effluent collecting space.

7. The filling-collecting device for fuel cells as claimed in claim 2, wherein each of the fuel feed opening, the water feed opening and the effluent inlet opening is equipped with a connector which removably connects with tubing of the fuel cell system.

8. The filling-collecting device for fuel cells as claimed in claim 1, further comprising a fuel resupply connector and a water collecting connector each of which is provided in the container, where the fuel resupply connector is so provided as to communicate with the fuel accommodating space for filling and the water collecting connector is so provided as to communicate with the effluent collecting space and serves for collection of effluents stored in the effluent collecting space, wherein
in resupply of fuel, the water collecting connector and the fuel resupply connector are each connected to a reusing device which serves for resupplying fuel to the fuel accommodating space for filling, and the fuel is resupplied to the fuel accommodating space for filling, whereby the partition plate is moved toward the effluent collecting space so that effluents in the effluent collecting space can be discharged.

9. A fuel cell system comprising:
the filling-collecting device for fuel cells as defined in claim 1;
a fuel cell body having an anode for oxidizing fuel, a cathode for reducing oxygen, an electrolyte membrane disposed between the anode and the cathode, and a diffusion layer disposed on each surface of the electrolyte membrane;
a fuel feed line which makes the fuel feed opening and the anode communicated with each other so that the liquid fuel undiluted solution accommodated in the fuel accommodating space for filling can be fed to the anode;
an effluent collecting line which makes the cathode and the effluent inlet opening communicated with each other so that the effluents can be collected from the cathode into the effluent collecting space; and
a pressure difference generating mechanism for generating a pressure difference between the fuel accommodating space for filling and the effluent collecting space so that a pressure of the fuel accommodating space for filling becomes lower.

10. A fuel cell system comprising:
the filling-collecting device for fuel cells as defined in claim 2;
a fuel cell body having an anode for oxidizing fuel, a cathode for reducing oxygen, an electrolyte membrane disposed between the anode and the cathode, and diffusion layers disposed on respective surfaces of the electrolyte membrane;
a water feed line which makes the water feed opening and the anode communicated with each other so that water contained in the effluents can be fed to the anode;
a first feed-quantity regulating unit for regulating quantity of water fed through the water feed opening so that concentration of fuel supplied to the anode becomes a specified value; and
a control unit for controlling the first feed-quantity regulating unit by means of the effluents stored in the effluent collecting space so that the partition plate pressurizes the fuel accommodating space for filling with a specified pressure.

11. The fuel cell system as claimed in claim 9, wherein
the pressure difference generating mechanism is equipped with an air pump for supplying air to the cathode; and
the air pump is an air supply pump which supplies air to the cathode so that the effluents produced in the cathode are collected to the effluent collecting space through the effluent collecting line and that the effluent collecting space is pressurized so as to make the partition plate moved toward the fuel accommodating space for filling, whereby the liquid fuel undiluted solution is supplied to the anode from the fuel accommodating space for filling through the fuel feed line.

12. The fuel cell system as claimed in claim 10, further comprising:
a second feed-quantity regulating unit for regulating a quantity of liquid fuel supplied to the fuel cell body, wherein
the control unit controls a second feed-quantity regulating unit so that the liquid fuel consumed by power generation in the fuel cell body is fed from the filling-collecting device for fuel cells to the anode side of the fuel cell body.

13. The fuel cell system as claimed in claim 10, further comprising: a position detecting unit for detecting a position of the partition plate; and a fuel remaining quantity calculating unit for detecting remaining quantity of the liquid fuel accommodated in the filling-collecting device for fuel cells based on information concerning the position of the partition plate detected by the position detecting unit.

14. The fuel cell system as claimed in claim 13, wherein the position detecting unit is implemented by a device which is capable of detecting the position of the partition plate without contacting the filling-collecting device for fuel cells.

15. The fuel cell system as claimed in claim 14, wherein the position detecting unit comprises:
a magnet provided on the partition plate; and
a detector which is provided outside the filling-collecting device for fuel cells and which serves for detecting a magnetic field that has been emitted from the magnet and that has permeated through an exterior wall of the filling-collecting device for fuel cells to detect a position of the magnet.

16. The fuel cell system as claimed in claim 14, further comprising:
a remaining electric energy calculating unit for calculating an electric energy that can be generated by the liquid fuel accommodated in the filling-collecting device for fuel cells based on information as to remaining quantity of the liquid fuel calculated by the fuel remaining quantity calculating unit;
a power consumption calculating unit for detecting an electric energy outputted from the fuel cell body and calculating an electric energy outputted per unit time based on the detected electric energy; and
a remaining time calculating unit for calculating information as to a remaining time duration during which electric power can be generated by liquid fuel accommodated in the filling-collecting device for fuel cells, based on information as to a generable electric energy calculated by the remaining electric energy calculating unit and to a power consumption quantity per unit time calculated by the power consumption calculating unit.

17. The fuel cell system as claimed in claim 9, further comprising a fuel mixing tank for storing the liquid fuel fed from the filling-collecting device for fuel cells and water fed through the water feed opening.

18. The fuel cell system as claimed in claim 17, wherein at least the anode side of the fuel cell body is placed in the fuel mixing tank.

19. The fuel cell system as claimed in claim 17, further comprising a concentration detecting unit for detecting concentration of liquid fuel in the fuel mixing tank, wherein
the control unit, upon reception of a detection signal from the concentration detecting unit, controls the first and second feed-quantity regulating units so that the concentration of the liquid fuel in the fuel mixing tank becomes a constant value.

20. The fuel cell system as claimed in claim 17, further comprising a liquid level detecting unit for detecting a liquid level in the fuel mixing tank, wherein
upon a decision by the liquid level detecting unit that the liquid level in the fuel mixing tank has become lower than a reference level, the control unit controls the first and second feed-quantity regulating units so that at least one of water and liquid fuel is supplied to the fuel mixing tank.

21. The fuel cell system as claimed in claim 9, wherein the diffusion layer placed on the anode side has hydrophilicity, and the diffusion layer placed on the cathode side has hydrophobicity.

22. The fuel cell system as claimed in claim 9, further comprising a gas-liquid separating mechanism capable of separating the effluents produced in the cathode into gas and liquid, wherein
the liquid separated by the gas-liquid separating mechanism is collected into the effluent collecting space.

23. The fuel cell system as claimed in claim 22, further comprising a pressure regulating valve for the gas-liquid separating mechanism evacuating the separated gas, whereby interior of the effluent collecting space is maintained at a specified pressure.

24. A reusing device for filling-collecting device for fuel cells for use in connection with the filling-collecting device for fuel cells as defined in claim 8, wherein
interior space thereof is partitioned into a filling fuel supply part where fuel is stored and an effluent accommodation part by a piston, where a fuel filling connector which is connectable with the fuel resupply connector of the filling-collecting device for fuel cells is provided in the filling fuel supply part, and an effluent collecting connector which is connectable with a water collecting connector of the filling-collecting device for fuel cells is provided in the effluent accommodation part, and
the piston is moved toward the filling fuel supply part, whereby fuel in the filling fuel supply part is supplied to the fuel accommodating space for filling of the filling-collecting device for fuel cells through the fuel resupply connector, while effluents in the effluent collecting space of the filling-collecting device for fuel cells are collected into the effluent accommodation part through the effluent collecting connector.

25. A fuel cell system comprising:
a fuel cell body having an anode for oxidizing fuel, a cathode for reducing oxygen, an electrolyte membrane disposed between the anode and the cathode, an anode-side diffusion layer disposed on an anode-side surface of the electrolyte membrane and having hydrophilicity, and a cathode-side diffusion layer disposed on a cathode-side surface of the electrolyte membrane and having hydrophobicity;
a fuel feed line which makes the fuel feed opening and the anode communicated with each other so that the liquid fuel undiluted solution accommodated in the fuel accommodating space for filling can be fed to the anode;
one container capable of defining a fuel accommodating space for filling for accommodating therein a liquid fuel undiluted solution to be fed to the anode side, and an effluent collecting space for accommodating therein effluents produced in the cathode;
a partition plate which is movably set inside the container along its axial direction and which divides interior of the container into two spaces of the fuel accommodating space for filling and the effluent collecting space; and
a fuel feed opening and an air supply unit each of which is provided in the container, where the fuel feed opening communicates with the effluent collecting space and with the fuel accommodating space for filling of the fuel cell body and serves for feeding the liquid fuel undiluted solution stored inside thereof to the anode side of the fuel cell body, and the air supply unit supplies air to the cathode.

26. The filling-collecting device for fuel cells as claimed in claim 2, further comprising a pressure regulating mechanism which is provided in the effluent collecting space and which regulates the internal pressure of the effluent collecting space due to the effluents derived from the fuel cell body.

27. The filling-collecting device for fuel cells as claimed in claim 2, further comprising a fuel resupply connector and a water collecting connector each of which is provided in the container, where the fuel resupply connector is so provided as to communicate with the fuel accommodating space for filling and the water collecting connector is so provided as to communicate with the effluent collecting space and serves for collection of effluents stored in the effluent collecting space, wherein
in resupply of fuel, the water collecting connector and the fuel resupply connector are each connected to a reusing device which serves for resupplying fuel to the fuel accommodating space for filling, and the fuel is resupplied to the fuel accommodating space for filling, whereby the partition plate is moved toward the effluent collecting space so that effluents in the effluent collecting space can be discharged.
